(19) United States
(12) Patent Application Publication
(10) Pub. No.: US 2017/0210989 A1
(43) Pub. Date: Jul. 27, 2017

(54) LIQUID CRYSTAL COMPOSITION AND LIQUID CRYSTAL DISPLAY ELEMENT USING THE SAME

(71) Applicant: DIC CORPORATION, Tokyo (JP)

(72) Inventors: Shinichi HIRATA, Kita-adachi-gun (JP); Yoshinori IWASHITA, Kita-adachi-gun (JP)

(73) Assignee: DIC Corporation, Tokyo (JP)

(21) Appl. No.: 15/328,612

(22) PCT Filed: Sep. 17, 2015
(86) PCT No.: PCT/JP2015/076440

§ 371 Date: Jan. 24, 2017

(30) Foreign Application Priority Data
Jul. 24, 2014 (JP) 2014-150713

(51) Int. Cl. C09K 19/30; C09K 19/56

(52) U.S. Cl. CPC C09K 19/3068; C09K 19/56; C09K 2019/3078

(57) ABSTRACT

The problem that the present invention is to solve is to provide a liquid crystal display element using a liquid crystal composition having negative dielectric anisotropy that can achieve excellent display characteristics by using a liquid crystal display element without deteriorating various characteristics as a liquid crystal display element such as dielectric anisotropy, viscosity, nematic phase upper limit temperature, nematic phase stability at low temperature and γ₁, and burn-in characteristics as a display element. The liquid crystal display composition contains at least one selected from the group of compounds represented by a General Formula (1) as a first component, and at least one selected from the group of compounds represented by a General Formula (2) as a second component.

### TECHNICAL FIELD

The present invention relates to a liquid crystal composition useful as a constituent member of a liquid crystal display device and the like, and a liquid crystal display element.

### BACKGROUND ART

A liquid crystal display element has become used in watches, clocks, and electronic calculators, and also in various measurement instruments, automobile panels, word processors, electronic organizers, printers, computers, televisions, watches, clocks, advertisement billboards, etc. Typical liquid crystal display systems include a TN (twisted nematic) mode, an STN (super-twisted nematic) mode, a TFT (thin-film transistor)-using VA (hereinafter also referred to as vertical alignment) mode, an IPS (in-plane switching) mode, etc. The liquid crystal composition to be used in these liquid crystal display elements is required to be stable to external factors such as moisture, air, heat, light and the like, to express a liquid crystal phase in a broadest possible temperature range around room temperature as the center, to have a low viscosity and to have a low driving voltage. Furthermore, to make characteristic values of dielectric anisotropy (Δ∈), refractive index anisotropy (Δn) and the like be optimum values to the individual display elements, the liquid crystal composition is constituted of compounds of several kinds to several tens kinds.

For example, VA mode widely used in a liquid crystal TV and the like generally uses a liquid crystal composition having negative Δ∈, and TN mode used in PC monitor and the like and IPS mode widely used in a touch panel and the like generally use a liquid crystal composition having positive Δ∈. As a matter of course, a liquid crystal composition showing low voltage driving, high response and wide operating temperature range is required in not only those IPS and VA modes, but all of driving systems. To respond to the requirement, a liquid crystal composition having Δ∈ of large absolute value, small viscosity (η) and high nematic phase-isotropic liquid phase transition temperature (Tni) is required. Further, from the setting of Δn×d that is a product of Δn and a cell gap (d), it is necessary to adjust Δn of a liquid crystal composition to an appropriate range in conformity with a cell gap. In addition, in the case of applying a liquid crystal display element to a television and the like, high responsiveness is considered to be important, and therefore, a liquid crystal composition having small γ1 is required. In view of the above, to constitute a liquid crystal composition having small γ1, conventionally a compound having a bicyclohexane framework has been generally used as shown in, for example, PTL 1.

However, a bicyclohexane compound is effective to decrease γ1, but vapor pressure generally tends to be high, and particularly the tendency is remarkable in a compound having short alkyl chain length. Further, the bicyclohexane compound has the tendency showing low Tni, and therefore, the bicyclohexane compound generally uses a compound in which the total of a side chain length is 5 to 7 carbon atoms or more, in many cases.

For example, one of the technology in which a bicyclohexane framework is essential includes PTL 2. PTL 2 discloses a liquid crystal composition in which the formula (1) of a so-called tetracyclic framework in which four benzene rings or four cyclohexane rings are connected, and the formula (2) of a bicyclohexane framework are essential.

According to PTL 2, the compound (1) represented by the formula (1) of a tetracyclic framework plays a role of increasing an upper limit temperature and an absolute value of dielectric anisotropy, and the compound (2) represented by the formula (2) of a bicyclohexane framework plays a role of decreasing a viscosity (paragraph [0046]). For this reason, it is surely confirmed that when Examples of PTL 2 are examined, viscosity (η), dielectric anisotropy (Δ∈) or phase transition temperature (Tni) is improved as compared with Comparative Examples.

### CITATION LIST

### Patent Literature

PTL 1: JP-T 2008-505235

PTL 2: JP-A 2011-144274

### SUMMARY OF INVENTION

### Technical Problem

PTL 2 describes that in the characteristics of dielectric anisotropy (Δ∈) having large absolute value, small viscosity (η), upper limit (Nl) and lower limit (Tc) of a nematic phase, large specific resistance, high stability to ultraviolet rays, high stability to heat, and the like, at least one characteristic is satisfied. However, properties of a liquid crystal composition confirmed in all Examples of the PTL are any one of viscosity (η), dielectric anisotropy (Δ∈), phase transition temperatures (Nl and Tc) and voltage holding ratio (VHR). Thus, it is the present status that evaluations and investigations are not made at all on the items relating to reliability, such as large specific resistance, stability to ultraviolet rays and stability to heat. PTL 1 is the same in this regard, and characteristics relating to reliability are indispensable from the standpoint of maintaining display quality of a liquid crystal display element that is the use embodiment of a liquid crystal composition. Particularly, in the case of using the bicyclohexane compound and the liquid crystal compound of relatively low molecule described in PTLs 1 and 2 above, the problem of high volatility always remains, and additionally, when an alkenyl group, an alkoxy group or the like is bonded to the end of those compounds, new problem causes in reliability such as light resistance, heat resistance or burn-in.

In view of the above, the present invention has been made to solve the above problems, and has an object that in the liquid crystal composition of the present invention, a composition having excellent reliability such as light resistance, heat resistance or burn-in while maintaining high responsiveness is provided.

### Solution to Problem

To solve the above problems, the present inventors have found that reliability such as light resistance, heat resistance or burn-in can be improved, and have reached to complete the present invention.

The present invention has an object to provide a liquid crystal composition containing, as a first component, at least one selected from the group of compounds represented by the following formula (1):

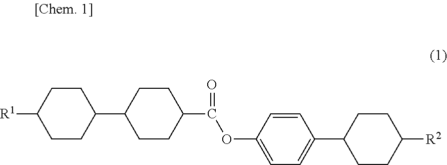

in General Formula (1), R¹ and R² each independently represent one group selected from the group consisting of an alkyl group having 1 to 15 carbon atoms, an alkenyl group having 2 to 15 carbon atoms and an alkoxy group having 1 to 15 carbon atoms, and

as a second component, at least one selected from the group consisting of compounds represented by the following General Formula (2):

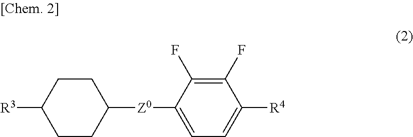

in General Formula (2), R³ is selected from the group consisting of an alkyl group having 1 to 15 carbon atoms, an alkenyl group having 2 to 15 carbon atoms and an alkoxy group having 1 to 15 carbon atoms,

Z⁰ represents a single bond, —CH₂O— or —OCH₂—, and

R⁴ is selected from the group consisting of an alkyl group having 1 to 15 carbon atoms and an alkoxy group having 1 to 15 carbon atoms.

### Advantageous Effects of Invention

According to the present invention, the liability such as light resistance, heat resistance or burn-in of a liquid crystal composition can be improved.

### BRIEF DESCRIPTION OF DRAWINGS

FIG. 1 is a view schematically showing a configuration of a liquid crystal display element.

FIG. 2 is an enlarged plane view of a thin-film transistor-containing electrode layer 3 formed on the substrate in FIG. 1.

FIG. 3 is a cross-sectional view in which the liquid crystal display element shown in FIG. 1 was cut in line II-II′ direction in FIG. 2.

FIG. 4 is an enlarged view of a thin-film transistor that is a region of IV in FIG. 3.

FIG. 5 is other view schematically showing a configuration of a liquid crystal display element.

FIG. 6 is an enlarged plane view of a thin-film transistor-containing electrode 3 formed on the substrate in FIG. 5.

FIG. 7 is a cross-sectional view in which the liquid crystal display element shown in FIG. 5 was cut in line II-II′ direction in FIG. 6.

FIG. 8 is an enlarged plane view of a thin-film transistor-containing electrode 3 formed on the substrate in other embodiments in FIG. 5.

FIG. 9 is a cross-sectional view showing other embodiment in which the same place as in FIG. 7 was cut.

### DESCRIPTION OF EMBODIMENTS

The first aspect of the present invention is a liquid crystal composition containing, as a first component, at least one selected from the group of compounds represented by General Formula (1):

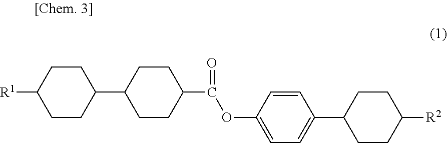

in General Formula (1), R¹ and R² each independently represent one group selected from the group consisting of an alkyl group having 1 to 15 carbon atoms, an alkenyl group having 2 to 15 carbon atoms, and an alkoxy group having 1 to 15 carbon atoms, and

as a second component, at least one selected from the group of compounds represented by General Formula (2):

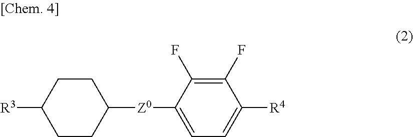

in General Formula (2), R³ is selected from the group consisting of an alkyl group having 1 to 15 carbon atoms, an alkenyl group having 2 to 15 carbon atoms, and an alkoxy group having 1 to 15 carbon atoms,

Z⁰ represents a single bond, —CH₂O— or —OCH₂—, and

R⁴ is at least one group selected from the group consisting of an alkyl group having 1 to 15 carbon atoms, and an alkoxy group having 1 to 15 carbon atoms.

Reliability such as light resistance, heat resistance or burn-in of the liquid crystal composition can be improved by the combination of General Formula (1) and General Formula (2).

The liquid crystal composition of the present invention contains the first component represented by General Formula (1) and the second component represented by General Formula (2) as essential components, and as necessary, may further contain a third component represented by General Formula (3), a fourth component represented by General Formula (4), a polymerizable monomer and at least one selected from the group consisting of other components such as additives. Specifically, the liquid crystal composition of the present invention contains the compounds represented by General Formulas (1) and (2) as essential components, and as necessary, can further contain at least one selected from the group consisting of the compounds of General Formulas (3) and (4) described hereinunder.

The total content of the compounds represented by General Formulas (1) and (2) contained in the liquid crystal composition is that, as the lower limit, 5 mass % is preferable, 10 mass % is preferable, 12 mass % is preferable, 15 mass % is preferable, 17 mass % is preferable, 20 mass % is preferable, 22 mass % is preferable, 24 mass % is preferable, 26 mass % is preferable, 28 mass % is preferable, and 30 mass % is preferable. As the upper limit, 50 mass % is preferable, 45 mass % is preferable, 43 mass % is preferable, 40 mass % is preferable, 38 mass % is preferable, 36 mass % is preferable, 30 mass % is preferable, 28 mass % is preferable, and 26 mass % is preferable.

The value of dielectric anisotropy Δ∈ of the liquid crystal composition of the present invention is, at 25° C., preferably −2.0 to −6.0, more preferably −2.5 to −5.0, and particularly preferably −2.5 to −4.0, and further in detail, the value of dielectric anisotropy Δ∈ falls within a range of −2.5 to −3.4 from the viewpoint of response speed.

The value of refractive index anisotropy (Δn) of the liquid crystal composition of the present invention is, at 25° C., preferably 0.08 to 0.13, more preferably 0.09 to 0.12. Further in detail, the value is preferably about 0.10 to 0.12 for a thin cell gap, and is preferably about 0.08 to 0.10 for a thick cell gap.

The upper limit of the rotational viscosity (γ₁) of the liquid crystal composition of the present invention is preferably 150 (mPa·s) or less, more preferably 130 (mPa·s) or less, even more preferably 120 (mPa·s) or less. On the other hand, the lower limit of the rotational viscosity (γ₁) is preferably 20 (mPa·s) or more, more preferably 30 (mPa·s) or more, even more preferably 40 (mPa·s) or more, still more preferably 50 (mPa·s) or more, further more preferably 60 (mPa·s) or more, and especially preferably 70 (mPa·s) or more.

Of the liquid crystal composition of the present invention, the function Z between the rotational viscosity and the refractive index anisotropy preferably indicates a specific value.

Z=γ1/(Δn)² [Math. 1]

In the above numerical formula, γ₁ represents a rotational viscosity, and Δn represents a refractive index anisotropy.

Z is preferably 13,000 or less, more preferably 12,000 or less, even more preferably 11,000 or less.

In the case where the liquid crystal composition of the present invention is used in an active matrix display element, it must have a specific resistivity of 10¹¹ (Ω·m) or more, preferably 10¹² (Ω·m) or more, more preferably 10¹³ (Ω·m) or more.

The liquid crystal composition of the present invention can be used in a broad nematic phase-isotropic liquid phase transition temperature (T_{NI}) range, and the phase transition temperature (T_{NI}) is preferably 60 to 120° C., more preferably 70 to 110° C., even more preferably 75 to 100° C.

The components that can be contained in the liquid crystal composition of the present invention are described in detail hereinunder.

The liquid crystal composition of the present invention contains, as the first component, the compound represented by the following General Formula (1):

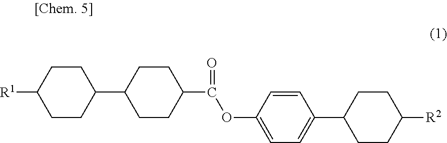

in General Formula (1), R¹ and R² each independently represent one group selected from the group consisting of an alkyl group having 1 to 15 carbon atoms, an alkenyl group having 2 to 15 carbon atoms, and an alkoxy group having 1 to 15 carbon atoms,

as the essential component.

Preferably, the liquid crystal composition contains the compound represented by General Formula (1) from the standpoint of the improvement of reliability, such as light resistance, heat resistance or burn-in. Particularly, when the compound represented by General Formula (1) is contained in the liquid crystal composition, the compound contributes to the increase of a transition temperature and Δn, but also increases a viscosity. For this reason, the compound may be disadvantageous to the liquid crystal composition that aims at high response. However, it has been confirmed that the increase of a viscosity can be suppressed to a certain extent by combining the compound with the compound represented by General Formula (2). The compound has an ester bond in a linking group. Therefore, solubility is excellent as compared with a compound in which tetracyclic structure is directly connected, but there a problem that the ester bond is easy to decompose and is easy to hold ions as impurities. However, as confirmed in the examples described hereinunder, it has been confirmed that a liquid crystal composition having excellent light resistance that is relatively difficult to be decomposed can be provided by combining with the compound represented by General Formula (2).

In General Formula (1), preferably, R¹ and R² each independently represent one group selected from the group consisting of an alkyl group having 1 to 6 carbon atoms, an alkenyl group having 2 to 6 carbon atoms and an alkoxy group having 1 to 6 carbon atoms.

The compound represented by General Formula (1) as the first component preferably contains at least one kind of the compounds represented by the following General Formula (1-1)

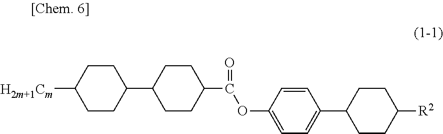

in General Formula (1-1), R² each independently is one group selected from the group consisting of an alkyl group having 1 to 15 carbon atoms, an alkenyl group having 2 to 15 carbon atoms and an alkoxy group having 1 to 15 carbon atoms.

The liquid crystal composition preferably contains the compound represented by General Formula (3) from the standpoint of the improvement of reliability in light resistance, heat resistance or burn-in.

The compound represented by General Formula (1) is particularly preferably compounds represented by the formulae (1.1) to (1.5).

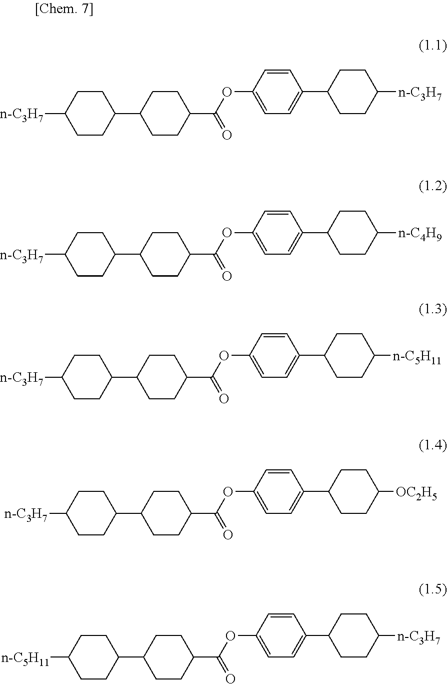

In the liquid crystal composition of the present invention, the lower limit of the content of the first component is, as one embodiment of the present invention, for example, preferably 1 mass %, preferably 3 mass %, preferably 5 mass %, preferably 7 mass %, preferably 9 mass %, preferably 10 mass %, preferably 12 mass %, preferably 15 mass %, preferably 16 mass %, preferably 18 mass %, preferably 20 mass %, preferably 22 mass %, preferably 24 mass %, preferably 26 mass %, preferably 28 mass %, preferably 30 mass %, preferably 32 mass %, preferably 35 mass %, and preferably 40 mass %, based on the total amount (100 mass %) of the liquid crystal composition of the present invention.

Further, in the liquid crystal composition of the present invention, the upper limit of the content of the first component is, as one embodiment of the present invention, for example, preferably 45 mass %, preferably 42 mass %, preferably 40 mass %, preferably 38 mass %, preferably 36 mass %, preferably 34 mass %, preferably 32 mass %, preferably 30 mass %, preferably 28 mass %, preferably 26 mass %, preferably 24 mass %, preferably 26 mass %, preferably 24 mass %, preferably 22 mass %, preferably 20 mass %, preferably 18 mass %, preferably 16 mass %, preferably 14 mass %, preferably 12 mass %, preferably 10 mass %, preferably 8 mass %, preferably 6 mass %, preferably 5 mass %, and preferably 4 mass %, based on the total amount (100 mass %) of the liquid crystal composition of the present invention.

In the first component in the present invention, kinds that can combine the compounds represented by General Formula (1) with each other are not particularly limited, and are used by appropriately combining depending on desired performances such as solubility at low temperature, a transition temperature, electrical reliability and a birefringence. For example, as one embodiment of the present invention, the kind of the compound of General Formula (1) used as the first component is that the first component is one kind of the compounds represented by General Formula (1). Alternatively, in other embodiment of the present invention, the first component is two kinds of the compounds represented by General Formula (1). In other embodiment of the present invention, the first component is three kinds of the compounds represented by General Formula (1). In other embodiment of the present invention, the first component is four kinds of the compounds represented by General Formula (1). In other embodiment of the present invention, the first component is five kinds of the compounds represented by General Formula (1). In other embodiment of the present invention, the first component is six kinds of the compounds represented by General Formula (1). In other embodiment of the present invention, the first component is seven kinds of the compounds represented by General Formula (1). In other embodiment of the present invention, the first component is eight kinds of the compounds represented by General Formula (1). In other embodiment of the present invention, the first component is nine kinds of the compounds represented by General Formula (1). In other embodiment of the present invention, the first component is a system containing ten or more kinds of the compounds represented by General Formula (1).

The liquid crystal composition of the present invention contains, as the second component, at least one selected from the group consisting of the compound represented by the following General Formula (2):

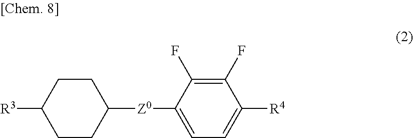

in General Formula (2), R³ is selected from the group consisting of an alkyl group having 1 to 15 carbon atoms, an alkenyl group having 2 to 15 carbon atoms and an alkoxy group having 1 to 15 carbon atoms,

Z⁰ represents a single bond, —CH₂O— or —OCH₂—, and

R⁴ is at least one group selected from the group consisting of an alkyl group having 1 to 15 carbon atoms and an alkoxy group having 1 to 15 carbon atoms, as the essential component.

The liquid crystal composition preferably contains the compound represented by General Formula (2) from the standpoint of the improvement of reliability in light resistance, heat resistance or burn-in. When Z⁰ is a single bond, the condition is preferably satisfied that R³ in General Formula (2) preferably satisfies the condition that R⁴ is an alkyl group in the case where R³ in General Formula (2) is an alkenyl group, from the standpoint of the improvement of reliability in light resistance, heat resistance or burn-in.

In General Formula (2), R³ is preferably selected from the group consisting of an alkyl group having 1 to 6 carbon atoms, an alkenyl group having 2 to 6 carbon atoms and an alkoxy group having 1 to 6 carbon atoms, and R⁴ is preferably at least one group selected from the group consisting of an alkyl group having 1 to 6 carbon atoms and an alkoxy group having 1 to 6 carbon atoms.

The preferred embodiment of the compound represented by General Formula (2) is preferably one or more kinds selected from the group consisting of the following formulae (2.1) to (2.26).

Compounds represented by

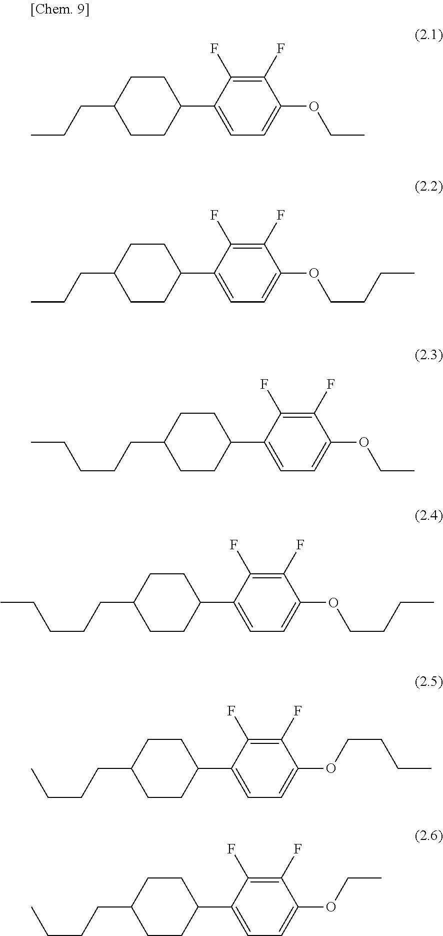

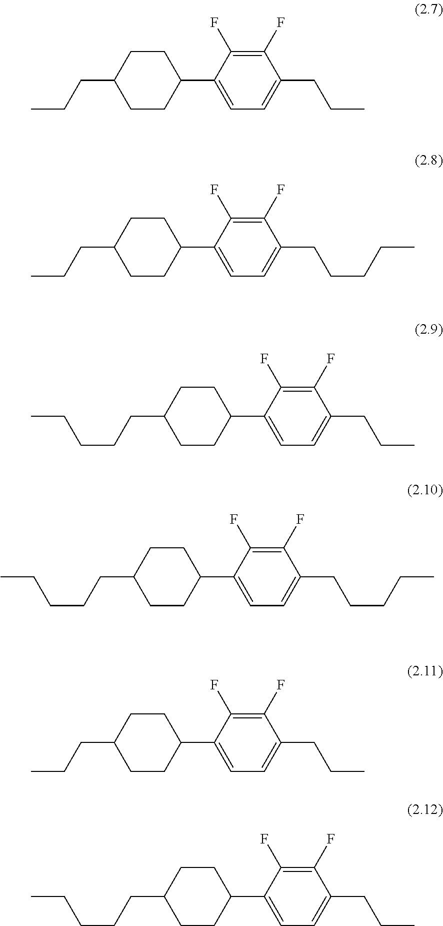

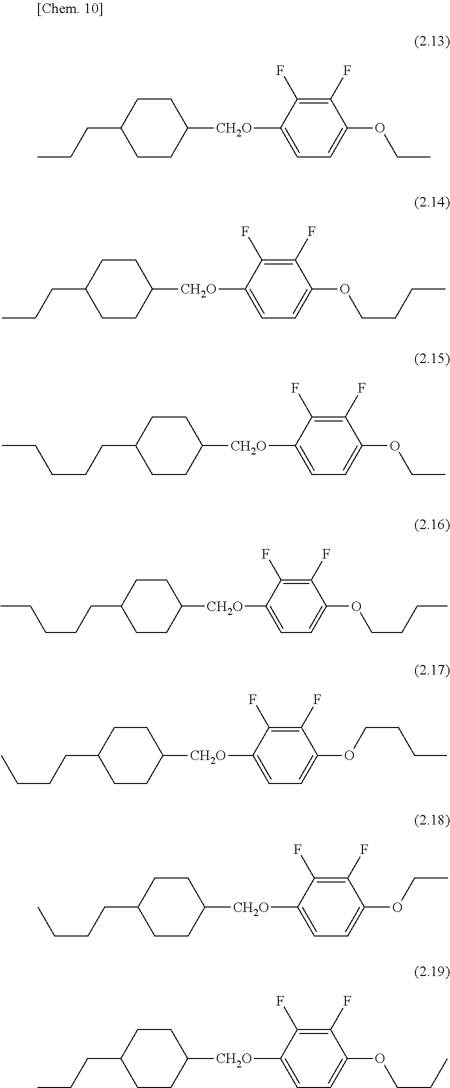

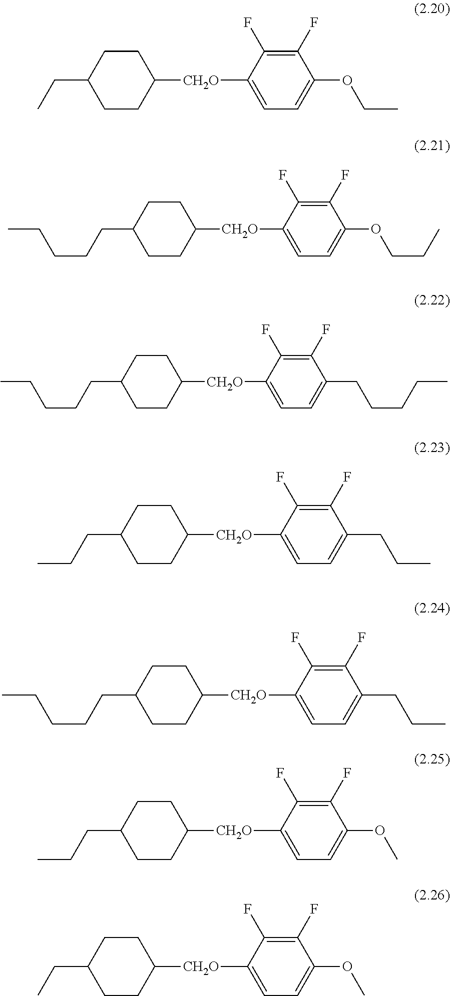

are preferred, and the formulae (2.1) to (2.6), the formulae (2.13) to (2.21) and the formulae (2.25) to (2.26) are more preferred.

In the case of considering reliability of the liquid crystal composition of the present invention to be important, Z⁰ is preferably a single bond. On the other hand, in the case of using the liquid crystal composition of the present invention in a display element of low voltage driving, Z⁰ is preferably —CH₂O— or —OCH₂—, and is more preferably —CH₂O— from the standpoint of dielectric anisotropy.

In the liquid crystal composition of the present invention, the lower limit of the content of the second component is, as one embodiment of the present invention, for example, preferably 1 mass %, preferably 3 mass %, preferably 5 mass %, preferably 7 mass %, preferably 9 mass %, preferably 10 mass %, preferably 12 mass %, preferably 15 mass %, preferably 16 mass %, preferably 18 mass %, preferably 20 mass %, preferably 22 mass %, preferably 24 mass %, preferably 26 mass %, preferably 28 mass %, preferably 30 mass %, preferably 32 mass %, preferably 35 mass %, and preferably 40 mass %, based on the total amount (100 mass %) of the liquid crystal composition of the present invention.

Further, in the liquid crystal composition of the present invention, the upper limit of the content of the second component is, as one embodiment of the present invention, for example, preferably 60 mass %, preferably 58 mass %, preferably 56 mass %, preferably 54 mass %, preferably 52 mass %, preferably 50 mass %, preferably 48 mass %, preferably 46 mass %, preferably 45 mass %, preferably 42 mass %, preferably 40 mass %, preferably 38 mass %, preferably 36 mass %, preferably 34 mass %, preferably 32 mass %, preferably 30 mass %, preferably 28 mass %, preferably 2 mass % preferably 24 mass %, preferably 26 mass %, preferably 24 mass % s, preferably 22 mass %, preferably 20 mass %, preferably 18 mass %, preferably 16 mass %, preferably 14 mass %, preferably 12 mass % and preferably 10 mass %, based on the total amount (100 mass %) of the liquid crystal composition of the present invention.

In the second component in the present invention, kinds that can combine the compounds represented by General Formula (2) with each other are not particularly limited, and are used by appropriately combining depending on desired performances such as solubility at low temperature, a transition temperature, electrical reliability and a birefringence. For example, as one embodiment of the present invention, the kind of the compound of General Formula (2) used as the second component is that the second component is one kind of the compound represented by General Formula (2). Alternatively, in other embodiment of the present invention, the second component is two kinds of the compounds represented by General Formula (2). In other embodiment of the present invention, the second component is three kinds of the compounds represented by General Formula (2). In other embodiment of the present invention, the second component is four kinds of the compounds represented by General Formula (2). In other embodiment of the present invention, the second component is five kinds of the compounds represented by General Formula (2) In other embodiment of the present invention, the second component is six kinds of the compounds represented by General Formula (2). In other embodiment of the present invention, the second component is seven kinds of the compounds represented by General Formula (2). In other embodiment of the present invention, the second component is eight kinds of the compounds represented by General Formula (2). In other embodiment of the present invention, the second component is nine kinds of the compounds represented by General Formula (2) In other embodiment of the present invention, the second component is a system containing ten or more kinds of the compounds represented by General Formula (2).

Preferably, the liquid crystal composition of the present invention further contains, as the third component, at least one compound selected from the group consisting of compounds represented by the following General Formula (3):

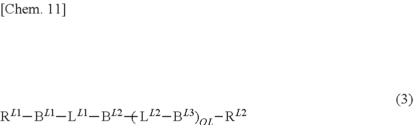

(in General Formula (3), R^{L1} and R^{L2} each independently represent an alkyl group having 1 to 8 carbon atoms, and one or non-adjacent two or more (—CH₂—)'s in the alkyl group may be each independently substituted with —CH═CH—, —C≡C—, —O—, —CO—, —COO— or —OCO—,

OL indicates 0, 1, 2 or 3,

B^{L1}, B^{L2} and B^{L3} each independently represent a group selected from the following (a) and (b):

(a) a 1,4-cyclohexylene group (one —CH₂— or non-adjacent 2 or more (—CH₂—)'s existing in this group may be substituted with —O—),

(b) a 1,4-phenylene group (one —CH═ or non-adjacent two or more (—CH═)'s existing in this group may be substituted with —N═),

wherein the hydrogen atom contained in the group represented by the above (a) and the above (b) may be each independently substituted with a cyano group, a chlorine atom or a fluorine atom,

L_{L1} and L_{L2} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF— or —C≡C—,

when OL is 2 or 3 and plural L^{L2}'s are present, they may be the same or different, and when OL is 2 or 3 and plural B^{L3}'s are present, they may be the same or different,

with the proviso that compounds represented by General Formula (1) and compounds represented by General Formula (2) are excluded.)

In General Formula (5) where the cyclic structure bonding thereto is a phenyl group (aromatic), R^{L1} and R^{L2} each are preferably a linear alkyl group having 1 to 5 carbon atoms, a linear alkoxy group having 1 to 4 (or more) carbon atoms, or an alkenyl group having 4 to 5 carbon atoms, and where the cyclic structure bonding thereto is a cyclohexane, a pyran, a dioxane or the like saturated cyclic structure, they each are preferably a linear alkyl group having 1 to 5 carbon atoms, a linear alkoxy group having 1 to 4 (or more) carbon atoms, or a linear alkenyl group having 2 to 5 carbon atoms.

In the case where the liquid crystal composition of the present invention is required to have chemical stability, it is desirable that the compound represented by General Formula (3) to be therein does not have a chlorine atom in the molecule thereof. With respect to the compound represented by General Formula (3) according to the present invention, it is preferred that the number of a halogen atom present in one molecule is zero or 1.

Adding such a compound represented by General Formula (3) to the liquid crystal composition is especially preferred in the point that the viscosity, Δn and the transition point of the liquid crystal composition can be changed arbitrarily while minimizing the driving voltage change for liquid crystal display elements.

The content of the third component in the liquid crystal composition of the present invention is, like that of the above-mentioned other components, suitably selected in relation to not only the use mode and the use object of the liquid crystal composition but also to the other components, and therefore a preferred range of the content of the third component contained in the liquid crystal composition is preferably differently and independently defined.

In the liquid crystal composition of the present invention, the lower limit of the content of the third component is, as one embodiment of the present invention, for example, preferably 1 mass % based on the total amount (100 mass %) of the liquid crystal composition of the present invention. Alternatively, in another embodiment of the present invention, the lower limit is preferably 10 mass %. Further, in another embodiment of the present invention, the lower limit is preferably 20 mass %. Further, in another embodiment of the present invention, the lower limit is preferably 30 mass %. Further, in another embodiment of the present invention, the lower limit is preferably 40 mass %. Further, in another embodiment of the present invention, the lower limit is preferably 50 mass %. Further, in another embodiment of the present invention, the lower limit is preferably 55 mass %. Further, in another embodiment of the present invention, the lower limit is preferably 60 mass %. Further, in another embodiment of the present invention, the lower limit is preferably 65 mass %. Further, in another embodiment of the present invention, the lower limit is preferably 70 mass %. Further, in another embodiment of the present invention, the lower limit is preferably 75 mass %. Further, in another embodiment of the present invention, the lower limit is preferably 80 mass %.

Further, in the liquid crystal composition of the present invention, the upper limit of the content of the third component is, for example, preferably 95 mass % based on the total amount (100 mass %) of the liquid crystal composition of the present invention in one embodiment of the present invention. Further, the upper limit is preferably 85 mass % in another embodiment of the present invention. Further, the upper limit is preferably 75 mass % in another embodiment of the present invention. Further, the upper limit is preferably 65 mass % in another embodiment of the present invention. Further, the upper limit is preferably 55 mass % in another embodiment of the present invention. Further, the upper limit is preferably 45 mass % in another embodiment of the present invention. Further, the upper limit is preferably 35 mass % in another embodiment of the present invention. Further, the lower limit is preferably 25 mass % in another embodiment of the present invention.

In the liquid crystal composition of the present invention, the content of the compound represented by General Formula (3) is required to be appropriately adjusted depending on required performances such as solubility at low temperature, a transition temperature, electrical reliability, a birefringence, process adaptability and drop marks described hereinunder, burn-in and dielectric anisotropy.

In the case where a liquid crystal composition maintaining a viscosity of the liquid crystal composition of the present invention low and having high response speed is required, it is preferred that the lower limit is high and the upper limit is high. Further, in the case where a liquid crystal composition maintaining Tni of the liquid crystal composition of the present invention high and having good temperature stability is required, it is preferred that the lower limit is high and the upper limit is high. When dielectric anisotropy is desired to be increased in order to maintain driving voltage low, it is preferred that the lower limit is low and the upper limit is low.

In the third component in the present invention, kinds that can combine the compounds represented by General Formula (3) with each other are not particularly limited, and are used by appropriately combining those depending on desired performances such as solubility at low temperature, a transition temperature, electrical reliability and a birefringence. For example, as one embodiment of the present invention, the kind of the compound of General Formula (3) used as the third component is that the third component is one kind of the compound represented by General Formula (3). Alternatively, in other embodiment of the present invention, the third component is two kinds of the compounds represented by General Formula (3). Further, in other embodiment of the present invention, the third component is three kinds of the compounds represented by General Formula (3). In other embodiment of the present invention, the third component is four kinds of the compounds represented by General Formula (3). In other embodiment of the present invention, the third component is five kinds of the compounds represented by General Formula (3). In other embodiment of the present invention, the third component is six kinds of the compounds represented by General Formula (3). In other embodiment of the present invention, the third component is seven kinds of the compounds represented by General Formula (3). In other embodiment of the present invention, the third component is eight kinds of the compounds represented by General Formula (3). In other embodiment of the present invention, the third component is nine kinds of the compounds represented by General Formula (3). In other embodiment of the present invention, the third component is a system containing ten or more kinds of the compounds represented by General Formula (3).

The total content of the compounds represented by General Formulas (1), (2) and (3) contained in the liquid crystal composition of the present invention is that, as the lower limit, 16 mass % is preferable, 18 mass % is preferable, 20 mass % is preferable, 23 mass % is preferable, 25 mass % is preferable, 28 mass % is preferable, 30 mass % is preferable, 32 mass % is preferable, 35 mass % is preferable, 38 mass % is preferable, 40 mass % is preferable, 42 mass % is preferable, 45 mass % is preferable, 47 mass % is preferable, and 50 mass % is preferable. As the upper limit, 35 mass % is preferable, 38 mass % is preferable, 40 mass % is preferable, 42 mass % is preferable, 45 mass % is preferable, 47 mass % is preferable, 50 mass % is preferable, 53 mass % is preferable, 55 mass % is preferable, 57 mass % is preferable, 60 mass % is preferable, 62 mass % is preferable, 65 mass % is preferable, 68 mass % is preferable, 70 mass % is preferable, 72 mass % is preferable, 75 mass % is preferable, 78 mass t is preferable, 80 mass % is preferable, 82 mass % is preferable, 85 mass % is preferable, 88 mass % is preferable, 90 mass % is preferable, 92 mass % is preferable, 95 mass % is preferable, 97 mass % is preferable, 98 mass % is preferable, 99 mass % is preferable, and 100 mass % is preferable.

The lower limit of the dielectric anisotropy (Δ∈) of the compound represented by General Formula (3) of the present invention is −1 in one embodiment, and −0.5 in another embodiment. Further, the value is 0 in another embodiment, and 0.5 in still another embodiment. Further, the value is 1 in another embodiment and −0.3 in still another embodiment. On the other hand, the upper limit of the dielectric anisotropy (Δ∈) of a liquid crystal composition including the compound represented by General Formula (3) is +1 in one embodiment, and +0.5 in another embodiment. Further, the value is 0 in another embodiment, and −0.5 in still another embodiment. Further, the value is +0.3 in another embodiment, and −0.7 in still another embodiment.

The compound represented by General Formula (3) in the present invention is preferably at least one kind of a compound selected from the group of the compounds represented by General Formulas (V-a) to (V-g).

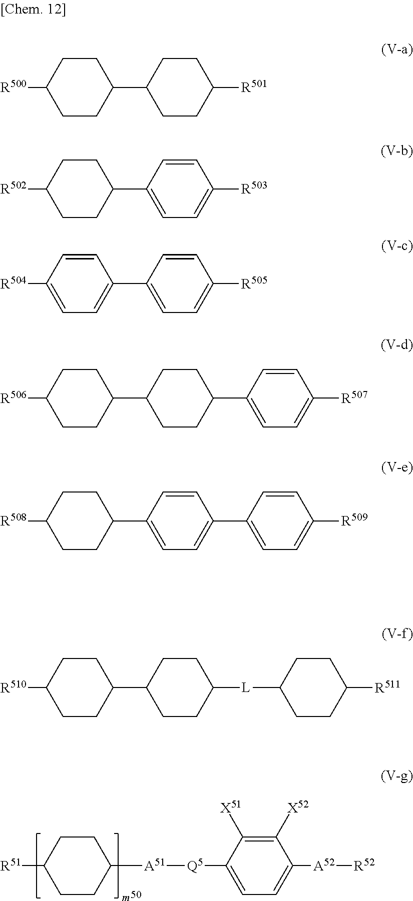

In General Formulas (V-a) to (V-f), R⁵⁰⁰ to R^{S11} each independently represent an alkyl group having 1 to 10 carbon atoms, an alkoxy group having 1 to 10 carbon atoms or an alkenyl group having 2 to 10 carbon atoms, and L is a divalent linking group; and, in General Formula (V-g), R^{S1} and R⁵² each independently represent an alkyl group having 1 to 5 carbon atoms, an alkenyl group having 2 to 5 carbon atoms or an alkoxy group having 1 to 4 carbon atoms, A⁵¹ and A^{S2} each independently represent a 1,4-cyclohexylene group or a 1,4-phenylene group, Q⁵ represents a single bond or COO—, X⁵¹ and X⁵² each independently represent a fluorine atom or a hydrogen atom, and m^{S0} is an integer of 0 or 1, but excluding the condition that General Formula (V-g) has the same structure as General Formulas (V-b) to (V-e). Further, it is preferred to exclude that X⁵¹ and X⁵² are simultaneously a fluorine atom in General Formula (V-g), and this is the same as that the compound represented by General Formula (3) in the present invention does not contain a halogen in the same ring structure.

In General Formulas (V-a) to (V-f), R⁵⁰⁰ to R^{S11} each independently preferably represent an alkyl group having 1 to 10 carbon atoms, an alkenyl group having 2 to 10 carbon atoms or an alkoxy group having 1 to 10 carbon atoms, and more preferably represent an alkyl group having 1 to 5 carbon atoms, an alkenyl group having 2 to 5 carbon atoms or an alkoxy group having 2 to 5 carbon atoms. Further, the divalent linking group (L) in General Formula (V-f) preferably represents a single bond, —CF₂O— or COO—.

In the case of indicating an alkenyl group in General Formulas (V-a) to (V-g), the same alkenyl groups described above are preferably exemplified, and the formulae (i) to (iv) are more preferably exemplified.

R⁵⁰⁰ and R^{S09} may be the same or different, but preferably represent different substituents.

In the case of using the compound selected from the group of seven compounds represented by General Formulas (V-a) to (V-g) as the third component, one to ten kinds of compounds are preferably contained in the third component, one to eight kinds of compounds are more preferably contained in the third component, one to five kinds of compounds are even more preferably contained in the third component, and two to four kinds of compounds are particularly preferably contained in the third component. In this case, the total content of the third component in the liquid crystal composition of the present invention is preferably 5 to 50%, more preferably 5 to 40 mass %, and even more preferably 5 to 35 mass %, and particularly preferably 7 to 30 mass %.

The lower limit of the preferred content of General Formula (V-a) is 1%, 2%, 3%, 5%, 7%, 10%, 15%, 20%, 25%, 30%, 35%, 40%, 45%, 50% and 55%, based on the total amount of the composition of the present invention. The upper limit of the preferred content is 95%, 90%, 85%, 80%, 75%, 70%, 65%, 60%, 55%, 50%, 45%, 40%, 35%, 30% and 25%, based on the total amount of the composition of the present invention.

The compound represented by General Formula (V-a) in the present invention is preferably a compound selected from the group of compounds represented by General Formula (V-a-1).

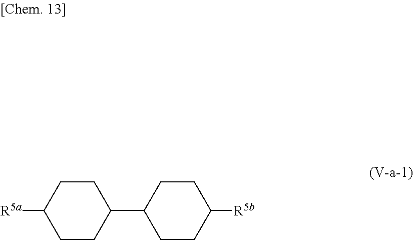

In General Formula (V-a-1), R^{5a} and R^{Sb} each independently represent an alkyl group having 1 to 5 carbon atoms.

More specifically, the compound represented by General Formula (V-a-1) is preferably any of the following compounds.

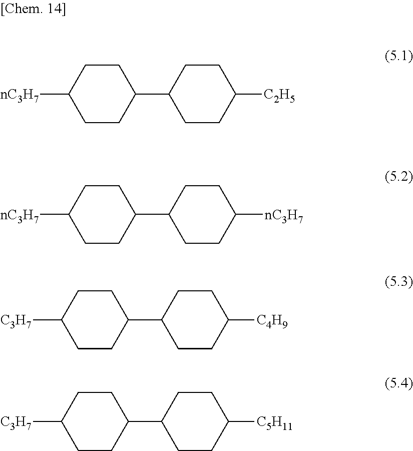

Compounds represented by General Formula (5.1), General Formula (5.3) and the formula (5.4) are more preferred.

For producing a high-response liquid crystal display element having a small viscosity, using a larger amount of the formula (5.1) is preferred, but for producing a liquid crystal display element having a high Tni and stable even at high temperatures, increasing the content of the compound represented by the formula (5.3) or the formula (5.4) is preferred.

The compound represented by General Formula (V-a) in the present invention is preferably a compound selected from the group of compounds represented by General Formula (V-a-2).

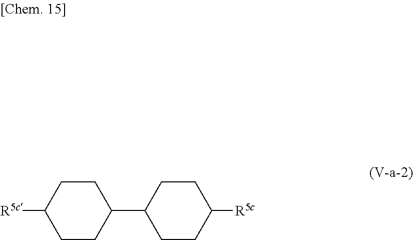

In General Formula (V-a-2), R^{5c′} and R^{5c} each independently represent an alkyl group having 1 to 5 carbon atoms, an alkenyl group having 2 to 5 carbon atoms, or an alkoxy group having 1 to 5 carbon atoms.

More specifically, the compound represented by General Formula (V-a-2) is preferably any of the following compounds.

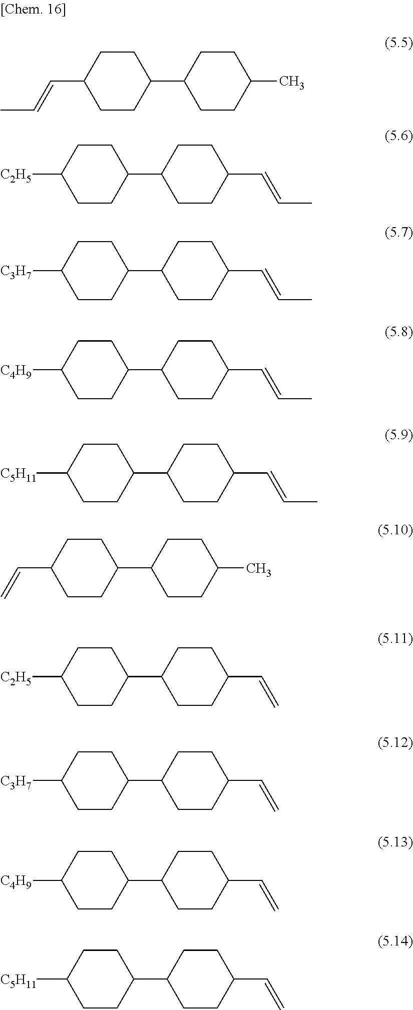

The compound represented by the above formula (5.6) or (5.7) is preferred and the compound represented by the formula (5.7) is more preferred.

The lower limit of the preferred total content of the compounds of General Formula (V-a-2) is 1%, 2%, 3%, 5%, 7%, 10%, 13%, 15%, 18%, 20%, 23%, 25%, 27%, 30%, 33% and 35%, based on the total amount of the composition of the present invention, and the upper limit is 80%, 70%, 60%, 50%, 45%, 40%, 37%, 35%, 33%, 30%, 28%, 25%, 23% and 20%, based on the total amount of the composition of the present invention.

Further, the compound represented by General Formula (V-a) is preferably a compound selected from the group of compounds represented by General Formula (V-a-3).

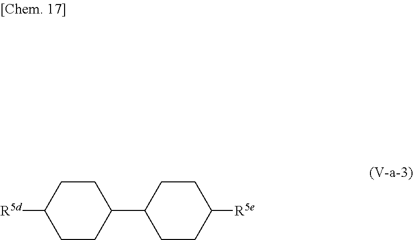

In General Formula (V-a-3), R^{5d} represents an alkyl group having 1 to 5 carbon atoms, and R^{5e} represents an alkoxy group having 1 to 4 carbon atoms.

More specifically, the compound represented by General Formula (V-a-3) is preferably any of the following compounds.

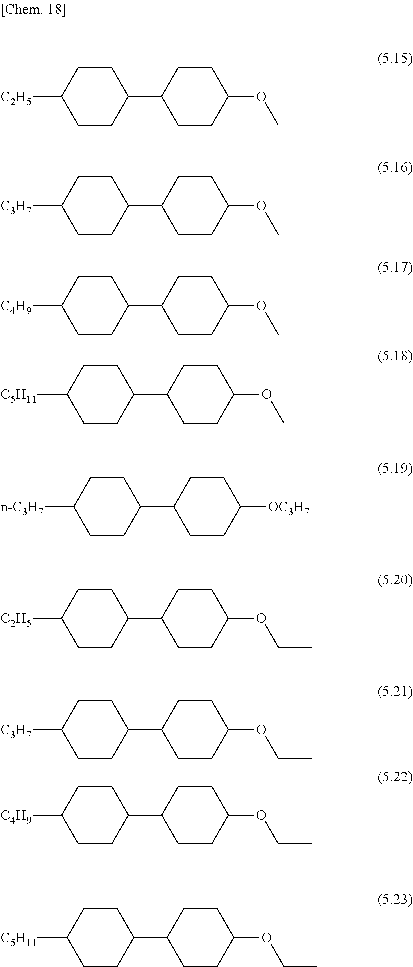

The compound of the above formula (5.16), the compound of the formula (5.18) and the compound of the formula (5.23) are preferred.

The liquid crystal composition of the present invention may further contain a compound of the formula (5.24) having a structure similar to that of the compound represented by General Formula (V-a).

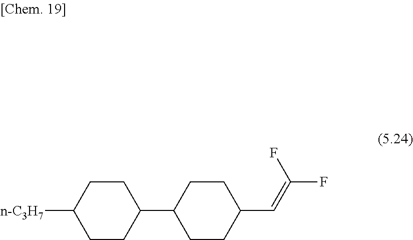

Further, the compound represented by General Formula (V-a) is preferably a compound selected from the group of compounds represented by General Formula (V-a-4).

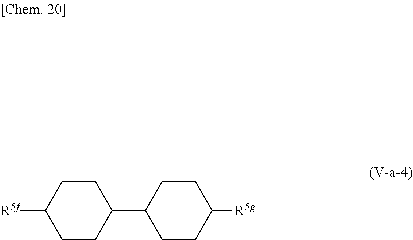

In General Formula (V-a-4), R^{Sf} and R^{5g} each independently represent an alkenyl group having 2 to 5 carbon atoms.

Further, the compound represented by General Formula (V-a-4) is preferably a compound selected from the group of compounds represented by the formulae (5.25) to (5.34), more preferably a compound represented by the formula (5.26), the formula (5.28) or the formula (5.31).

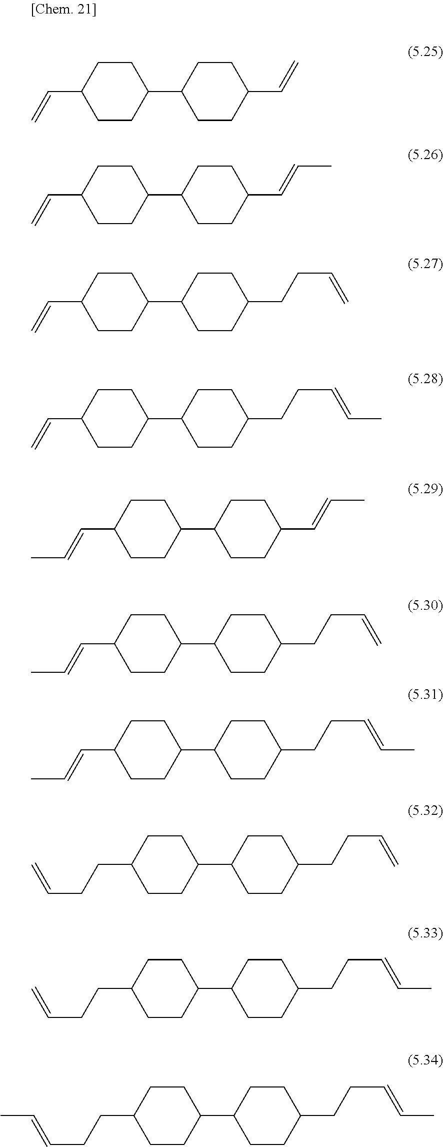

The lower limit of the preferred content of the compound represented by General Formula (V-b) is 1%, 2%, 3%, 5%, 7% and 10%, based on the total amount of the composition of the present invention. The upper limit of the preferred content is 20%, 15%, 13%, 10%, 8%, 7%, 6%, 5% and 3%, based on the total amount of the composition of the present invention.

Further, the compound represented by General Formula (V-b) is preferably a compound selected from the group of compounds represented by General Formula (V-b-1).

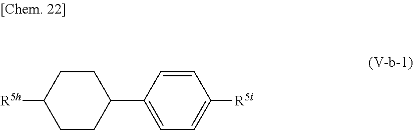

In General Formula (V-b-1), R^{5h} represents an alkyl group having 1 to 5 carbon atoms, an alkenyl group having 2 to 5 carbon atoms or an alkoxy group having 1 to 4 carbon atoms, R⁵ⁱ represents an alkyl group having 1 to 5 carbon atoms, an alkenyl group having 4 to 5 carbon atoms or an alkoxy group having 1 to 4 carbon atoms.

More specifically, the compound represented by General Formula (V-b-1) is preferably any of the following compounds.

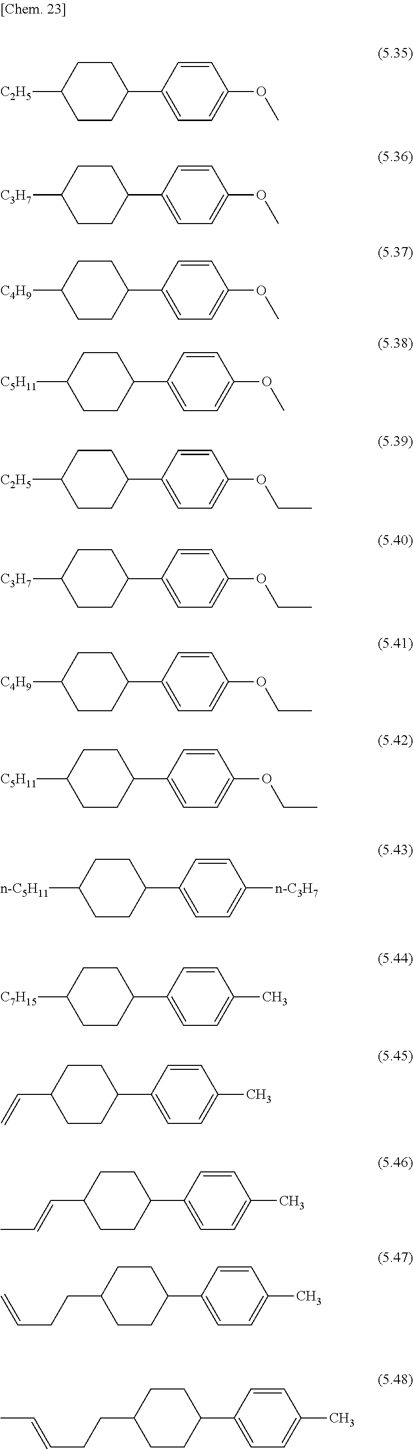

The compounds represented by the formula (5.36) and the formula (5.43) are preferred.

Further, the liquid crystal composition of the present invention may contain a compound selected from the group of compounds represented by General Formula (V-b-2) having a structure similar to that of the compound represented by General Formula (V-b-1).

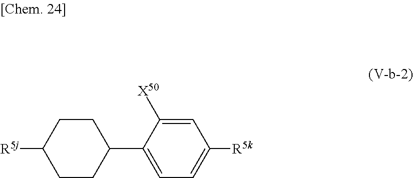

In General Formula (V-b-2), R^{5j} and R^{Sk} each independently represent an alkyl group having 1 to 5 carbon atoms, an alkenyl group having 2 to 5 carbon atoms or an alkoxy group having 1 to 4 carbon atoms, X^{S0} each independently represents a fluorine atom or a chlorine atom.

Further, the compound represented by General Formula (V-b-2) is preferably a compound represented by the formula (5.44).

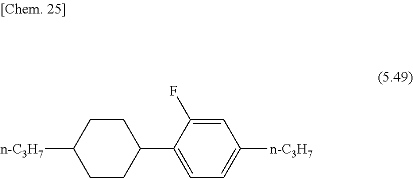

The lower limit of the preferred content of the compound represented by General Formula (V-c) is 1%, 2%, 3%, 5%, 7% and 10%, based on the total amount of the composition of the present invention. The upper limit of the preferred content is 20%, 15%, 13%, 10%, 8%, 7%, 6%, 5% and 3%, based on the total amount of the composition of the present invention.

Further, the compound represented by General Formula (V-c) is preferably a compound selected from the group of compounds represented by General Formula (V-c-1).

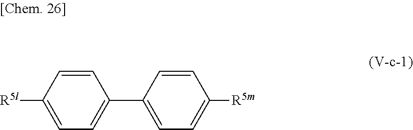

In General Formula (V-c-1), R^{5l} and R^{Sm} each independently represent an alkyl group having 1 to 5 carbon atoms, an alkenyl group having 4 to 5 carbon atoms or an alkoxy group having 1 to 4 carbon atoms.

More specifically, the compound represented by General Formula (V-c-1) is preferably any of the following compounds.

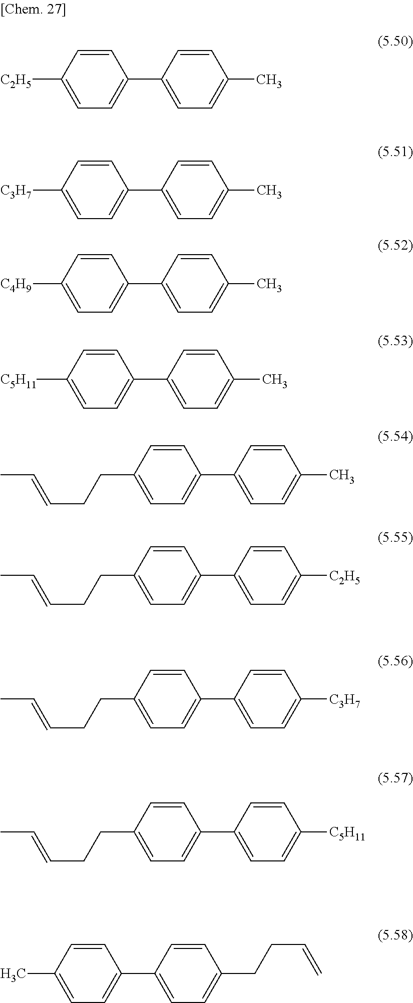

Compounds represented by the formula (5.53), the formula (5.54) and the formula (5.58) are preferred.

Further, the composition may contain a compound selected from the group of compounds represented by General Formula (V-c-2) having a structure similar to that of the compound represented by General Formula (V-c-1).

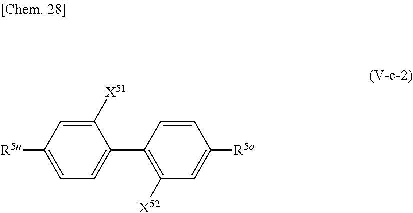

In General Formula (V-c-2), R⁵ⁿ and R^{So} each independently represent an alkyl group having 1 to 5 carbon atoms, an alkenyl group having 4 to 5 carbon atoms or an alkoxy group having 1 to 4 carbon atoms, and X⁵¹ and X⁵² each independently represent a fluorine atom or a hydrogen atom, provided that any one of X⁵¹ and X⁵² is a fluorine atom.

Further, the compound represented by General Formula (V-c-2) is preferably a compound represented by the formula (5.59).

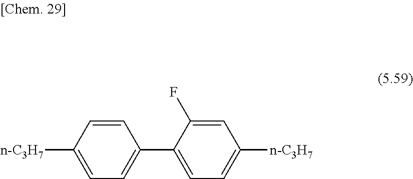

The lower limit of the preferred content of the compound represented by General Formula (V-d) is 1%, 2%, 3%, 5%, 7%, 10%, 14%, 16%, 20%, 23%, 26%, 30%, 35% and 40%, based on the total amount of the composition of the present invention. The upper limit of the preferred content of the compound represented by General Formula (V-d) is 50%, 40%, 35%, 30%, 20%, 15%, 10% and 5%, based on the total amount of the composition of the present invention.

Further, the compound represented by General Formula (V-d) is, for example, preferably a compound selected from the group of compounds represented by General Formula (V-d-1).

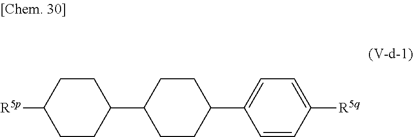

In General Formula (V-d-1), R^{5p} represents an alkyl group having 1 to 5 carbon atoms, and R^{5q} represents an alkyl group having 1 to 5 carbon atoms or an alkoxy group having 1 to 4 carbon atoms.

More specifically, the compound represented by General Formula (V-d-1) is preferably any of the following compounds.

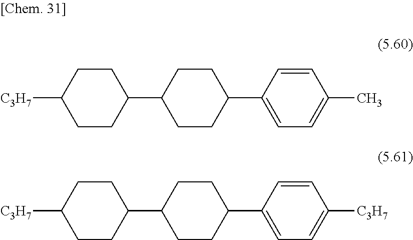

The compound represented by General Formula (V-d-1) is more preferably a compound represented by the formula (5.60).

Further, the compound represented by General Formula (V-d) is, for example, preferably a compound selected from the group of compounds represented by General Formula (V-d-2).

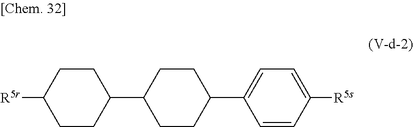

In General Formula (V-d-2), R^{5r} represents an alkyl group having 1 to 5 carbon atoms, and R^{5s} represents an alkoxy group having 1 to 4 carbon atoms.

Further, the compound represented by General Formula (V-d-1) is, for example, preferably any of compounds represented by the formulae (5.62) to (5.65), and among these, the compound represented by the formula (5.65) is more preferred.

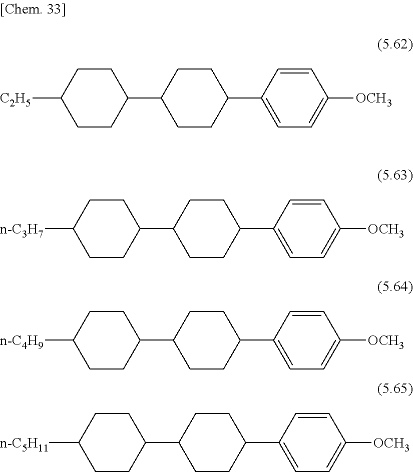

The compound represented by General Formula (V-d) in the present invention is, for example, preferably a compound selected from the group of compounds represented by General Formula (V-d-3).

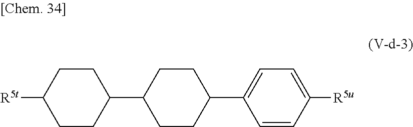

(In General Formula (V-d-3), R^{5t} represents an alkenyl group having 2 to 5 carbon atoms, and R^{5u} represents an alkyl group having 1 to 5 carbon atoms or an alkoxy group having 1 to 4 carbon atoms.)

Further, the compound represented by General Formula (V-d-3) is, for example, preferably any of compounds represented by the formulae (5.66) to (5.68).

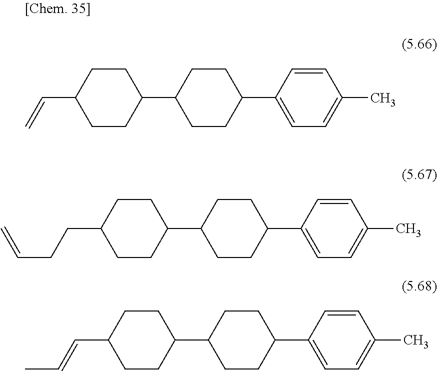

The lower limit of the preferred content of the compound represented by General Formula (V-e) is 1%, 2%, 3%, 5%, 7%, 10%, 14%, 16%, 20%, 23%, 26%, 30%, 35% and 40%, based on the total amount of the composition of the present invention. The upper limit of the preferred content of the compound represented by General Formula (V-e) is 50%, 40%, 35%, 30%, 20%, 15%, 10% and 5%, based on the total amount of the composition of the present invention.

The compound represented by General Formula (V-e) in the present invention is preferably a compound selected from the group of compounds represented by General Formula (V-e-1).

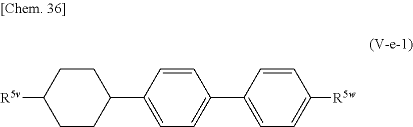

In General Formula (V-e-1), R^{5v} and R^{5w} each independently represent an alkenyl group having 2 to 5 carbon atoms, an alkyl group having 1 to 5 carbon atoms or an alkoxy group having 1 to 4 carbon atoms.

More specifically, the compound represented by General Formula (V-e-1) is preferably any of the following compounds.

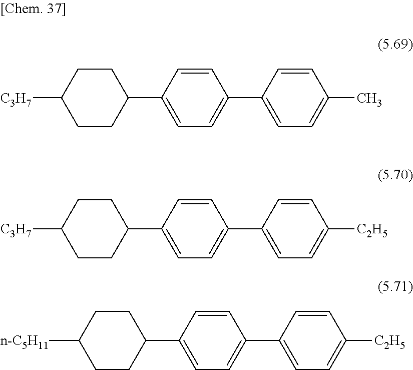

The compound represented by General Formula (V-e) in the present invention is more preferably a compound selected from the group of compounds represented by General Formula (V-e-2).

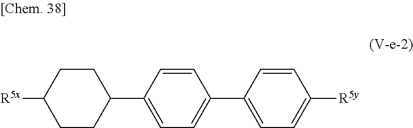

In General Formula (V-e-2), R^{5x} represents an alkenyl group having 2 to 5 carbon atoms, and R^{5y} each independently represents an alkyl group having 1 to 5 carbon atoms or an alkoxy group having 1 to 4 carbon atoms.

The compound represented by General Formula (V-e-2) is, for example, preferably a compound represented by the formula (5.72) or the formula (5.73).

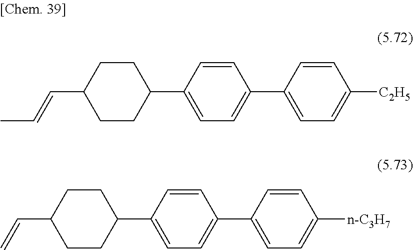

The compound represented by General Formula (V-e) in the present invention is preferably a compound selected from the group of compounds represented by General Formula (V-e-3).

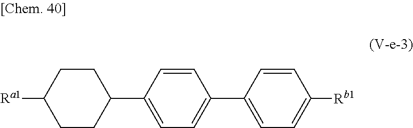

In General Formula (V-e-3), R^{a1} represents an alkyl having 1 to 5 carbon atoms, and R^{b1} represents an alkoxy group having 1 to 4 carbon atoms.

Further, the compound represented by General Formula (V-e-3) is, for example, preferably a compound selected from the group of compounds represented by the formula (5.74) to the formula (5.76), and is especially preferably a compound represented by the formula (5.76).

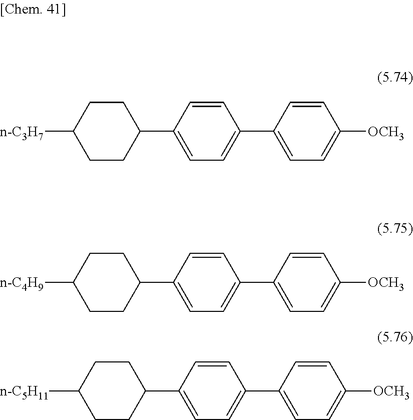

The lower limit of the preferred content of the compound represented by General Formula (V-f) is 1%, 2%, 3%, 5%, 7%, 10%, 14%, 16%, 20%, 23%, 26% and 30%, based on the total amount of the composition of the present invention. The upper limit of the preferred content of the compound represented by General Formula (V-f) is 40%, 35%, 30%, 20%, 15%, 10% and 5%, based on the total amount of the composition of the present invention.

The compound represented by General Formula (V-f) in the present invention is, for example, preferably a compound selected from the group of compounds represented by General Formula (V-f-1).

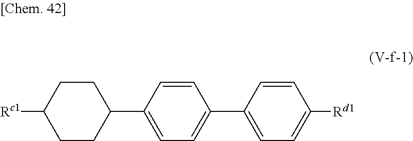

In General Formula (V-f-1), R^{c1} and R^{d1} each independently represent an alkenyl group having 2 to 5 carbon atoms, an alkyl group having 1 to 5 carbon atoms, or an alkoxy group having 1 to 4 carbon atoms.

Further, the compound represented by General Formula (V-f-1) is, for example, preferably a compound of the formula (5.77).

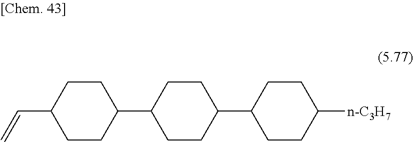

The compound represented by General Formula (V-f) in the present invention is, for example, preferably a compound selected from the group of compounds represented by General Formula (V-f-2).

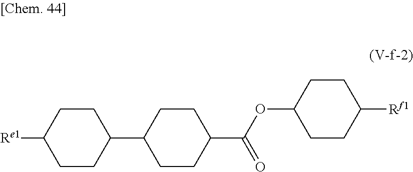

In General Formula (V-f-2), R^{e1} and R^{f1} each independently represent an alkenyl group having 2 to 5 carbon atoms, an alkyl group having 1 to 5 carbon atoms or an alkoxy group having 1 to 4 carbon atoms.

Further, the compound represented by General Formula (V-f-2) is, for example, preferably a compound represented by any of the formulae (5.78) to (5.82), and is especially preferably a compound represented by the formula (5.79) and/or the formula (5.82).

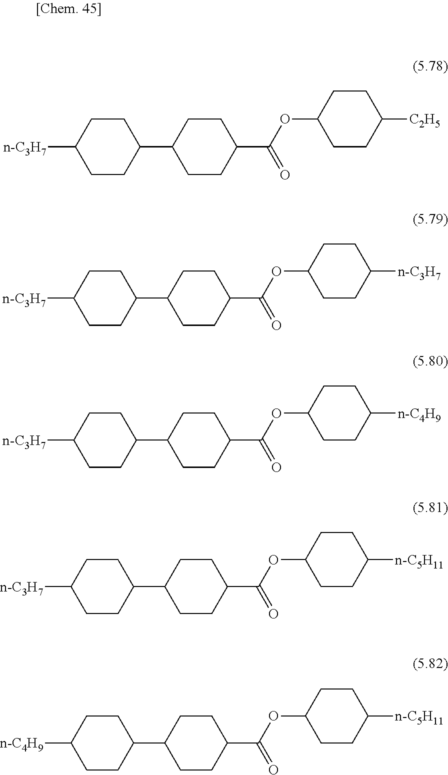

The compound represented by General Formula (V-f-2) is preferable from the standpoint of the improvement in a transition temperature, but an ester group of three-ring structure is relatively easy to decompose, and is easy to hold ions. Therefore, there is a possibility that the compound is poor in the standpoint of reliability.

The lower limit of the preferred content of the compound represented by General Formula (V-g) is 1%, 2%, 3%, 5%, 7%, 10%, 14%, 16% and 20%, based on the total amount of the composition of the present invention. The upper limit of the preferred content of the compound represented by General Formula (V-g) is 30%, 25%, 23%, 20%, 18%, 15%, 10% and 5%, based on the total amount of the composition of the present invention.

The compound represented by General Formula (V-g) in the present invention is preferably a compound represented by General Formula (V-g-1).

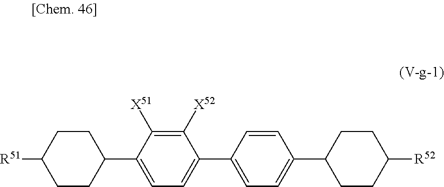

In General Formula (V-g-1), R⁵¹ and R^{S2} each independently represent an alkyl group having 1 to 5 carbon atoms, an alkenyl group having 2 to 5 carbon atoms or an alkoxy group having 1 to 4 carbon atoms, and X⁵¹ and X⁵² each independently represent a fluorine atom or a hydrogen atom.

The compound represented by General Formula (V-g) in the present invention is preferably a compound represented by General Formula (V-g-2).

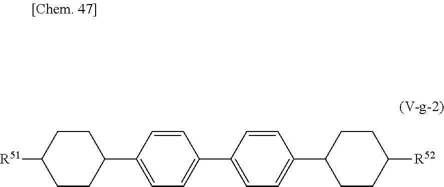

In General Formula (V-g-2), R^{S1} and R⁵² each independently represent an alkyl group having 1 to 5 carbon atoms, an alkenyl group having 2 to 5 carbon atoms or an alkoxy group having 1 to 4 carbon atoms.

Further, the compound represented by General Formula (V-g-2) is preferably a compound of any of the formulae (5.83) to (5.86), and is preferably a compound of the formula (5.84).

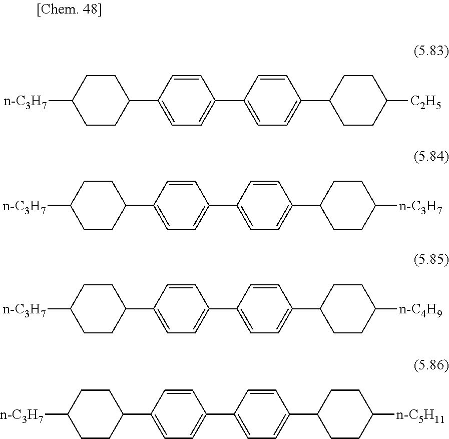

Further, the compound represented by General Formula (V-g) is preferably the compound represented by General Formula (V-g-2).

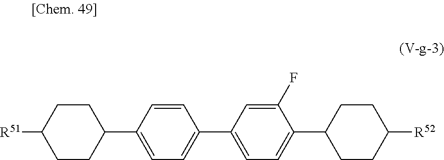

In General Formula (V-g-3), R^{S1} and R⁵² each independently represent an alkyl group having 1 to 5 carbon atoms, an alkenyl group having 2 to 5 carbon atoms or an alkoxy group having 1 to 4 carbon atoms.

Further, the compound represented by General Formula (V-g-3) is preferably compounds represented by the formulae (5.87) to (5.89), and more preferably the compound represented by the formula (5.87).

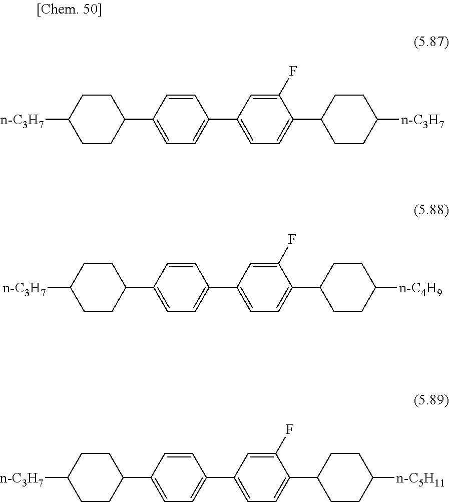

The compound represented by General Formula (V-g) in the present invention is preferably a compound represented by General Formula (V-g-4).

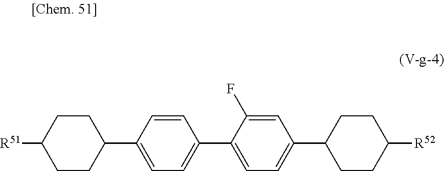

In General Formula (V-g-4), R^{S1} and R⁵² each independently represent an alkyl group having 1 to 5 carbon atoms, an alkenyl group having 2 to 5 carbon atoms or an alkoxy group having 1 to 4 carbon atoms.

Further, the compound represented by General Formula (V-g-4) is compounds represented by the formulae (5.85) to (5.87), and preferably the compound represented by the formula (5.85).

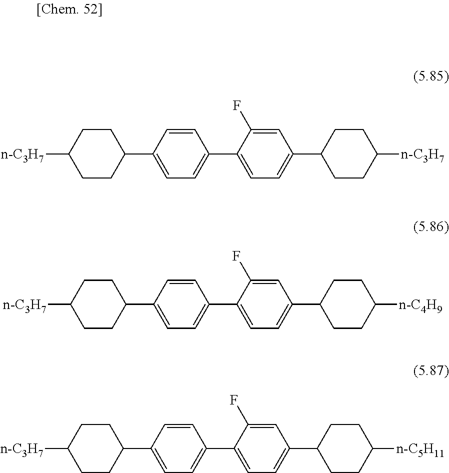

The compound represented by General Formula (V-g) of the present invention is preferably a compound represented by General Formula (V-g-5).

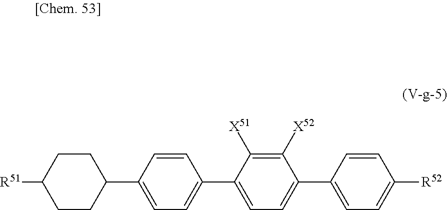

In General Formula (V-g-5), R^{S1} and R⁵² each independently represent an alkyl group having 1 to 5 carbon atoms, an alkenyl group having 2 to 5 carbon atoms or an alkoxy group having 1 to 4 carbon atoms, and X⁵¹ and X⁵² each independently represent a fluorine atom or a hydrogen atom.

The compound represented by General Formula (V-g) in the present invention is preferably a compound represented by General Formula (V-g-6).

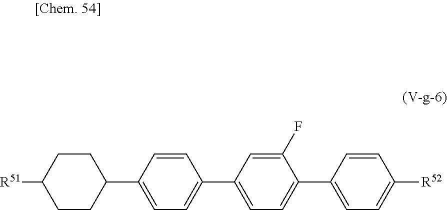

In General Formula (V-g-6), R^{S1} and R⁵² each independently represent an alkyl group having 1 to 5 carbon atoms, an alkenyl group having 2 to 5 carbon atoms or an alkoxy group having 1 to 4 carbon atoms.

Further, the compound represented by General Formula (V-g-6) is preferably compounds represented by the formulae (5.88) to (5.4), and more preferably compounds represented by the formula (5.88) and/or the formula (5.91).

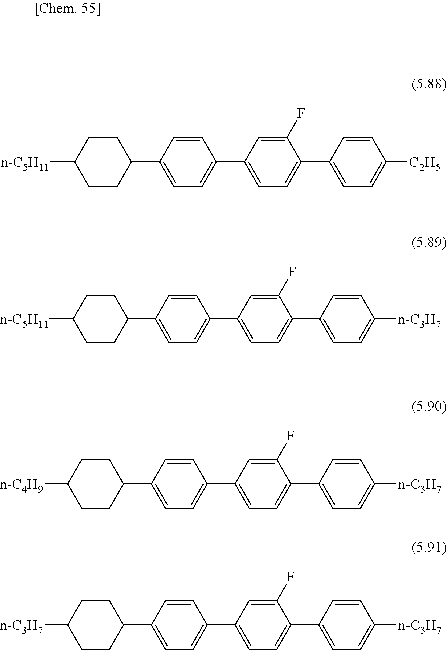

The compound represented by General Formula (V-g) in the present invention is preferably a compound represented by General Formula (V-g-7).

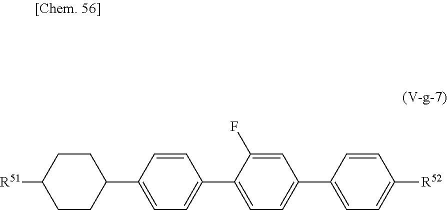

In General Formula (V-g-7), R⁵¹ and R^{S2} each independently represent an alkyl group having 1 to 5 carbon atoms, an alkenyl group having 2 to 5 carbon atoms or an alkoxy group having 1 to 4 carbon atoms.

Further, the compound represented by General Formula (V-g-7) is preferably compounds represented by the formulae (5.92) to (5.95), and more preferably compounds represented by the formula (5.92) and/or the formula (5.93).

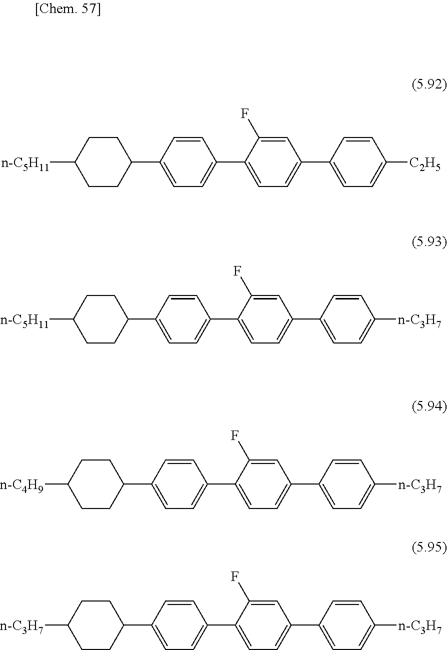

The compound represented by General Formula (V-g) in the present invention is preferably a compound represented by General Formula (V-g-9).

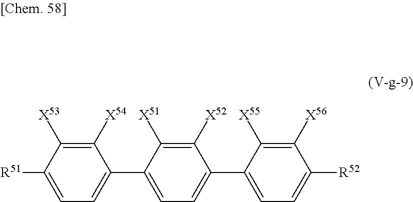

In General Formula (V-g-9), R⁵¹ and R^{S2} each independently represent an alkyl group having 1 to 5 carbon atoms, an alkenyl group having 2 to 5 carbon atoms or an alkoxy group having 1 to 4 carbon atoms, and X^{S1} to X^{S6} each independently represent a fluorine atom or a hydrogen atom.

Further, in General Formula (V-g-9), with respect to each of the combinations of X⁵¹ and X⁵², X⁵³ and X⁵⁴, and X⁵⁵ and X⁵⁶, it is preferred that at least one of the two groups is a fluorine atom.

The lower limit of the preferred content of the compound of General Formula (V-g-9) is 1%, 2%, 3%, 5% and 7%, based on the total amount of the composition of the present invention. The upper limit of the preferred content of those compounds is 25%, 20%, 15%, 13%, 10% and 9%.

The compound represented by General Formula (V-g) in the present invention is preferably compounds represented by General Formulas (V-g-10) to (V-g-13).

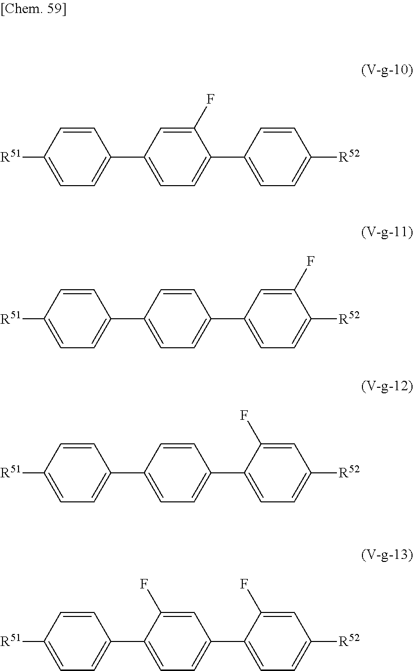

In General Formulas (V-g-10) to (V-g-13), R⁵¹ and R⁵² each independently represent an alkyl group having 1 to 5 carbon atoms, an alkenyl group having 2 to 5 carbon atoms or an alkoxy group having 1 to 4 carbon atoms.

The lower limit of the preferred content of the compound of General Formula (V-g-10) is 1%, 2%, 3%, 5% and 7%, based on the total amount of the composition of the present invention. The upper limit of the preferred content of those compounds is 25%, 20%, 15%, 13%, 10% and 9%.

Further, the compound represented by General Formula (V-g) is preferably a compound represented by General Formula (V-g-10). Preferred examples of the compound represented by General Formula (V-g-10) are compounds of the following formulae (5.100) to (5.116).

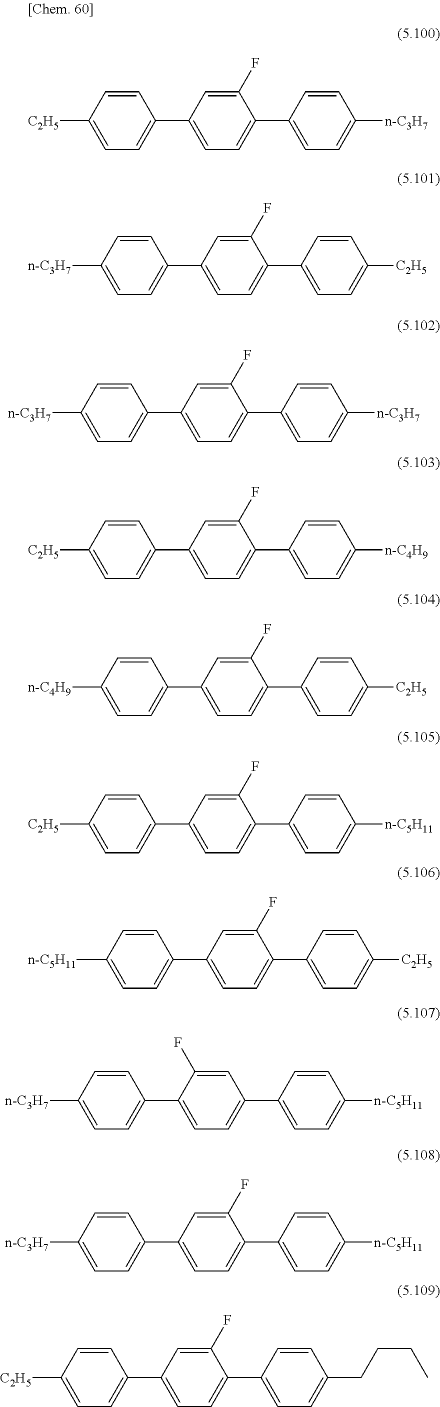

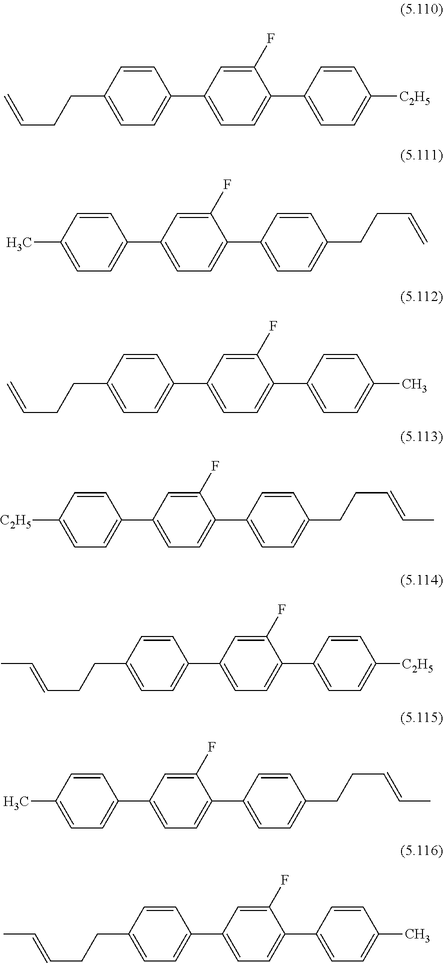

The lower limit of the content of the third component represented by General Formulas (V-a) to (V-g) is preferably 20 mass %, 25 mass %, 30 mass %, 35 mass %, 40 mass %, 45 mass % and 50 mass %, in this order. Further, the upper limit of the content of the third component represented by General Formulas (V-a) to (V-g) is preferably 70 mass %, 65 mass %, 60 mass %, 55 mass %, 50 mass %, 45 mass %, 40 mass %, 35 mass % and 30 mass %, in this order.

The particularly preferred embodiment of the third component of the present invention is that in the compounds represented by General Formulas (5.100) to (5.108) and the formulae (5.109) to (5.114), one to three different kinds of compounds are mixed. In such a case, the mass ratio of the whole third component in the present invention is particularly preferably 32 to 40 mass % based on the whole liquid crystal composition.

The liquid crystal composition of the present invention preferably further contains, as the fourth component, at least one selected from the groups of compounds represented by the following General Formula (4):

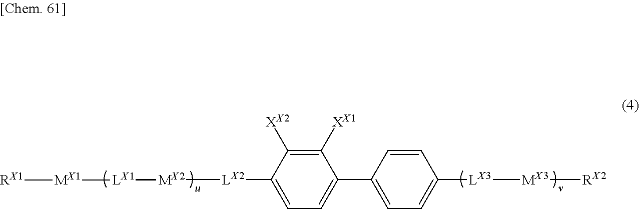

In General Formula (4), R^{X1} and R^{X2} each independently represent an alkyl group having 1 to 10 carbon atoms, an alkoxy group having 1 to 10 carbon atoms, or an alkenyl group having 2 to 10 carbon atoms, and one methylene group or two or more non-adjacent methylene groups existing in these groups may be substituted with —O— or —S—, and one or more hydrogen atoms exiting in these groups may be substituted with a chlorine atom and/or a fluorine atom,

u and v each independently indicate 0, 1 or 2, and u+v is 2 or less,

M^{X1}, M^{X2} and M^{X3} each independently represent a group selected from the following (a) and (b):

(a) a trans-1,4-cyclohexylene group (one methylene group or two or more non-adjacent methylene groups existing in this group may be substituted with —O— or —S—),

(b) a 1,4-phenylene group (one —CH═ or two or more non-adjacent (—CH═)'s existing in this group may be substituted with —N═),

the hydrogen atom contained in the group of the above (a) or the above (b) may be substituted with a group selected from a cyano group, a fluorine atom, a trifluoromethyl group and a trifluoromethoxy group, and plural M^{X2}'s and/or M^{X3}'s, if any, may be the same or different,

L^{X1}, L^{X2} and L^{X3} each independently represent a single bond, —COO—, —OCO—, —CH₂CH₂—, —(CH₂)₄—, —OCH₂—, —CH₂O—, —OCF₂—, —CF₂O—, —CH═CH— or —C≡C—, and plural L^{X1}'s and/or L^{X3} s, if any, may be the same or different, and

X^{X1} and X^{X2} each independently represent a trifluoromethyl group, a trifluoromethoxy group or a fluorine atom, provided that any one of X^{X1} and X^{X2} represents a fluorine atom, with the proviso that the compounds represented by General Formula (1) to General Formula (4) are excluded.

In the case where the cyclic structure bonding thereto is a phenyl group (aromatic), R^{x1} and R^{x2} each are preferably a linear or branched alkyl group having 1 to 10 carbon atoms, a linear or branched alkoxy group having 1 to 10 (or more) carbon atoms, or an alkenyl group having 2 to 10 carbon atoms, more preferably a linear alkyl group having 1 to 5 carbon atoms, a linear alkoxy group having 1 to 4 (or more) carbon atoms, or an alkenyl group having 4 to 5 carbon atoms. On the other hand where the cyclic structure bonding thereto is a cyclohexane, a pyran, a dioxane or the like saturated cyclic structure, R^{x1} and R^{x2} each are preferably a linear or branched alkyl group having 1 to 10 carbon atoms, a linear alkoxy group having 1 to 10 (or more) carbon atoms, or a linear alkenyl group having 2 to 10 carbon atoms, more preferably a linear alkyl group having 1 to 5 carbon atoms, a linear alkoxy group having 1 to 4 (or more) carbon atoms, or a linear alkenyl group having 2 to 5 carbon atoms.

In the case where improving the response speed of a display element is considered to be important, an alkenyl group is preferred in General Formula (4) in the present invention, but where reliability such as a voltage holding ratio or the like is considered to be important, an alkyl group is preferred.

The alkyl group and alkoxy group in General Formula (4) are preferably the same alkyl group and/or alkoxy group as in the first to third components. Further, the alkenyl group in General Formula (4) is preferably the same alkenyl group as in the third component, and more preferably the above formulae (i) to (iv).

Addition of the compound represented by General Formula (4) to the liquid crystal composition is particularly preferred in the standpoint that it changes a driving voltage of a liquid crystal display element.

The content of the fourth component in the liquid crystal composition of the present invention is appropriately selected by not only use embodiment and use purpose of a liquid crystal composition, but the relationship with other components, similar to the above-described first component and second component that are essential components. Therefore, the preferred range of the content of the fourth component contained in the liquid crystal composition is preferably individually independent depending on the embodiments, respectively.

In the liquid crystal composition of the present invention, the lower limit of the content of the fourth component is, as one embodiment of the present invention, for example, preferably 1 mass % based on the total amount (100 mass %) of the liquid crystal composition of the present invention. Alternatively, in another embodiment of the present invention, the lower limit is preferably 10 mass %. Further, in another embodiment of the present invention, the lower limit is preferably 20 mass %. In another embodiment of the present invention, the lower limit is preferably 30 mass %. In another embodiment of the present invention, the lower limit is preferably 40 mass %. In another embodiment of the present invention, the lower limit is preferably 50 mass %. In another embodiment of the present invention, the lower limit is preferably 55 mass %. In another embodiment of the present invention, the lower limit is preferably 60 mass %. In another embodiment of the present invention, the lower limit is preferably 65 mass %. In another embodiment of the present invention, the lower limit is preferably 70 mass %. In another embodiment of the present invention, the lower limit is preferably 75 mass %. In another embodiment of the present invention, the lower limit is preferably 80 mass %.

Further, in the liquid crystal composition of the present invention, the upper limit of the content of the fourth component is, as one embodiment of the present invention, for example, preferably 95 mass % based on the total amount (100 mass %) of the liquid crystal composition of the present invention. Further, in another embodiment of the present invention, the upper limit is preferably 85 mass %. In another embodiment of the present invention, the upper limit is preferably 75 mass %. In another embodiment of the present invention, the upper limit is preferably 65 mass %. In another embodiment of the present invention, the upper limit is preferably 55 mass %. In another embodiment of the present invention, the upper limit is preferably 45 mass %. In another embodiment of the present invention, the upper limit is preferably 35 mass %. In another embodiment of the present invention, the upper limit is preferably 25 mass %.

In the liquid crystal composition of the present invention, the content of the compound represented by General Formula (4) is required to be appropriately adjusted depending on required performances such as solubility at low temperature, a transition temperature, electrical reliability, a birefringence, process adaptability and drop marks described hereinunder, burn-in and dielectric anisotropy.

In the case where a liquid crystal composition maintaining a viscosity of the liquid crystal composition of the present invention low and having high response speed is required, it is preferred that the lower limit is high and the upper limit is high. Further, in the case where a liquid crystal composition maintaining Tni of the liquid crystal composition of the present invention high and having good temperature stability is required, it is preferred that the lower limit is high and the upper limit is high. When dielectric anisotropy is desired to be increased in order to maintain driving voltage low, it is preferred that the lower limit is low and the upper limit is low.

In the fourth component in the present invention, kinds that can combine the compounds represented by General Formula (4) with each other are not particularly limited, and are used by appropriately combining those depending on desired performances such as solubility at low temperature, a transition temperature, electrical reliability and a birefringence. For example, as one embodiment of the present invention, the kind of the compound of General Formula (4) used as the fourth component is that the fourth component is one kind of the compound represented by General Formula (4). Alternatively, in another embodiment of the present invention, the fourth component is two kinds of the compounds represented by General Formula (4). Further, in another embodiment of the present invention, the fourth component is three kinds of the compounds represented by General Formula (4). In another embodiment of the present invention, the fourth component is four kinds of the compounds represented by General Formula (4). In another embodiment of the present invention, the fourth component is five kinds of the compounds represented by General Formula (4). In another embodiment of the present invention, the fourth component is six kinds of the compounds represented by General Formula (4). In another embodiment of the present invention, the fourth component is seven kinds of the compounds represented by General Formula (4). In another embodiment of the present invention, the fourth component is eight kinds of the compounds represented by General Formula (4). In another embodiment of the present invention, the fourth component is nine kinds of the compounds represented by General Formula (4). In another embodiment of the present invention, the fourth component is a system containing ten or more kinds of the compounds represented by General Formula (4).

The total content of the compounds represented by General Formulas (1), (2) and (4) contained in the liquid crystal composition of the present invention is that as the lower limit, 16 mass % is preferable, 18 mass % is preferable, 20 mass % is preferable, 23 mass % is preferable, 25 mass % is preferable, 28 mass % is preferable, 30 mass % is preferable, 32 mass % is preferable, 35 mass % is preferable, 38 mass % is preferable, 40 mass % is preferable, 42 mass % is preferable, 45 mass % is preferable, 47 mass % is preferable, and 50 mass % is preferable. As the upper limit, 35 mass % is preferable, 38 mass % is preferable, 40 mass % is preferable, 42 mass % is preferable, 45 mass % is preferable, 47 mass % is preferable, 50 mass % is preferable, 53 mass % is preferable, 55 mass % is preferable, 57 mass % is preferable, 60 mass % is preferable, 62 mass % is preferable, 65 mass % is preferable, 68 mass % is preferable, 70 mass % is preferable, 72 mass % is preferable, 75 mass % is preferable, 78 mass % is preferable, 80 mass % is preferable, 82 mass % is preferable, 85 mass % is preferable, 88 mass % is preferable, and 90 mass % is preferable.

The lower limit of the dielectric anisotropy (Δ∈) of the compound represented by General Formula (4) of the present invention is −20 in one embodiment, and −15 in another embodiment. Further, the value is −13 in another embodiment, and −12 in still another embodiment. Further, the value is −10 in other embodiment, and −8 in still another embodiment. On the other hand, the upper limit of the dielectric anisotropy (Δ∈) of a liquid crystal composition including the compound represented by General Formula (4) is 0 in one embodiment, and −1 in other embodiment. Further, the upper limit is −2 in another embodiment, and −3 in still another embodiment. Further, the upper limit is −4 in another embodiment, and −5 in still another embodiment.

The compound represented by General Formula (4) in the present invention is preferably at least one kind selected from the group of the compounds represented by General Formulas (VI-a), (VI-b), (VI-c) and (VI-e):

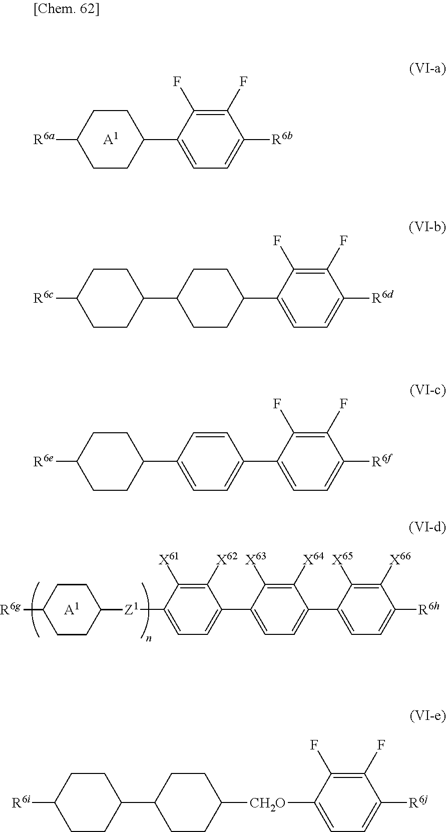

In General Formula (VI-a), R^{6a} and R^{6b} each independently represent an alkyl group having 1 to 8 carbon atoms, an alkenyl group having 2 to 8 carbon atoms, an alkoxy group having 1 to 8 carbon atoms or an alkenyloxy group having 2 to 8 carbon atoms, at least one hydrogen atom in the alkyl group, alkenyl group, alkoxy group and/or alkenyloxy group may be substituted with a fluorine atom, and a methylene group in the alkyl group, alkenyl group, alkoxy group and/or alkenyloxy group may be substituted with an oxygen atom so long as the oxygen atom does not continuously bond, and may be substituted with a carbonyl group so long as the carbonyl group does not continuously bond.

A¹ represents a 1,4-phenylene group or a tetrahydropyran-2,5-diyl group, and when A¹ represents a 1,4-phenylene group, at least one hydrogen atom in the 1,4-phenylene group may be substituted with a fluorine atom.

In General Formula (VI-b), R^{6c} and R^{6d} each independently represent an alkyl group having 1 to 8 carbon atoms, an alkenyl group having 2 to 8 carbon atoms, an alkoxy group having 1 to 8 carbon atoms or an alkenyloxy group having 2 to 8 carbon atoms, at least one hydrogen atom in the alkyl group, alkenyl group, alkoxy group and/or alkenyloxy group may be substituted with a fluorine atom, and a methylene group in the alkyl group, alkenyl group, alkoxy group and/or alkenyloxy group may be substituted with an oxygen atom so long as the oxygen atom does not continuously bond, or may be substituted with a carbonyl group so long as the carbonyl group does not continuously bond.

In General Formula (VI-c), R^{6e} and R^{6f} each independently represent an alkyl group having 1 to 15 carbon atoms, an alkenyl group having 2 to 15 carbon atoms or an alkoxy group having 1 to 15 carbon atoms.

In General Formula (VI-d), R^{6g} and R^{6h} each independently represent an alkyl group having 1 to 8 carbon atoms, an alkenyl group having 2 to 8 carbon atoms, an alkoxy group having 1 to 8 carbon atoms or an alkenyloxy group having 2 to 8 carbon atoms, at least one hydrogen atom in the alkyl group, alkenyl group, alkoxy group and/or alkenyloxy group may be substituted with a fluorine atom, and a methylene group in the alkyl group, alkenyl group, alkoxy group and/or alkenyloxy group may be substituted with an oxygen atom so long as the oxygen atom does not continuously bond, or may be substituted with a carbonyl group so long as the carbonyl group does not continuously bond.

A² represents a 1,4-cyclohexylene group, a 1,4-phenylene group or a tetrahydropyran-2,5-diyl group, and when A represents a 1,4-phenylene group, at least one hydrogen atom in the 1,4-phenylene group may be substituted with a fluorine atom,

Z¹ represents a single bond, —OCH₂—, —OCF₂—, —CH₂O— or CF₂O—,

n is 0 or 1, and

X⁶¹ to X⁶⁶ each independently represents a hydrogen atom or a fluorine atom, and at least two of X⁶¹ to X⁶⁶ represent a fluorine atom.

In General Formula (VI-e), R⁶ⁱ and R^{6j} each independently represent an alkyl group having 1 to 15 carbon atoms, an alkenyl group having 2 to 15 carbon atoms or an alkoxy group having 1 to 15 carbon atoms.

The compounds represented by General Formulas (VI-a) to (VI-e) are described in detail hereinunder.

The compound represented by General Formula (4) in the present invention is preferably a compound represented by General Formula (VI-a).

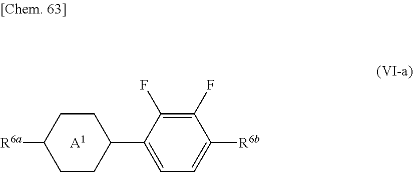

In General Formula (VI-a), R^{6a} and R^{6b} each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, and one or more hydrogen atoms in the alkyl group, the alkenyl group, the alkoxy group and/or the alkenyloxy group may be substituted with a fluorine atom, and the methylene group in the alkyl group, the alkenyl group, the alkoxy group and/or the alkenyloxy group may be substituted with an oxygen atom so far as oxygen atoms do not bond continuously, and may be substituted with a carbonyl group so far as carbonyl groups do not bond continuously, and

A¹ represents a 1,4-cyclohexylene group, a 1,4-phenylene group or a tetrahydropyrane-2,5-diyl group, and when A¹ represents a 1,4-phenylene group, one or more hydrogen atoms in the 1,4-phenylene group may be substituted with a fluorine atom.

In General Formula (VI-a), R^{6a} is preferably an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, more preferably an alkyl group having 1 to 8 carbon atoms or an alkenyl group having 2 to 8 carbon atoms, even more preferably an alkyl group having 1 to 8 carbon atoms, and further more preferably an alkyl group having 3 to 5 carbon atoms.

In General Formula (VI-a), R^{6b} is preferably an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, more preferably an alkyl group having 1 to 8 carbon atoms or an alkenyl group having 2 to 8 carbon atoms, even more preferably an alkyl group having 3 to 5 carbon atoms or an alkoxy group having 2 to 4 carbon atoms, and further more preferably an alkyl group having 3 or 5 carbon atoms or an alkoxy group having 2 or 4 carbon atoms.

In General Formula (VI-a), A¹ represents a 1,4-cyclohexylene group, a 1,4-phenylene group or a tetrahydropyrane-2,5-diyl group, and when A¹ is a 1,4-phenylene group, one or more hydrogen atoms in the 1,4-phenylene group may be substituted with a fluorine atom, but A¹ is preferably a 1,4-cyclohexylene group or a 1,4-phenylene group. More specifically, in the liquid crystal element and the liquid crystal display produced using the liquid crystal composition of the present invention, when the response speed is considered to be important, A¹ is preferably a 1,4-phenylene group, but when the operation temperature range is considered to be important, that is, the element and the display require a high operation temperature range (high Tni), A¹ is preferably a 1,4-cyclohexylene group. In the case where A¹ is a 1,4-phenylene group, one or more hydrogen atoms in the benzene ring may be substituted with a fluorine atom, but preferably the group is unsubstituted or mono-substituted or di-substituted. More preferably, the group is unsubstituted. As the di-substituted group, a 2,3-difluoro-1,4-phenylene group is preferred.

Specifically, the compound represented by General Formula (VI-a) is preferably a compound selected from the group of the following General Formula (VI-a-1).

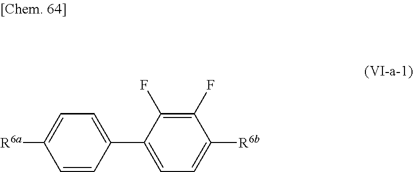

In General Formula (VI-a-1), R^{6a} and R^{6b} each independently represent an alkyl group having 1 to 5 carbon atoms, an alkenyl group having 2 to 5 carbon atoms, an alkoxy group having 1 to 8 carbon atoms, or an alkenyloxy group having 2 to 8 carbon atoms, and one or more hydrogen atoms in the alkyl group, the alkenyl group, the alkoxy group and/or the alkenyloxy group may be substituted with a fluorine atom, and the methylene group in the alkyl group, the alkenyl group, the alkoxy group and/or the alkenyloxy group may be substituted with an oxygen atom so far as oxygen atoms do not bond continuously, and may be substituted with a carbonyl group so far as carbonyl groups do not bond continuously.

More preferably, R^{6a} and R^{6b} each independently represent an alkyl group having 1 to 5 carbon atoms, an alkenyl group having 2 to 5 carbon atoms, an alkoxy group having 1 to 5 carbon atoms, or an alkenyloxy group having 2 to 5 carbon atoms, and in the case where R^{6a} and R^{6b} each are an alkenyl group, the carbon number thereof is preferably 4 to 5.

The lower limit of the preferred content of the compound represented by General Formula (VI-a) is 3%, 5%, 7%, 10%, 13%, 15%, 17% and 20%, based on the total amount of the composition of the present invention. The upper limit of the preferred content is 35%, 30%, 28%, 25%, 23%, 20%, 18%, 15%, 13%, 11%, 10% and 8%, based on the total amount of the composition of the present invention.

Specifically the compound represented by General Formula (VI-a) in the present invention is preferably compounds represented by the following formulae (6.13) to (6.21):

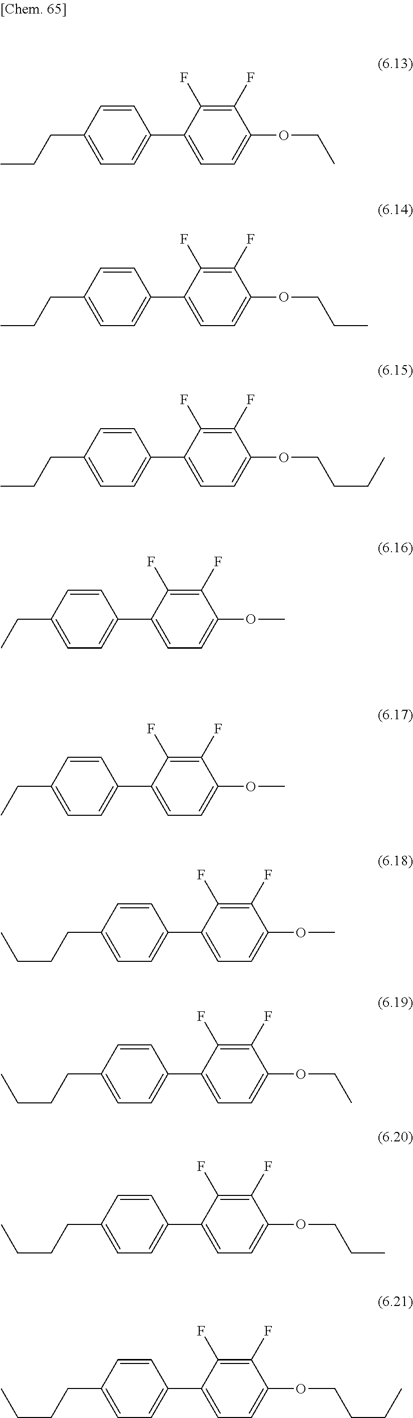

but the compounds represented by the formulae (6.13) to (6.20) are more preferred, and the compounds represented by the formulae (6.13) to 6.15) and the formulae (6.19) to (6.21) are even more preferred.

In the case where the compound represented by General Formula (VI-a) in the present invention has an alkenyl group, specifically, a compound selected from the group of the following formulae (6.22) to (6.27) is preferred:

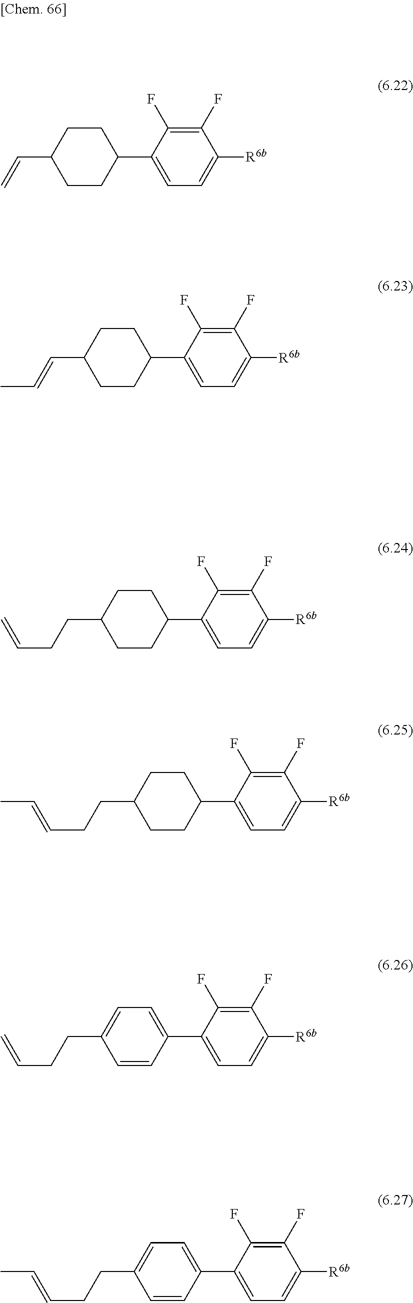

In the above formulae, R^{6b} each independently represent an alkyl group having 1 to 5 carbon atoms, an alkenyl group having 4 to 5 carbon atoms, or an alkoxy group having 1 to 4 carbon atoms.

The compound represented by the formula (4) in the present invention is preferably a compound selected from the group of General Formula (VI-b).

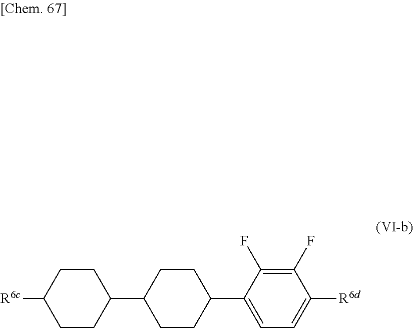

In General Formula (VI-b), R^{6c} and R^{6d} each independently represent an alkyl group having 1 to 8 carbon atoms, an alkenyl group having 2 to 8 carbon atoms, an alkoxy group having 1 to 8 carbon atoms or an alkenyloxy group having 2 to 8 carbon atoms, one or more hydrogen atoms in the alkyl group, the alkenyl group, the alkoxy group and/or the alkenyloxy group may be substituted with a fluorine atom, and a methylene group in the alkyl group, the alkenyl group, the alkoxy group and/or the alkenyloxy group may be substituted with an oxygen atom so long as the oxygen atom does not bond continuously, or may be substituted with a carbonyl group so long as the carbonyl group does not bond continuously.

In General Formula (VI-b), R^{6c} represents preferably an alkyl group having 1 to 8 carbon atoms, an alkenyl group having 2 to 8 carbon atoms, an alkoxy group having 1 to 8 carbon atoms or an alkenyloxy group having 2 to 8 carbon atoms, more preferably an alkyl group having 1 to 8 carbon atoms or an alkenyl group having 2 to 8 carbon atoms, even more preferably an alkyl group having 1 to 8 carbon atoms, and further more preferably an alkyl group having 3 to 5 carbon atoms.

In General Formula (VI-b), R^{6d} represents preferably an alkyl group having 1 to 8 carbon atoms, an alkenyl group having 2 to 8 carbon atoms, an alkoxy group having 1 to 8 carbon atoms or an alkenyloxy group having 2 to 8 carbon atoms, more preferably an alkyl group having 1 to 8 carbon atoms or an alkoxy group having 1 to 8 carbon atoms, even more preferably an alkyl group having 3 to 5 carbon atoms or an alkoxy group having 2 to 4 carbon atoms, and further more preferably an alkyl group having 3 or 5 carbon atoms or an alkoxy group having 2 or 4 carbon atoms.

The lower limit of the preferred content of the compound represented by General Formula (VI-b) is 5%, 7%, 10%, 13%, 15%, 17%, 20%, 23%, 25%, 27%, 30%, 33%, 35%, 37%, 40% and 42%, based on the total amount of the composition of the present invention. The upper limit of the preferred content is 50%, 48%, 45%, 43%, 40%, 38%, 35%, 33%, 30%, 28%, 25%, 23%, 20%, 18%, 15%, 13%, 10%, 8%, 7%, 6% and 5%, based on the total amount of the composition of the present invention.

Specifically the compound represented by General Formula (VI-b) is preferably compounds represented by the following formulae (6.28) to (6.35):

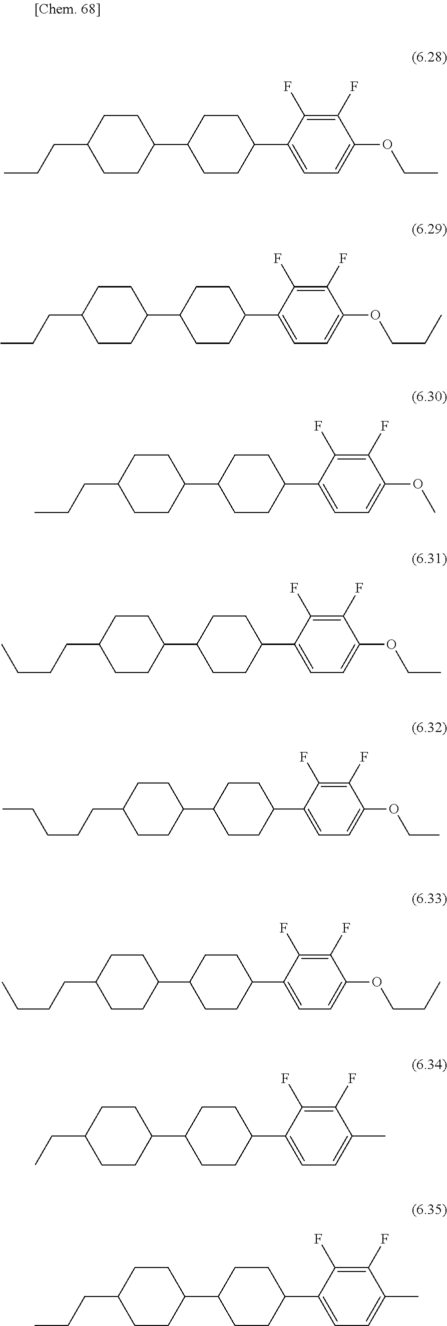

but the compounds represented by the formulae (6.28) to (6.29) and the formulae (6.31) to (6.35) are more preferred.

In the case where the compound represented by General Formula (VI-b) in the present invention has an alkenyl group, specifically, compounds represented by the following formulae (6.36) to (6.39) are preferred:

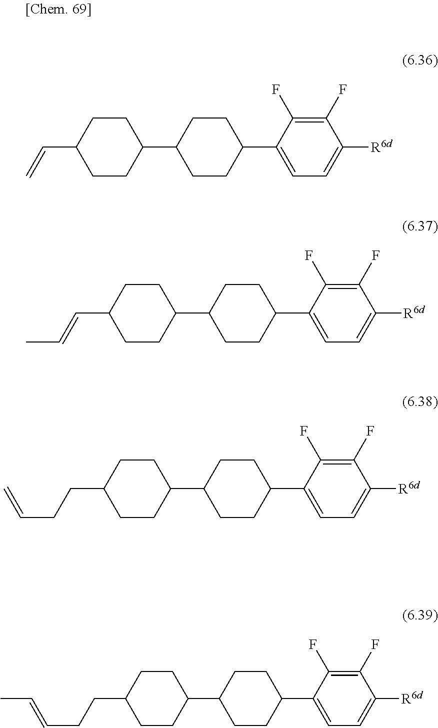

In the above formulae, R^{6d} represents an alkyl group having 1 to 5 carbon atoms, an alkenyl group having 4 to 5 carbon atoms or an alkoxy group having 1 to 4 carbon atoms.

The compound represented by the formula (4) in the present invention is preferably a compound represented by General Formula (VI-c).

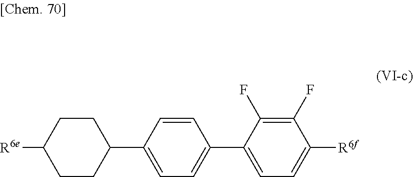

In General Formula (VI-c), R^{6e} and R^{6f} each independently represent an alkyl group having 1 to 15 carbon atoms, an alkenyl group having 2 to 15 carbon atoms or an alkoxy group having 1 to 15 carbon atoms.

In the compound represented by General Formula (VI-c), more preferably, R^{6e} is an alkyl group having 1 to 10 carbon atoms and R^{6f} is an alkoxy group having 1 to 10 carbon atoms, and particularly preferably, R^{6e} is an alkyl group having 1 to 5 carbon atoms and R^{6f} is an alkoxy group having 1 to 5 carbon atoms.

The lower limit of the preferred content of the compound represented by General Formula (VI-c) is 5%, 10%, 13%, 15%, 17% and 20%, based on the total amount of the composition of the present invention. The upper limit of the preferred content is 35%, 30%, 28%, 25%, 23%, 20%, 18%, 15% and 13%, based on the total amount of the composition of the present invention.

Further, as the compound represented by General Formula (VI-c) in the present invention, a compound selected from the group of the following formulae (6.40) to (6.45):

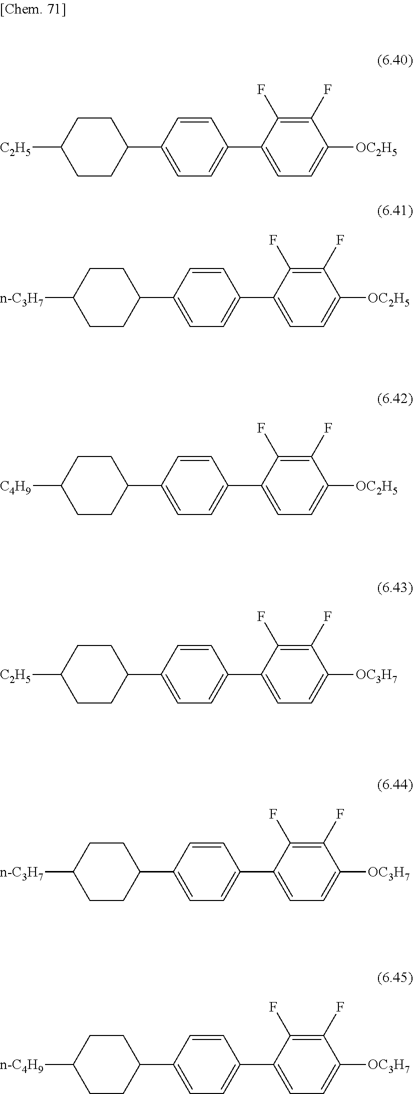

is preferable.

The compound represented by General Formula (4) in the present invention is preferably a compound represented by General Formula (VI-d).

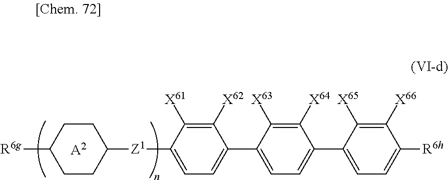

(In General Formula (VI-d), R^{6g} and R^{6h} each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, and one or more hydrogen atoms in the alkyl group, the alkenyl group, the alkoxy group and/or the alkenyloxy group may be substituted with a fluorine atom, and the methylene group in the alkyl group, the alkenyl group, the alkoxy group and/or the alkenyloxy group may be substituted with an oxygen atom so far as oxygen atoms do not bond continuously, and may be substituted with a carbonyl group so far as carbonyl groups do not bond continuously,

A² represents a 1,4-cyclohexylene group, a 1,4-phenylene group or a tetrahydropyrane-2,5-diyl group, and when A² is a 1,4-phenylene group, one or more hydrogen atoms in the 1,4-phenylene group may be substituted with a fluorine atom,

Z¹ represents a single bond, —OCH₂—, —OCF₂—, —CH₂O—, or CF₂O—,

n indicates 0 or 1, and

X⁶¹ to X⁶⁶ each independently represent a hydrogen atom or a fluorine atom, provided that at least two of X⁶¹ to X⁶⁶ are fluorine atoms.)

The 1,4-cyclohexyl group in the present application is preferably a trans-1,4-cyclohexyl group.

In the case where the liquid crystal composition of the present invention contains a compound represented by General Formula (2) as the second component and where the compound represented by General Formula (VI-d) is the same as the compound represented by General Formula (2), preferably, the compound represented by General Formula (VI-d) is not contained in the fourth component.

In General Formula (VI-d), R^{6g} preferably represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, more preferably an alkyl group having 1 to 8 carbon atoms or an alkenyl group having 2 to 8 carbon atoms, even more preferably an alkyl group having 1 to 8 carbon atoms, and further more preferably an alkyl group having 3 to 5 carbon atoms.

In General Formula (VI-d), R^{6h} preferably represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, more preferably an alkyl group having 1 to 8 carbon atoms or an alkoxy group having 1 to 8 carbon atoms, even more preferably an alkyl group having 3 to 5 carbon atoms or an alkoxy group having 2 to 4 carbon atoms, further more preferably an alkyl group having 3 or 5 carbon atoms. Also preferably, R^{e} and R^{f} differ from each other in point of the number of carbon atoms.

In General Formula (VI-d), preferably, X⁶¹ to X⁶⁶ each are independently a hydrogen atom or a fluorine atom, and preferably, two to five of them are fluorine atoms, more preferably two to four are fluorine atoms, even more preferably, two to three are fluorine atoms, further more preferably two are fluorine atoms, and most preferably two are fluorine atoms.

In this case, when the formula has one fluorine atom, preferably any two of X⁶³ to X⁶⁶ are fluorine atoms, more preferably X⁶³ or X⁶⁴ is a fluorine atom. When the formula has two fluorine atoms, preferably any two of X⁶³ to X⁶⁶ are fluorine atoms, more preferably X⁶³ and X⁶⁴ are fluorine atoms or X⁶⁵ and X⁶⁶ are fluorine atoms, and even more preferably X⁶³ and X⁶⁴ are fluorine atoms. When the formula has three or more fluorine atoms, preferably at least X⁶³ and X⁶⁴ are fluorine atoms or at least X⁶⁵ and X⁶⁶ are fluorine atoms, and even more preferably at least X⁶³ and X⁶⁴ are fluorine atoms.

In General Formula (VI-d), A² is preferably a 1,4-cyclohexylene group, a 1,4-phenylene group or a tetrahydropyrane-2,5-diyl group, and in the case where response speed is considered to be important for display elements and liquid crystal displays produced using the liquid crystal composition, the group is preferably a 1,4-phenylene group or a tetrahydropyrane-2,5-diyl group, and more preferably a 1,4-phenylene group. In the case where a driving voltage is considered to be important, the group is preferably a 1,4-phenylene group or a tetrahydropyrane-2,5-diyl group, and more preferably a tetrahydropyrane-2, 5-diyl group. In the case where an operation temperature range is considered to be important, that is, where a high operation temperature range is needed, the group is preferably a 1,4-cyclohexylene group or a tetrahydropyrane-2,5-diyl group, and more preferably a 1,4-cycloyexylene group. When the group is a 1,4-phenylene group, one or more hydrogen atoms in the benzene ring may be substituted with a fluorine atom, and the group is preferably unsubstituted, monosubstituted or disubstituted, and when it is disubstituted, the group is preferably 2,3-difluorobenzene.

In General Formula (VI-d), Z¹ represents a single bond, —OCH₂—, —OCF₂—, —CH₂O—, or —CF₂O—, and is preferably a single bond, —OCF₂— or —CF₂O—, more preferably a single bond.

In General Formula (VI-c), n indicates 0 or 1, and in the case where rapid response is considered to be important, n is preferably 0, but where an operation temperature range is considered to be important, that is, where a high operation temperature range is needed, n is preferably 1.

In General Formulas (VI-a) to (VI-d), R^{6a} to R^{6h} correspond to R^{X1} and R^{X2} in General Formula (4), and therefore it is needless to say that the alkyl group, the alkenyl group, the alkoxy group and the alkenyloxy group each are preferably linear or branched and more preferably linear.

The lower limit of the preferred content of the compound represented by General Formula (VI-d) is 5%, 8%, 10%, 13%, 15%, 17% and 20%, based on the total amount of the composition of the present invention. The upper limit of the preferred content is 35%, 33%, 30%, 28%, 25%, 23%, 20%, 18%, 15% and 13%, based on the total amount of the composition of the present invention.

Specifically, the compound represented by General Formula (VI-d) in the present invention is preferably any of compounds represented by the following General Formulas (VI-d-1) to (VI-d-12):

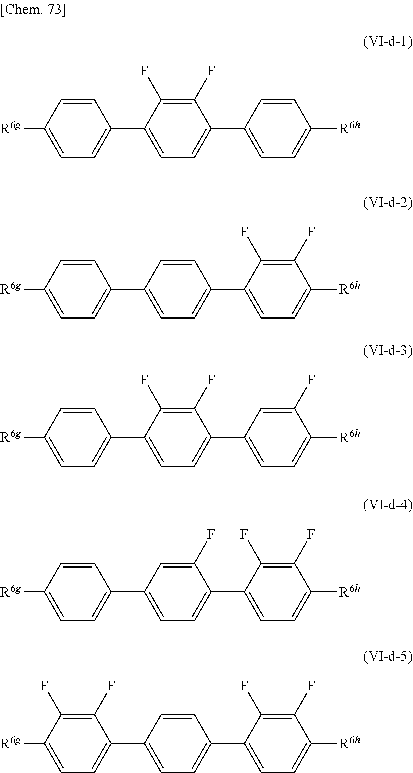

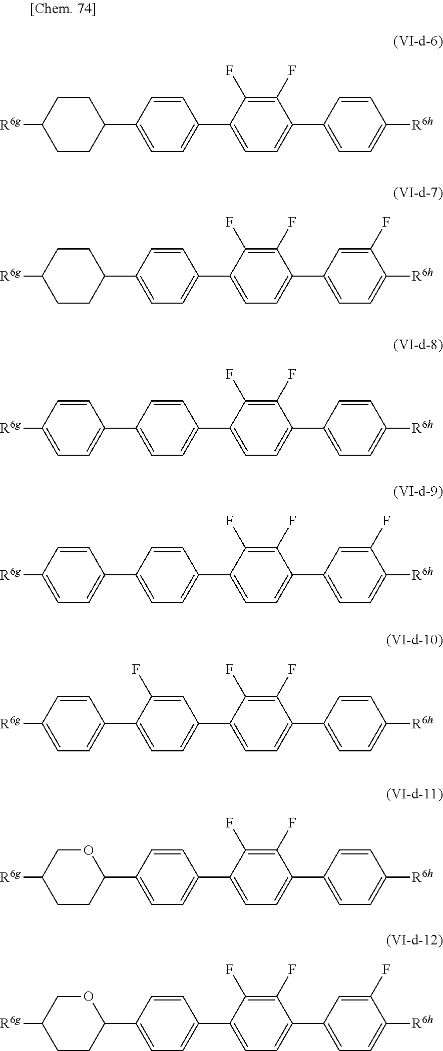

In the above formulae, R^{6g} has the same meaning as that of R^{6g} in General Formula (VI-d), and R^{6h} has the same meaning as that of R^{6h} in General Formula (VI-d).

The General Formula (VI-d-1), General Formulas (VI-d-3) to (VI-d-9) and General Formulas (VI-d-12) to (VI-d-15) are more preferred, General Formula (VI-d-1), General Formula (VI-d-3), General Formula (VI-d-5), General Formula (VI-d-6), General Formula (VI-d-9), General Formula (VI-d-12), General Formula (VI-d-13) and General Formula (VI-d-15) are even more preferred, General Formula (VI-d-1), General Formula (VI-d-5) and General Formula (VI-d-6) are especially preferred, and General Formula (VI-d-5) is most preferred.

In General Formula (VI-d) (including General Formulas (VI-d-1) to (VI-d-12)) in the present invention, R^{6g} and R^{6h} each independently represent an alkyl group having 1 to 8 carbon atoms, an alkenyl group having 2 to 8 carbon atoms, an alkoxy group having 1 to 8 carbon atoms or an alkenyloxy group having 2 to 8 carbon atoms, preferably an alkyl group having 1 to 8 carbon atoms or an alkenyloxy group having 2 to 8 carbon atoms, more preferably an alkyl group having 2 to 5 carbon atoms or an alkenyloxy group having 2 to 5 carbon atoms, most preferably an alkyl group having 2 to 5 carbon atoms, and these groups are preferably linear. In the case where R^{6g} and R^{6h} are both alkyl groups, preferably, they differ from each other in point of the number of carbon atoms.

More precisely, the compound where R^{6g} is a propyl group and R^{6h} is an ethyl group, or the compound where R^{6g} is a butyl group and R^{6h} is an ethyl group is preferred.

Specifically, the compound represented by General Formula (VI-d-1) in the present invention is preferably any of compounds of the formulae (6.46) to (6.57).

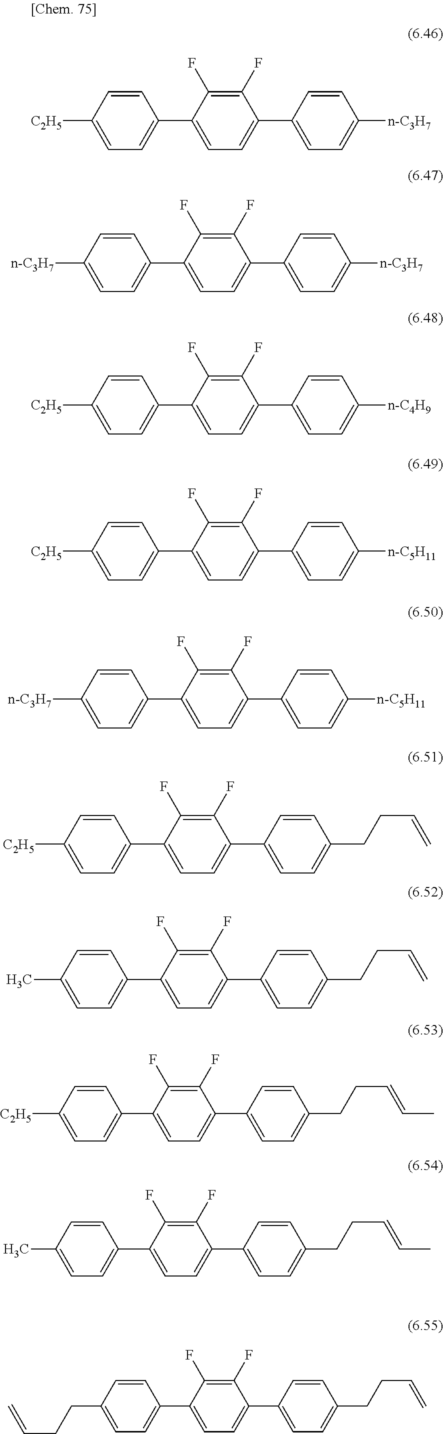

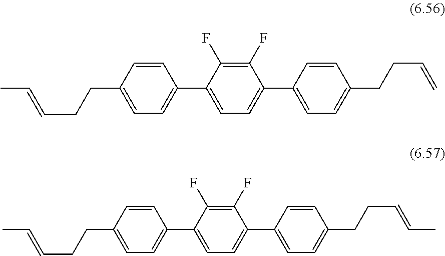

Of the compound represented by General Formula (4) in the present invention, a compound selected from the group of the compounds represented by the formulae (VI-d-1) and (VI-d-2) and the compounds represented by the formulae (6.46), (6.47), (6.48), (6.49) and (6.50) are more preferred.

The particularly preferred embodiment of the fourth component in the present invention is that 1 to 3 kinds of different compounds in compounds selected from the group of the compounds represented by the formulae (VI-d-1) and (VI-d-2) and the compounds represented by the formulae (6.46), (6.47), (6.48), (6.49) and (6.50) are mixed. Further, in such a case, a mass ratio of the whole fourth component in the present invention is particularly preferably 20 to 32 mass % based on the whole liquid crystal composition.

The compound represented by General Formula (4) in the present invention is preferably the compound represented by General Formula (VI-e).

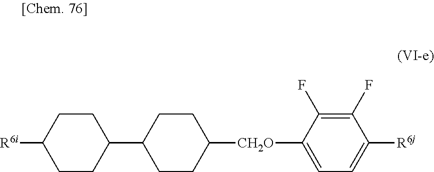

In General Formula (VI-e), R⁶ⁱ and R^{6j} each independently represent an alkyl group having 1 to 15 carbon atoms, an alkenyl group having 2 to 15 carbon atoms or an alkoxy group having 1 to 15 carbon atoms.

In General Formula (VI-e) in the present invention, R⁶ⁱ represents preferably an alkyl group having 1 to 8 carbon atoms, an alkenyl group having 2 to 8 carbon atoms, an alkoxy group having 1 to 8 carbon atoms or an alkenyloxy group having 2 to 8 carbon atoms, more preferably an alkyl group having 1 to 8 carbon atoms or an alkenyl group having 2 to 8 carbon atoms, even more preferably an alkyl group having 1 to 8 carbon atoms, and further more preferably an alkyl group having 3 to 5 carbon atoms.

In General Formula (VI-e), R^{6j} represents preferably an alkyl group having 1 to 8 carbon atoms, an alkenyl group having 2 to 8 carbon atoms, an alkoxy group having 1 to 8 carbon atoms or an alkenyloxy group having 2 to 8 carbon atoms, more preferably an alkyl group having 1 to 8 carbon atoms or an alkoxy group having 1 to 8 carbon atoms, even more preferably an alkyl group having 3 to 5 carbon atoms or an alkoxy group having 2 to 4 carbon atoms, and further more preferably an alkyl group having 3 or 5 carbon atoms.

When the liquid crystal composition contains the compound represented by General Formula (VI-e), an absolute value of dielectric anisotropy is increased, and as a result, the effect of enabling low voltage driving is exhibited. Further, when the compound represented by General Formula (VI-e) is combined with the compound (Z⁰═—CH₂O—) of General Formula (2), an absolute value of dielectric anisotropy is further increased, and as a result, the effect of enabling low voltage driving is exhibited.

The lower limit of the preferred content of the compound represented by General Formula (VI-e) is 5%, 10%, 13%, 15%, 17% and 20%, based on the total amount of the composition of the present invention. The upper limit of the preferred content is 35%, 30%, 28%, 25%, 23%, 20%, 18%, 15% and 13%, based on the total amount of the composition of the present invention.

Specifically, the compound represented by General Formula (VI-e) in the present invention is preferably the compounds represented by the formulae (9.1) to (9.8).

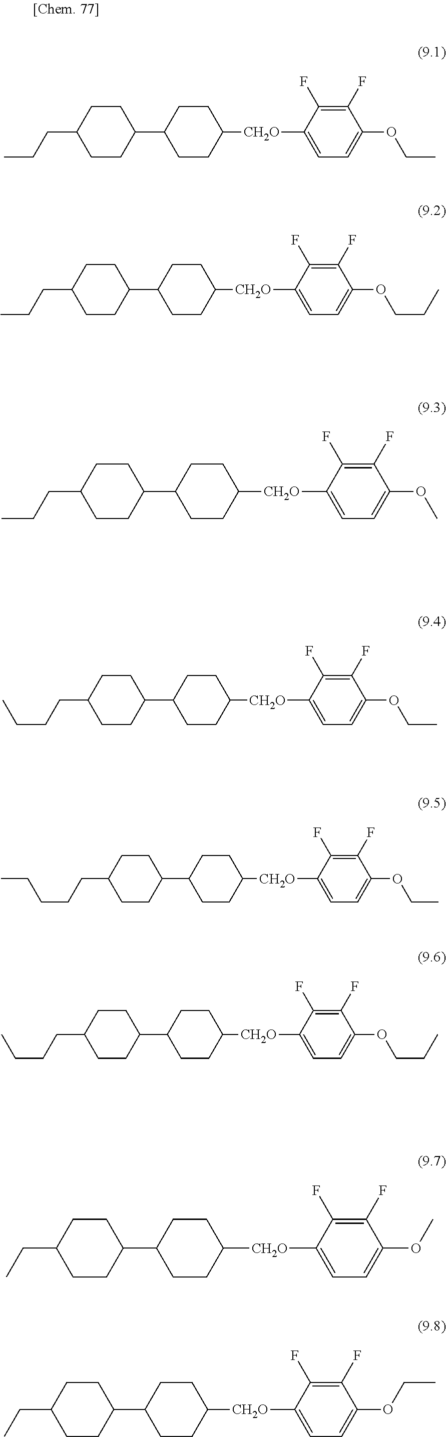

The total content of the compounds represented by General Formulas (1), (2) and (VI-e) contained in the liquid crystal composition is that, as the lower limit, 10 mass % is preferable, 12 mass % is preferable, 15 mass % is preferable, 18 mass % is preferable, 20 mass % is preferable, 22 mass % is preferable, 26 mass % is preferable, 28 mass % is preferable, and 30 mass % is preferable. As the upper limit, 60 mass % is preferable, 55 mass % is preferable, 50 mass % is preferable, 45 mass % is preferable, 40 mass % is preferable, 36 mass % is preferable, 33 mass % is preferable, 32 mass % is preferable, and 30 mass % is preferable.

The liquid crystal composition of the present invention may further contain, as a fifth component, at least one kind of the compounds represented by the following General Formulas (6a) and (6b).

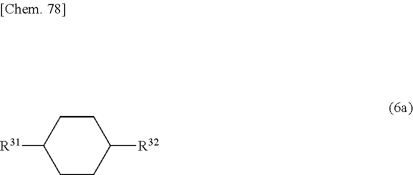

In General Formula (6a), R³¹ and R³² each independently represent a straight chain alkyl group having 1 to 10 carbon atoms, a straight chain alkoxy group having 1 to 10 carbon atoms or a straight chain alkenyl group having 2 to 10 carbon atoms.

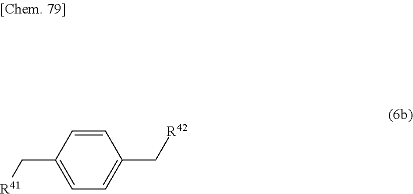

In General Formula (6b), R⁴¹ and R⁴² each independently represent a straight chain alkyl group having 1 to 10 carbon atoms, a straight chain alkoxy group having 1 to 10 carbon atoms or a straight chain alkenyl group having 4 to 10 carbon atoms.

Addition of the compounds represented by General Formulas (6a) and (6b) to the liquid crystal composition is particularly preferred from the standpoint that a liquid crystal composition having low viscosity is particularly obtained.

The content of the fifth component in the liquid crystal composition of the present invention is appropriately selected by not only use embodiment and use purpose of a liquid crystal composition, but the relationship with other components, similar to the above-described first component and second component that are essential components. Therefore, the preferred range of the content of the fourth component contained in the liquid crystal composition is preferably individually independent depending on the respective embodiments.

In the liquid crystal composition of the present invention, the lower limit of the content of the fifth component is, for example, as one embodiment of the present invention, preferably 1 mass % based on the total amount (100 mass %) of the liquid crystal composition of the present invention. Alternatively, in another embodiment of the present invention, the lower limit is preferably 10 mass %. Further, in another embodiment of the present invention, the lower limit is preferably 20 mass %. Further, in another embodiment of the present invention, the lower limit is preferably 30 mass %. Further, in another embodiment of the present invention, the lower limit is preferably 40 mass %. Further, in another embodiment of the present invention, the lower limit is preferably 50 mass %. Further, in another embodiment of the present invention, the lower limit is preferably 55 mass %. Further, in another embodiment of the present invention, the lower limit is preferably 60 mass %. Further, in another embodiment of the present invention, the lower limit is preferably 65 mass %. Further, in another embodiment of the present invention, the lower limit is preferably 70 mass %. Further, in another embodiment of the present invention, the lower limit is preferably 75 mass %. Further, in another embodiment of the present invention, the lower limit is preferably 80 mass %.

In the liquid crystal composition of the present invention, the upper limit of the content of the fifth component is, for example, in one embodiment of the present invention, preferably 95 mass % based on the total amount (100 mass %) of the liquid crystal composition of the present invention. Further, in another embodiment of the present invention, the upper limit is preferably 85 mass %. Further, in another embodiment of the present invention, the upper limit is preferably 75 mass %. Further, in another embodiment of the present invention, the upper limit is preferably 65 mass %. Further, in another embodiment of the present invention, the upper limit is preferably 55 mass %. Further, in another embodiment of the present invention, the upper limit is preferably 45 mass %. Further, in another embodiment of the present invention, the upper limit is preferably 35 mass %. Further, in another embodiment of the present invention, the upper limit is preferably 25 mass %.

In the liquid crystal composition of the present invention, the content of the compound represented by General Formula (6a) or (6b) must be appropriately adjusted depending on required performances such as solubility at low temperature, a transition temperature, electrical reliability, a birefringence, process adaptability and drop marks described hereinunder, burn-in and dielectric anisotropy.

In the case where a liquid crystal composition maintaining a viscosity of the liquid crystal composition of the present invention low and having high response speed is required, it is preferred that the lower limit is high and the upper limit is high. Further, in the case where a liquid crystal composition maintaining Tni of the liquid crystal composition of the present invention high and having good temperature stability is required, it is preferred that the lower limit is high and the upper limit is high. Further, when dielectric anisotropy is required to be increased in order to maintain driving voltage low, it is preferred that the lower limit is low and the upper limit is low.

In the fifth component of the present invention, kinds that can combine the compounds represented by General Formula (6a) or (6b) with each other are not particularly limited, and are used by appropriately combining those depending on desired performances such as solubility at low temperature, a transition temperature, electrical reliability and a birefringence. For example, as one embodiment of the present invention, the kind of the compound of General Formula (6a) or (6b) used as the fifth component is that the fifth component is one kind of the compound represented by General Formula (6a) or (6b). Alternatively, in other embodiment of the present invention, the fifth component is two kinds of the compounds represented by General Formula (6a) or (6b). Further, in other embodiment of the present invention, the fifth component is three kinds of the compounds represented by General Formula (6a) or (6b). In other embodiment of the present invention, the fifth component is four kinds of the compounds represented by General Formula (6a) or (6b). In other embodiment of the present invention, the fifth component is five kinds of the compounds represented by General Formula (6a) or (6b). In other embodiment of the present invention, the fifth component is six kinds of the compounds represented by General Formula (6a) or (6b). In other embodiment of the present invention, the fifth component is seven kinds of the compounds represented by General Formula (6a) or (6b). In other embodiment of the present invention, the fifth component is eight kinds of the compounds represented by General Formula (6a) or (6b). In other embodiment of the present invention, the fifth component is nine kinds of the compounds represented by General Formula (6a) or (6b). In other embodiment of the present invention, the fifth component is a system containing ten or more kinds of the compounds represented by General Formula (6a) or (6b).

The lower limit of the dielectric anisotropy (Δ∈) of the compound represented by General Formula (6a) or General Formula (6b) in the present invention is −1 in one embodiment, and −0.9 in another embodiment. In still another embodiment, the value is −0.8, and further in still another embodiment, it is −0.7. In still another embodiment, the value is −0.5, and further in still another embodiment, it is −0.4. On the other hand, the upper limit of the dielectric anisotropy (Δ∈) of the compound represented by General Formula (6a) or General Formula (6b) in the present invention is +1 in one embodiment, and +0.9 in another embodiment. In still another embodiment, the value is +0.8, further in still another embodiment, it is +0.7, further in still another embodiment, it is +0.6, and further in still another embodiment, it is +0.5.

Specifically, the compound represented by General Formula (6a) in the present invention is preferably any of compounds represented by the following formulae (7.1) to (7.60).

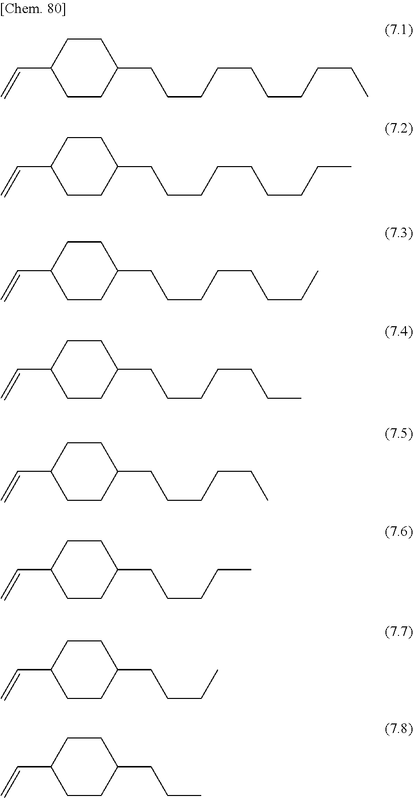

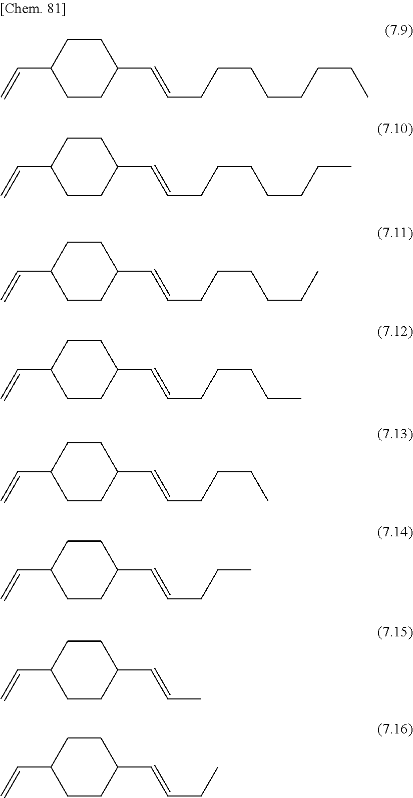

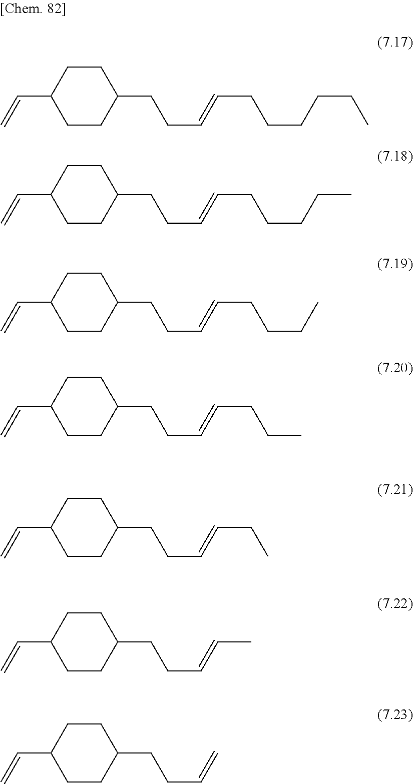

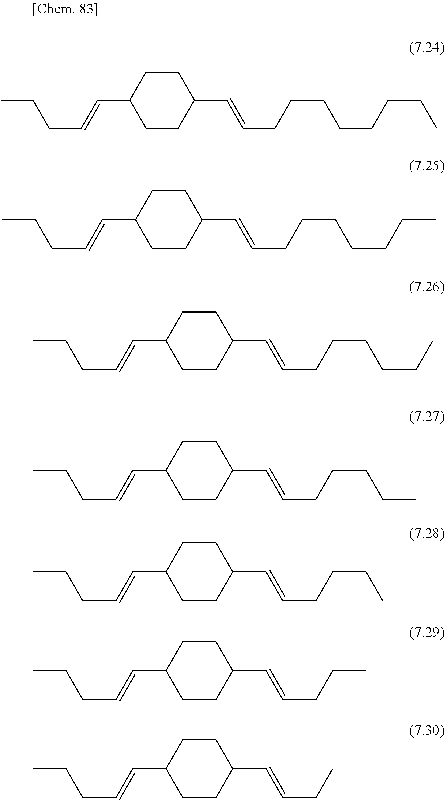

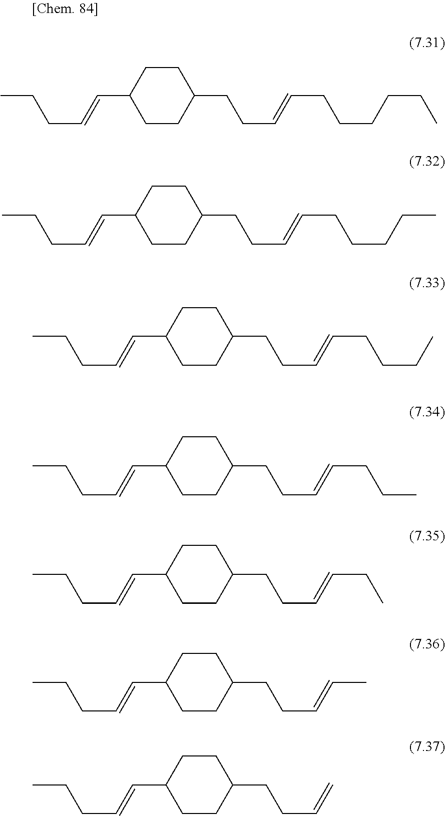

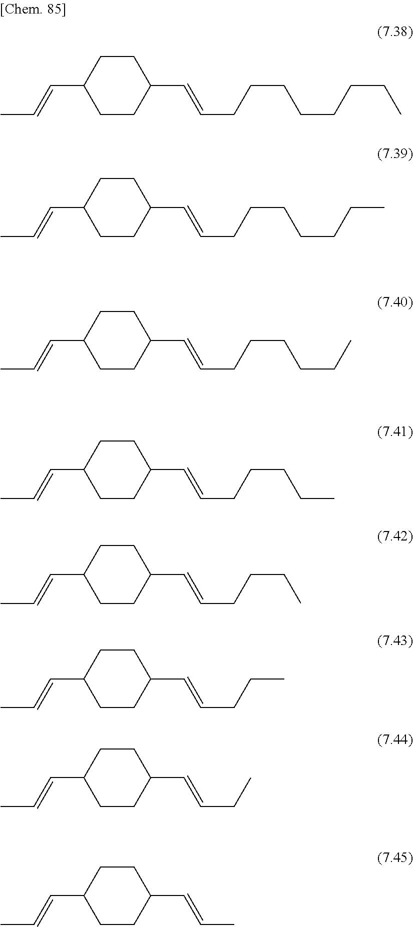

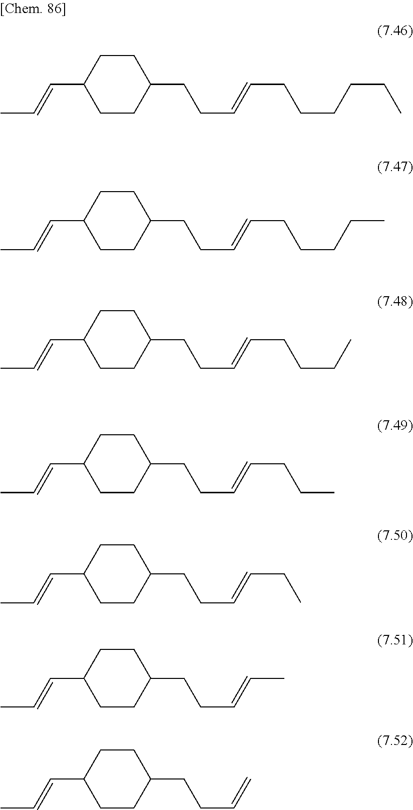

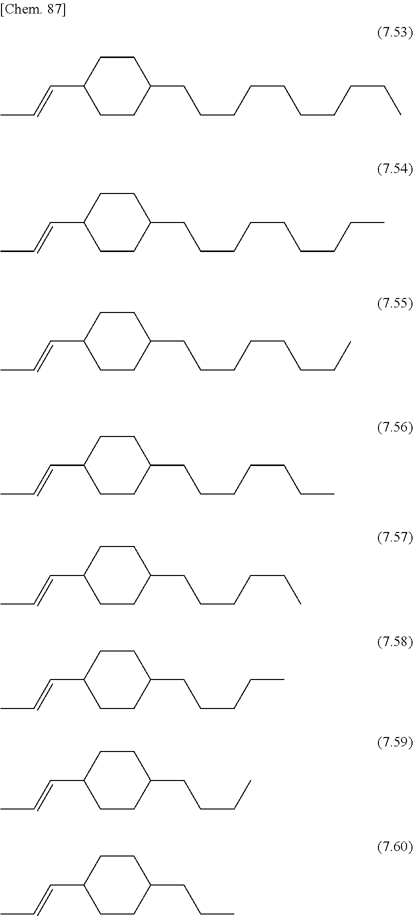

The compound represented by General Formula (6b) in the present invention is preferably at least one selected from the group of the formulae (7.71) to (7.85).

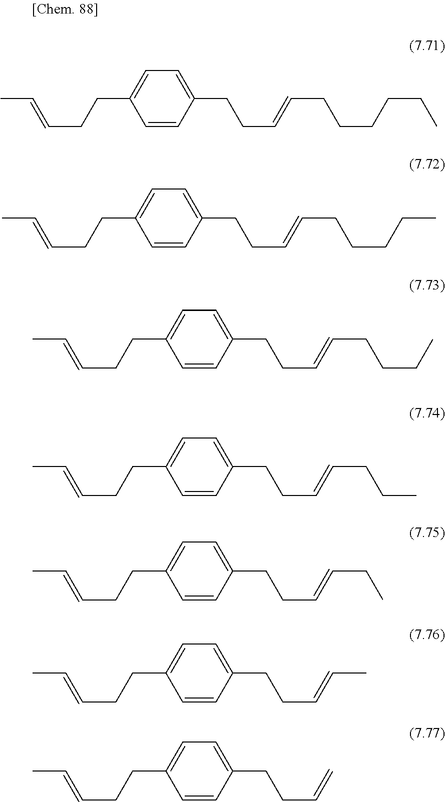

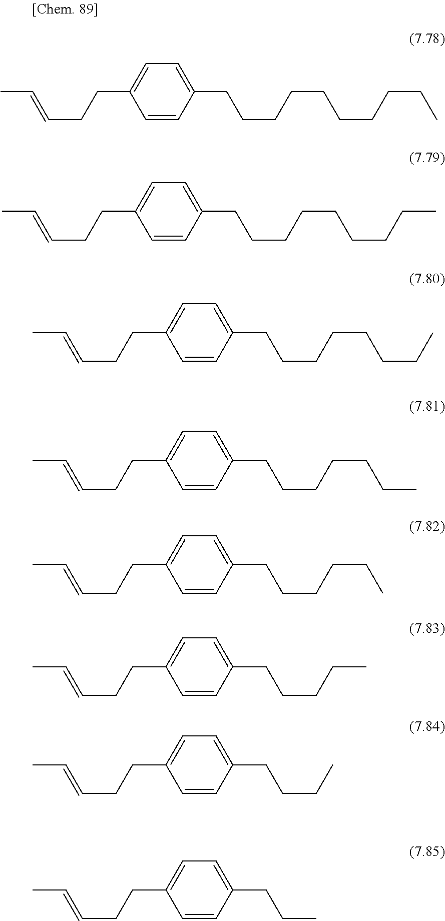

Among the compounds represented by General Formulas (6a) and (6b) in the present invention, the compounds of the formulae (7.71) to (7.85) are more preferred.

The total content of the compounds represented by General Formulas (1), (2), (3) and (4) contained in the liquid crystal composition of the present invention is that, as the lower limit, 60 mass % is preferable, 65 mass % is preferable, 70 mass % is preferable, 72 mass % is preferable, 75 mass % is preferable, 77 mass % is preferable, 80 mass % is preferable, 82 mass % is preferable, 85 mass % is preferable, 87 mass % is preferable, 90 mass % is preferable, 92 mass % is preferable, 95 mass % is preferable, 98 mass % is preferable, and 99 mass % is preferable. As the upper limit, 100 mass % is preferable, 99.5 mass % is preferable, 99 mass % is preferable, 98 mass % is preferable, 98 mass % is preferable, 97 mass % is preferable, and 95 mass % is preferable.

The liquid crystal composition of the present invention may contain other components such as general nematic liquid crystal, smectic liquid crystal, cholesteric liquid crystal, a chiral agent, an antioxidant, an ultraviolet absorber and a polymerizable monomer depending on the use purpose, other than the compounds represented by the above first to fifth components. Of those other components, an antioxidant and an ultraviolet absorber are not particularly limited, and the conventional compounds can be used.

In the case where stability and reliability by UV irradiation are considered to be important in the liquid crystal composition of the present invention, the content of a compound having a chlorine atom as a substituent is preferably 15 mass % or less, more preferably 10 mass % or less, even more preferably 5 mass % or less, and most preferably the embodiment that the compound is not substantially contained, based on the total mass of the composition.

In the liquid crystal composition of the present invention, it is preferred to increase the content of a compound in which a ring structure in the molecule is all a single 6-membered ring. The content of the compound in which a ring structure in the molecular is all a single 6-membered ring is preferably 80 mass % or more, more preferably 90 mass % or more, even more preferably 95 mass % or more, and most preferably the embodiment that a liquid crystal composition is constituted of only a compound in which a ring structure in the molecular is substantially all a single 6-membered ring, based on the total mass of the composition.

In the liquid crystal composition of the present invention, to suppress deterioration of the liquid crystal composition by oxidation, it is preferred to decrease the content of a compound having a cyclohexenylene group as a ring structure. The content of the compound having a cyclohexenylene group is preferably 10 mass % or less, more preferably 5 mass % or less, and even more preferably the embodiment that the compound is not substantially contained, based on the total mass of the composition.

In the liquid crystal composition of the present invention, in the case of considering the improvement of a viscosity and the improvement of Tni to be important, it is preferred to decrease the content of a compound having a 2-methylbenzene-1,4-diyl group in which a hydrogen atom may be substituted with a halogen, in the molecule. The content of the compound having a 2-methylbenzene-1,4-diyl group in the molecule is preferably 10 mass % or less, more preferably 5 mass % or less, and even more preferably the embodiment that the compound is not substantially contained, based on the total mass of the composition.

Due to expansion of the use of a liquid crystal display element in recent years, great change is appeared in its use method and production method, and to respond to those, optimization has been required in characteristics other than the basic physical properties conventionally known. Specifically, a liquid crystal display element using a liquid crystal composition is that VA type, IPS type and the like are widely used, and regarding its size, a display element having an extra-large screen of 50 inches or more has become to be used. Due to enlargement of a substrate size, an injection method of a liquid crystal composition into a substrate is that a drop injection (ODF: One drop fill) method becomes a mainstream in place of the conventional vacuum injection method (see JP-A 6-235925), and the problem that drop marks when a liquid crystal composition has dropped on a substrate cause the deterioration of display quality has become to be revealed. Further, for the purpose of high speed responsiveness of formation of a pretilt angle of a liquid crystal material in a liquid crystal display element, a PS liquid crystal display element (polymer stabilized) and a PSA liquid crystal display element (polymer sustained alignment) are developed (see JP-A 2002-357830), and the problem of drop marks is becoming large problem. Specifically, the PS or PSA display element is characterized by adding a monomer to a liquid crystal composition and hardening the monomer in the composition. In a liquid crystal composition for active matrix, a usable compound is specified from the necessity of sustaining high voltage holding ratio, and use of a compound having an ester bond therein is restricted. A monomer used in a PSA liquid crystal display element is mainly an acrylate type, and it is general to contain an ester bond in a compound. Such a compound is not generally used as a liquid crystal compound for active matrix (see JP-A 2002-357830). Such a foreign matter induces the generation of drop marks, and deterioration of a yield of a liquid crystal display element by poor display becomes a problem. Further, even in adding additives such as an antioxidant, a light absorber and the like to a liquid crystal composition, deterioration of a yield becomes a problem. Drop marks used herein are defined as the phenomenon that marks of a liquid crystal composition dropped in the case of black display rise up white.

For the suppression of such drop marks, a method of suppressing drop marks generated in relationship to an alignment controlling film by forming a polymer layer in a liquid crystal phase layer by polymerization of a polymerizable compound mixed in a liquid crystal composition is disclosed (JP-A 2006-58755). However, this method has a problem of burn-in of display due to a polymerizable compound added to a liquid crystal, and the effect of suppression of drop marks is not sufficient. Therefore, development of a liquid crystal display element that is difficult to generate burn-in and drop marks is required while maintaining basic characteristic as a liquid crystal display element. The liquid crystal composition of the present invention has the effect of suppressing or reducing the generation of drop marks.

The liquid crystal composition of the present invention preferably further contains a polymerizable monomer. Further, the polymerizable monomer in the present invention is preferably a bifunctional monomer represented by General Formula (8) from the above standpoint:

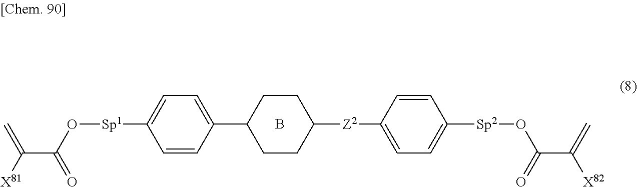

In General Formula (8), X⁸¹ and X⁸² each independently represent a hydrogen atom or a methyl group, Sp¹ and Sp² each independently represent a single bond, an alkylene group having 1 to 8 carbon atoms or —O—(CH₂)ₛ— (in the formula, s is an integer of 1 to 7, and an oxygen atom bonds to an aromatic ring),

Z² represents —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (in the formula, Y¹ and Y² each independently represent a fluorine atom or a hydrogen atom), —C≡C— or a single bond,

B represents a 1,4-phenylene group, a trans-1,4-cyclohexylene group or a single bond, and

a 1,4-phenylene group in the formula is all that an optional hydrogen atom may be substituted with a fluorine atom.

The bifunctional monomer represented by General Formula (8) is preferably a diacrylate derivative in which both X⁸¹ and X⁸² represent a hydrogen atom, a dimethacrylate derivative in which both X⁸¹ and X⁸² represent a methyl group, and a compound in which one of X⁸¹ and X⁸² represents a hydrogen atom and other represents a methyl group. Polymerization rate of those compounds is that the diacrylate derivative is most fast, the dimethacrylate is slow and an asymmetric compound is intermediate, and the preferred embodiment can be used depending on its use purpose. In a PSA display element, the dimethacrylate derivative is particularly preferred.

In General Formula (8), Sp¹ and Sp² each independently represent a single bond, an alkylene group having 1 to 8 carbon atoms or —O—(CH₂)ₛ—. In a PSA display element, at least one of Sp¹ and Sp² is preferably a single bond, and a compound in which both represent a single bond or an embodiment in which one represents a single bond and other represents an alkylene group having 1 to 8 carbon atoms or —O—(CH₂)ₛ— is preferred. In this case, an alkyl group having 1 to 4 is preferred, and s is preferably 1 to 4.

In General Formula (8), Z² is preferably —OCH₂—, —CH₂O—, —COO—, —OCO—, —CF₂O—, —OCF₂—, —CH₂CH₂—, —CF₂CF₂— or a single bond, more preferably —COO—, —OCO— or a single bond, and particularly preferably a single bond.

In General Formula (8), B represents a 1,4-phenylene group in which optional hydrogen atom may be substituted with a fluorine atom, a trans-1,4-cyclohexylene group or a single bond, and a 1,4-phenylene group or a single bond is preferred. In the case where B represents a ring structure other than a single bond, Z² is preferably a linking group other than a single bond, and in the case where B is a single bond, Z² is preferably a single bond.

In the liquid crystal composition of the present invention, the content of the polymerizable monomer represented by General Formula (8) is preferably 0.05 to 1 mass %, more preferably 0.1 to 0.5 mass %, even more preferably 0.1 to 0.4 mass %, particularly preferably 0.1 to 0.3 mass %, and most preferably 0.15 to 0.3 mass %, based on the whole amount (100 mass %) of the liquid crystal composition.

When the content of the polymerizable monomer is 0.1 to 0.3 mass %, it is preferred in the standpoint of a balance between display characteristics and reliability of a liquid crystal display element.

From those points, in General Formula (8), specifically the ring structure between Sp¹ and Sp² is preferably the structures described below.

In General Formula (8), B represents a single bond, and in the case where the ring structure is formed by two rings, B preferably represents the following formulae (VIIIa-1) to (VIIIa-5):

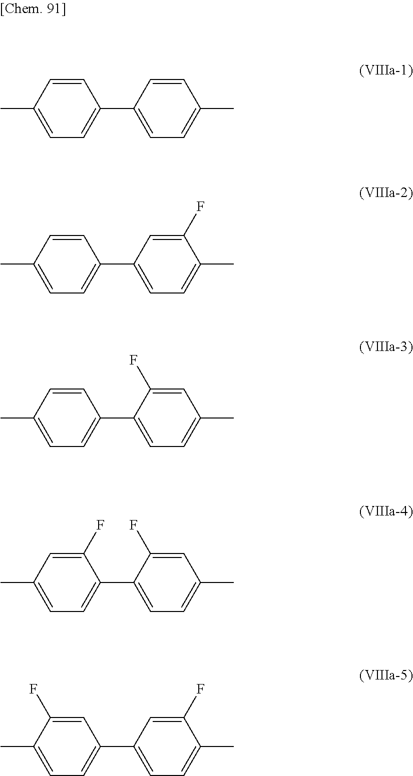

(in General Formulas (VIIIa-1) to (VIIIa-5), both ends bond to Sp¹ or Sp²),

more preferably represents General Formulas (VIIIa-1) to (VIIIa-3), and particularly preferably represents the formula (VIIIa-1).

In the polymerizable monomer containing those frameworks, alignment regulating force after polymerization is optimum to a PSA type liquid crystal display element, and good alignment state is obtained. As a result, display unevenness is suppressed or does not occur at all.

From the above, as the polymerizable monomer in the present invention, the formulae (8.1) to (8.4) are particularly preferred, and above all, the formula (8.2) is most preferred.

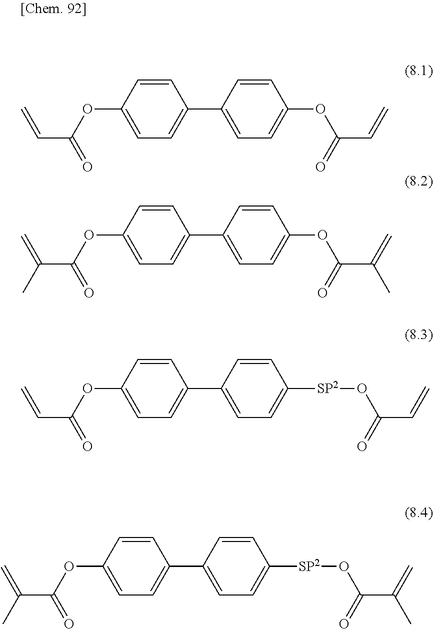

In the above formulae (8.1) to (8.4), Sp² represents an alkylene group having 2 to 5 carbon atoms.

In the case of adding a monomer to the liquid crystal composition of the present invention, polymerization proceeds even in the case where a polymerization initiator is not present, but to accelerate the polymerization, a polymerization initiator may be contained. Examples of the polymerization initiator include benzoin ethers, benzophenones, acetophenones, benzyl ketals, and acylphosphine oxides. Further, to improve storage stability, a stabilizer may be added. Examples of the stabilizer that can be used include hydroquinones, hydroquinone monoalkyl ethers, t-butyl catechols, pyrogallols, thiophenols, nitro compounds, β-naphthylamines, β-naphthols and nitroso compounds.

It has been confirmed that the liquid crystal composition and/or the liquid crystal composition containing a polymerizable monomer of the present invention are effective to the suppression of drop marks.

The liquid crystal composition containing a polymerizable monomer of the present invention (hereinafter this may be referred to as the polymerizable monomer-containing liquid crystal composition) is useful for liquid crystal display elements and especially useful for active matrix drive liquid crystal display elements, and can be used in PSA-mode, PSVA-mode, VA-mode, IPS-mode, FFS-mode or ECB-mode liquid crystal display elements.

The polymerizable monomer-containing liquid crystal composition of the present invention can be given alignment performance through polymerization of the polymerizable monomer contained therein via UV irradiation, and is used in a liquid crystal display element in which the amount of the transmitted light is controlled by birefringence of the liquid crystal composition. Regarding liquid crystal display elements, the composition is useful for AM-LCD (active matrix liquid crystal display element), TN (nematic liquid crystal display element), STN-LCD (supertwisted nematic liquid crystal element), OCB-LCD and IPS-LCD (in-plane switching liquid crystal display element), especially useful for AM-LCD, and can be used in transmission-type or reflection-type liquid crystal display elements.

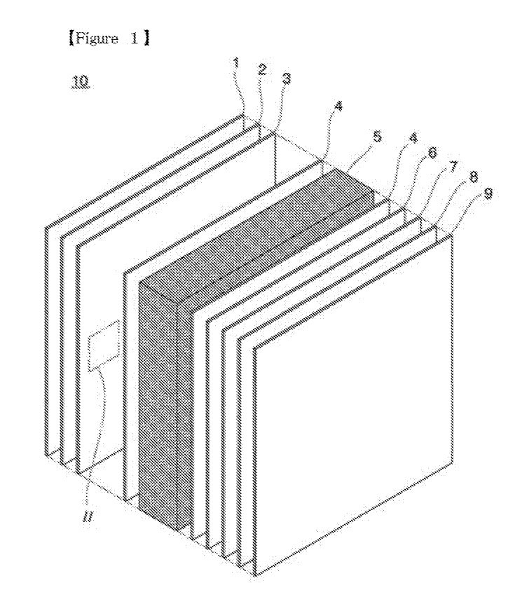

With reference to the liquid crystal display elements and the contents of FIGS. 1 to 4 to be described hereinunder, two substrates 2 and 8 for the liquid crystal cell to be used in a liquid crystal display element may be made of a flexible and transparent material such as glass or plastic, but may also be a non-transparent material such as silicon or the like. The transparent substrates 2 and 8 having transparent electrodes (layers) 6 and 14 may be prepared, for example, by sputtering indium-tin-oxide (ITO) on the transparent substrates 2 and 8 such as glass sheets, etc.

The substrates 2 and 8 on which the transparent electrode (layer) or TFT has been formed are combined in such a manner that the transparent electrodes (layers) 6 and 14 could face inside. In this case, the distance between the substrates may be controlled using a spacer (not shown). In this case, it is desirable to control the space in such a manner that the thickness of the light control layer to be formed could be 1 to 100 μm, more preferably 1.5 to 10 μm (see FIGS. 1 to 4).

In the case where a polarizer is used, it is desirable to control the product of the refractive index anisotropy Δn and the cell thickness d of the liquid crystal so as to realize a maximum contrast. In the case where the element has two polarizers 1 and 9, it is possible to control the polarization axis of each polarizer so as to better the viewing angle and the contrast (see FIGS. 1 to 4). Further, a retardation film may be used for broadening the viewing angle. As the spacer, for example, there are mentioned glass articles, plastic particles, alumina particles, photoresist materials, etc. Subsequently, a sealant of an epoxy-based thermoplastic composition or the like is screen-printed on the substrate in the form provided with a liquid crystal injection mouth, and then the substrates are stuck together and heated to thermally cure the sealant.

For the method for introducing a polymerizable monomer-containing liquid crystal composition into the space for liquid crystal composition to house the liquid crystal composition therein, as formed by sticking the two substrates to face to each other as mentioned above, an ordinary vacuum injection method or ODF method may be employed. However, the vacuum injection method of introducing a polymerizable monomer-containing liquid crystal composition has a problem of forming injection marks though drop marks are not formed, and in the present invention, producing liquid crystal displays using an ODF method is preferred.

As a method for polymerizing a polymerizable monomer in the present invention, a suitable polymerization rate is desired for realizing good alignment performance of liquid crystal, and therefore, a polymerization method according to single, combined or sequential irradiation with active energy rays such as UV rays, electron beams or the like is preferred. In the case where UV rays are used, a polarizing light source may be used, or a non-polarizing light source may be used. In the case where the polymerizable monomer-containing liquid crystal composition is polymerized while sandwiched between two substrates, at least the substrate on the irradiation side must give suitable transparency for active energy rays. In addition, a different method may also be employed, in which, a mask is used in photoirradiation so as to polymerize a specific part alone, and then the conditions of electric field, magnetic field, temperature and the like are changed to change the alignment state in the unpolymerized part, and the composition is further polymerized by additional active energy ray irradiation. In particular, in UV exposure, it is desirable to apply an alternating electric field to the polymerizable monomer-containing liquid crystal composition during UV exposure. The alternating electric field is preferably an alternate current of a frequency of 10 Hz to 10 kHz, more preferably a frequency of 60 Hz to 10 kHz, and the voltage may be selected depending on the desired pretilt angle of the liquid crystal display element. In other words, the pretilt angle of the liquid crystal display element can be controlled by the voltage to be applied. In an MVA-mode liquid crystal display element, the pretilt angle is preferably controlled to be 80 degrees to 89.9 degrees from the viewpoint of alignment stability and contrast.

The temperature at the time when active energy rays such as UV rays, electron beams or the like are irradiated is preferably within a temperature range in which the liquid crystal composition of the present invention can have a liquid crystal state. Preferably, the polymerization is carried out at a temperature close to room temperature, typically at a temperature of 15 to 35° C. A metal halide lamp, a high-pressure mercury lamp, an ultrahigh-pressure mercury lamp and the like can be used as a lamp to generate UV rays. Regarding the wavelength of the UV rays to be irradiated, UV rays having a wavelength region not the absorption wavelength region of the liquid crystal composition are preferably irradiated and, if desired, it is desirable to cut UV rays in irradiation. The intensity of the UV rays to be irradiated is preferably 0.1 mW/cm² to 100 mW/cm², more preferably 2 mW/cm² to 50 mW/cm². The energy amount of the UV rays to be irradiated may be suitably controlled, but is preferably 10 mJ/cm² to 500 mJ/cm², more preferably 100 mJ/cm² to 200 mJ/cm². In irradiation with UV rays, the intensity may be changed. The time for UV irradiation may be suitably selected depending on the intensity of the UV rays to be irradiated, but is preferably 10 seconds to 3600 seconds, preferably 10 seconds to 600 seconds.

As described above, in the process of producing a liquid crystal display element, the occurrence of drop marks is greatly influenced by a liquid crystal material to be injected, but the influence is not avoided even by the structure of a liquid crystal display element. Particularly, in a color filter or a thin-film transistor formed in a liquid crystal display element, only a thin alignment film, a transparent electrode or the like is a member separating a liquid crystal composition. Therefore, the occurrence of drop marks is influenced by, for example, a combination of a chemical structure of a pigment used in a color filter or a chemical structure of a color filter resin and a liquid crystal composition having a specific chemical structure.

From the above, the liquid crystal display element using the liquid crystal composition of the present invention is a useful element that achieves both high response and suppression of poor display, is particularly useful in an active matrix driving liquid crystal display element, and can be applied to VA mode, PSVA mode, FFS mode, PSA mode, IPS mode or ECB mode.

The liquid crystal composition of the present invention includes the compounds of General Formulas (1) and (2) as essential components, and as more preferred embodiment, can contain at least one kind selected from the group consisting of the compounds represented by General Formulas (3), (4), (6a), (6b) and (8). In this case, the contents are preferably the following contents.

The proportion of the compounds having two or more fluorine atoms in one molecule, specifically the compounds represented by General Formulas (1), (2), (3) and (4), occupied in each compound constituting the liquid crystal composition of the present invention is preferably 40 to 90 mass %, more preferably 45 to 85 mass %, and even more preferably 50 to 80 mass %, in the liquid crystal composition. Specifically described in more detail, in the case of considering response speed to be important, the proportion is preferably 50 to 60 mass %, and in the case of considering driving voltage to be important, the proportion is preferably 60 to 80 mass %.

### Liquid Crystal Display Element

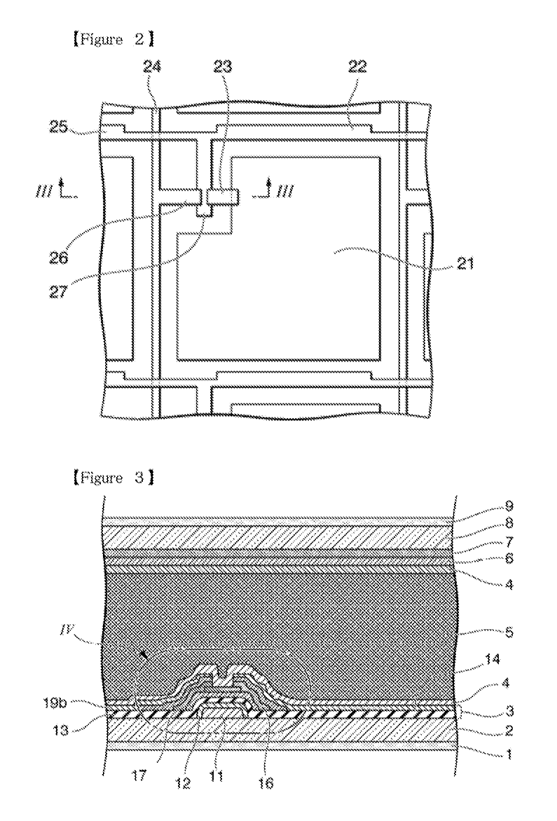

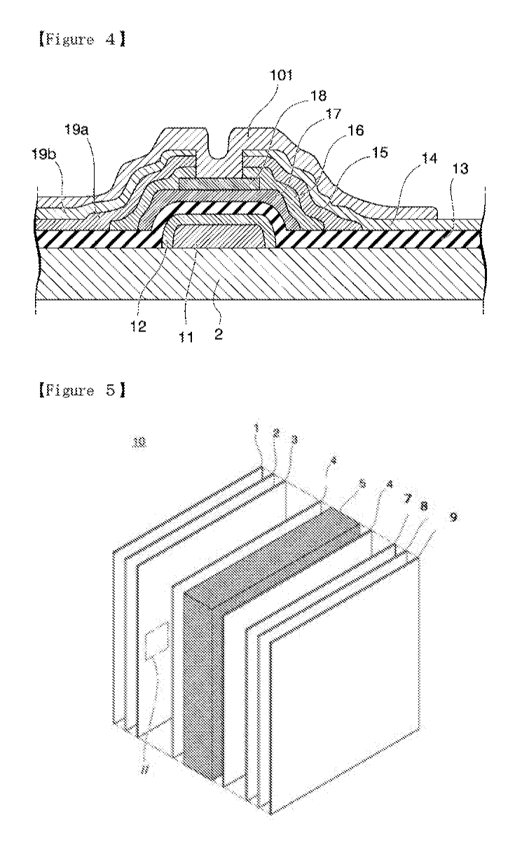

A second aspect of the present invention is a liquid crystal display element using the liquid crystal composition of the present invention. FIG. 1 is a view schematically showing a structure of one embodiment of the liquid crystal display element. Further, in FIG. 1, each constituent element is separately shown for the purpose of illustration. FIG. 2 is an enlarged plane view of a region surrounded by line II of an electrode layer 3 (or called a thin-film transistor layer 3) including a thin-film transistor formed on a substrate in FIG. 1. FIG. 3 is a cross-sectional view in which the liquid crystal display element shown in FIG. 1 was cut in a line III-III direction in FIG. 2. FIG. 4 is an enlarged view of a thin-film transistor in a region of IV in FIG. 3.

The second preferred embodiment of the liquid crystal display element of the present invention is a liquid crystal display element having a second substrate 8 provided with a common electrode 6, a first substrate 2 containing a pixel electrode including a transparent conductive material and a thin-film resistor layer 3 that forms a thin-film transistor controlling the pixel electrode provided on each pixel, and a liquid crystal composition (or a liquid crystal layer 5) interposed between the first substrate 2 and the second substrate 8, wherein alignment during non-application of voltage of a liquid crystal molecule in the liquid crystal composition is nearly vertical to the substrates 2 and 6, and characterized by using the liquid crystal composition of the present invention as the liquid crystal composition. In other words, the liquid crystal display element containing the liquid crystal composition of the present invention is arranged so as to separate the first substrate 2 and the second substrate 8, and the liquid crystal composition (or the liquid crystal layer 5) is filled between the first substrate 2 and the second substrate 8.

As shown in FIGS. 1 and 3, the second substrate 8 and the first substrate 2 may be sandwiched between a pair of polarizers 1 and 9. In FIG. 1, a color filer 7 is provided between the first substrate 8 and the common electrode 6. Further, a pair of alignment films 4 may be formed on the surface of transparent electrodes (layers) 6 and 14 so as to be adjacent to the liquid crystal layer 5 of the present invention and directly come into contact with the liquid crystal composition constituting the liquid crystal layer 5.

Specifically, the liquid crystal display element 10 of the present invention is so designed that the second polarizer 1, the second substrate 2, the thin-film transistor-containing electrode layer (or also referred to as thin-film transistor layer) 3, the alignment film 4, the liquid crystal composition-containing layer 5, the alignment film 4, the common electrode 6, the color filter 7, the first substrate 8 and the first polarizer 9 are laminated in that order.

As other preferred embodiment of the liquid crystal display element 10 of the present invention, it may be a so-called color filter on array (COA), and the color filter 7 may be provided between the thin-film transistor layer 3 and the liquid crystal layer 5, or the color filter 7 may be provided between the thin-film transistor layer 3 and the second substrate 2.

As shown in FIG. 2 and FIG. 3, in the thin-film transistor-containing electrode layer 3 formed on the surface of the second substrate 2, a gate wiring 25 for supplying a scanning signal and a data wiring 24 for supplying a display signal cross each other, and in the region surrounded by the plural gate wirings 25 and the plural data wirings 24, a pixel electrode 21 is formed in a matrix state. As a switch element for supplying a display signal to the pixel electrode 21, a thin-film transistor including a source electrode 26, a drain electrode 23 and a gate electrode 27 is, as connected to the pixel electrode 21, arranged near the cross at which the gate wiring 25 and the data wiring cross each other. Further, in the region surrounded by the plural gate wirings 25 and the plural data wirings 24, a storage capacitor 22 is arranged, which is for storing the display signal supplied thereto via the data wiring 24.

A common line 29 is provided in parallel to the gate electrode 26. The common line 29 is connected with the common electrode 22 so as to supply common signal to the common electrode 22.

In the present invention, the thin-film transistor can be preferably used in an inverted staggered type liquid crystal display element as shown in the drawing. The gate wiring 25, the data wiring 24 and the like are preferably a metal film, and the case of using an aluminum wiring is particularly preferred. Further, the gate wiring 25 and the data wiring 24 are overlapped through a gate insulting film.

In the configuration of FIG. 2 in which the color filter 7 and the thin-film transistor layer 3 are provided on the facing substrates, respectively, the color filter 7 preferably forms a black matrix (not shown) on the parts corresponding to the thin-film transistor and the storage capacitor 22 from the standpoint of prevention of leakage of light (the same in other embodiments).

Preferred one embodiment of the configuration of a thin-film transistor in the liquid crystal display element of the present invention has, for example, a gate electrode 11 formed on the surface of the substrate 2, a gate insulating layer 13 provided so as to cover the gate electrode 11 and further cover a surface of the substrate 2, a semiconductor layer 17 formed on a surface of the gate insulating layer 13 so as to face the gate electrode 11, a protective layer 18 provided so as to cover a part of a surface of the semiconductor layer 17, a drain electrode 15 provided so as to cover one side edge of the protective layer 18 and the semiconductor layer 17 and further to be brought into contact with the gate insulating layer 13 formed on a surface of the substrate 2, source electrodes 19a and 19b provided so as to cover other side edge of the protective layer 18 and the semiconductor layer 17 and further to be brought into contact with the gate insulating layer 13 formed on a surface of the substrate 2, a transparent electrode 14 provided so as to cover the source electrodes 19a and 19b and further to cover nearly the entire surface of the gate insulating layer 13 following the gate insulating layer 13, and a protective layer 101 (not shown in FIG. 3) provided so as to cover a part of the transparent electrode 14 and the source electrodes 19a and 19b, as shown in FIGS. 3 and 4.

As shown in FIGS. 3 and 4, an anodic oxide coating 12 may be formed on a surface of the gate electrode 11 for the reason that level difference to a gate electrode is eliminated. An ohmic contact layer 16 may be provided between the semiconductor layer 17 and the drain layer 15 for the purpose of reducing a width and a height of Schottky barrier.

Amorphous silicon, polycrystalline silicon or the like can be used in the semiconductor layer 17 in the present invention, but use of a transparent semiconductor film such as ZnO, IGZO (In—Ga—Zn—O), ITO or the like can suppress harmful effect of light carrier due to light absorption, and this is preferred from the standpoint of increasing an aperture ratio of an element.

The ohmic contact layer 15 may be provided between the semiconductor layer 13 and the drain electrode 16 or the source electrode 17 for the purpose of reducing a width and a height of Schottky barrier. A material having added thereto impurities such as phosphorus in high concentration, such as n-type amorphous silicon or n-type polycrystalline polysilicon, can be used in the ohmic contact layer.

The gate wiring 26, the data wiring 25 and the common wiring 29 are preferably a metal film. Al, Cu, Au, Ag, Cr, Ta, Ti, Mo, W, Ni or its alloy is more preferred, and use of a wiring of Al or its alloy is particularly preferred. The insulating protective layer 18 is a layer having insulating function, and is formed by silicon nitride, silicon dioxide, silicon oxynitride film or the like.

In the embodiments shown in FIGS. 2 and 3, the common electrode 22 is a flat plate electrode formed on nearly the entire surface of the gate insulating layer 12, and on the other hand, the pixel electrode 21 is a comb-shaped electrode formed on the insulating protective layer 18 covering the common electrode 22. That is, the common electrode 22 is provided at a position near the first substrate 2 than the pixel electrode 21, and those electrodes are overlapped with each other through the insulating protective layer 18 and arranged. The pixel electrode 21 and the common electrode 22 are formed by, for example, a transparent conductive material such as ITO (Indium Tin Oxide), IZO (Indium Zinc Oxide) or IZTO (Indium Zinc Tin Oxide). Because the pixel electrode 21 and the common electrode 22 are formed by a transparent conductive material, an area opened in a unit pixel area is increased, and an aperture ratio and transmittance are increased.

Particularly, in the case of using the above inverted staggered type as a thin-film transistor in the liquid crystal display element of the present invention, the drain electrode 15 is formed so as to cover the gate electrode 11. As a result, the area of the drain electrode 15 tends to be increased. Generally, it is the ordinary embodiment that a drain electrode is formed by a metal material such as copper, aluminum, chromium, titanium, molybdenum or tantalum, and is subjected to a passivation treatment. However, for example, as shown in FIGS. 3 and 4, the protective film 18 is generally thin, the alignment film 4 is also thin, and the possibility is high that those films do not shield ionic substances. As a result, the occurrence of drop marks by an interaction between a metal material and a liquid crystal composition could not be avoided.

However, it is considered in the liquid crystal display element containing the liquid crystal composition of the present invention that the problem of the occurrence of drop marks can be reduced from, for example, the standpoint of delicate balance between a member of a liquid crystal display element and surface free energy or adsorption energy of the liquid crystal composition of the present invention.

The second preferred embodiment of the liquid crystal display element of the present invention is a liquid crystal display element in which a first substrate having on the surface thereof a first alignment layer and a thin-film transistor-containing electrode layer and a second substrate having on the surface thereof a second alignment layer are arranged so as to separate such that the alignment layers face with each other, and a liquid crystal layer containing a liquid crystal composition is filled between the first substrate and the second substrate, wherein the thin-film transistor containing electrode layer preferably includes plural gate wirings and data wirings provided in a network shape, a thin-film transistor provided at each intersection between the gate wirings and the data wirings, a pixel electrode connected to the thin-film transistor, and a common electrode provided on the first substrate separating from the pixel electrode. Further, the first alignment layer and the second alignment layer provided adjacent to the liquid crystal layer are preferably an alignment film inducing homogeneous alignment to the liquid crystal composition.

Specifically, the liquid crystal display element is preferably designed such that a second polarizer, a second substrate, a thin-film transistor-containing electrode layer (or also referred to as a thin-film transistor layer), an alignment film, a liquid crystal composition-containing liquid crystal layer, an alignment film, a color filter, a first substrate and a first polarizer are laminated in this order.

Electric field (E) generated between the common electrode and the pixel electrode can have a plane surface direction component by providing the common electrode and pixel electrode separated with each other on the same substrate (or electrode layer). As a result, for example, when an alignment film inducing homogeneous alignment to a liquid crystal composition is used in the alignment layer, liquid crystal molecules arranged in a plane direction that is an alignment direction of an alignment film before applying voltage between a common electrode and a pixel electrode shield light, and when voltage is applied, the liquid crystal molecules rotate horizontally by the electric field (E) applying to a plane surface direction, and are arranged along the electric field direction, thereby an element shielding light can be provided.

The form of the liquid crystal display element of the present invention may be a so-called color filter on array (COA). A color filter may be provided between a thin-film transistor-containing electrode layer and a liquid crystal layer, or a color filler may be provided between the thin-film transistor-containing electrode layer and a second substrate.

More preferred embodiment (IPS) of the second embodiment of the present invention is a liquid crystal display element in which a first substrate having on the surface thereof an alignment layer and a thin-film transistor-containing electrode layer and a second substrate having on the surface thereof an alignment layer are arranged so as to separate such that the alignment layers face with each other, and a liquid crystal composition-containing liquid crystal layer is filled between the first substrate and the second substrate, wherein the thin-film transistor-containing electrode layer includes plural gate wirings and data wirings provided in a network shape, a thin-film transistor provided at each intersection between the gate wirings and the data wirings, a pixel electrode connected to the thin-film transistor, and a common electrode provided on the first substrate separated from the pixel electrode, and the shortest separation distance d between the adjacent common electrode and pixel electrode is preferably longer than the shortest separation distance D between the mutual alignment layers.

More preferred embodiment of the liquid crystal display element is described below using FIGS. 5 to 9. FIG. 5 is an exploded perspective view schematically showing a structure of one embodiment of a liquid crystal display element different from the configuration of the liquid crystal display element of FIG. 1, and is a so-called IPS (or FFS) system liquid crystal display element.

As shown in FIG. 5, the liquid crystal display element of the present invention is preferably designed such that the first polarizer 1, the first substrate 2, the thin-film transistor-containing electrode layer (or also referred to as a thin-film transistor layer) 3, the alignment film 4, the liquid crystal composition-containing liquid crystal layer 5, the alignment film 4, the color filter 7, the second substrate 8 and the second polarizer 9 are laminated in this order. The color filter 7 may be provided between the thin-film transistor-containing electrode layer 3 and the liquid crystal layer 5, or the color filter 7 may be provided between the thin-film transistor-containing electrode layer 3 and the second substrate 2. Further, the exploded perspective view schematically showing the structure of the liquid crystal display element of the present invention as shown in FIG. 5 is the common configuration in IPS system and FFS system.

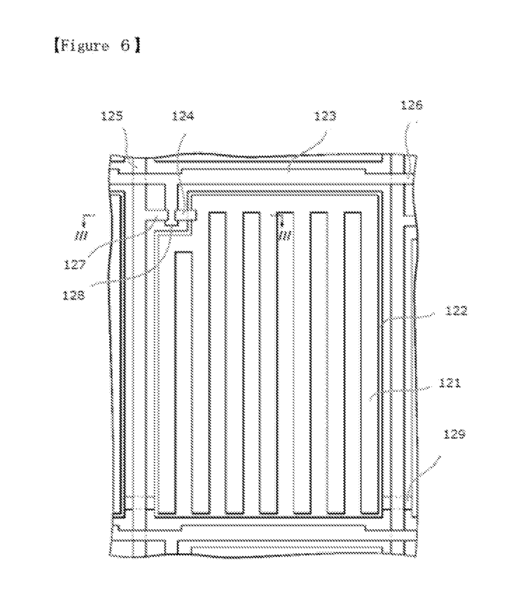

FIG. 6 is an enlarged plane view of a region II of the thin-film transistor-containing electrode layer 3 (or also referred to as a thin-film transistor layer 3) formed on the substrate in FIG. 5. As shown in FIG. 6, the thin-film transistor-containing electrode layer 3 formed on the first substrate 2 is that a gate wiring 126 for supplying scanning signal and a data wiring 125 for supplying display signal are intersected with each other, the gate wiring 126 and the data wiring 125 are formed in a network pattern (in the drawing, lattice pattern as one example), and a pixel electrode 121, a common electrode and a thin-film transistor are formed on a region surrounded by the plural gate wirings 126 and the plural data wirings 125. In more detail, the thin-film transistor containing a source electrode 127, a drain electrode 128 and a gate electrode 124 is provided by connecting to the pixel electrode 121 as a switch element supplying display signal to the pixel electrode 121 in the vicinity of an intersection at which the gate wiring 126 and the data wiring 125 intersect with each other. In FIG. 6, as one example, a comb-like pixel electrode is provided, and a common electrode 122 is formed on a flat plate at a first substrate side of the pixel electrode. As other embodiment, a comb-like common electrode is provided, and the comb-like common electrode may be provided so as to engage with the comb of the pixel electrode. The present invention is not limited to those, and is not particularly limited so long as it is designed such that a pixel electrode and a common electrode are arranged on the same substrate in the cross-section. An upper and lower position relationship between the pixel electrode and the common electrode may be present, and those electrodes may be alternately arranged. Further, the number and shape of teeth in a comb-like pixel electrode or common electrode are not particularly limited, and are not particularly limited so long as a cross-sectional structure in which the pixel electrode and the common electrode are arranged on the same substrate with a constant distance can be obtained. The surface of the pixel electrode is preferably covered with a protective insulating film and an alignment film. A storage capacitor 123 (not shown) that stores display signal supplied via the data wiring 125 may be provided in the region surrounded by the plural gate wirings 126 and the plural data wirings 125.

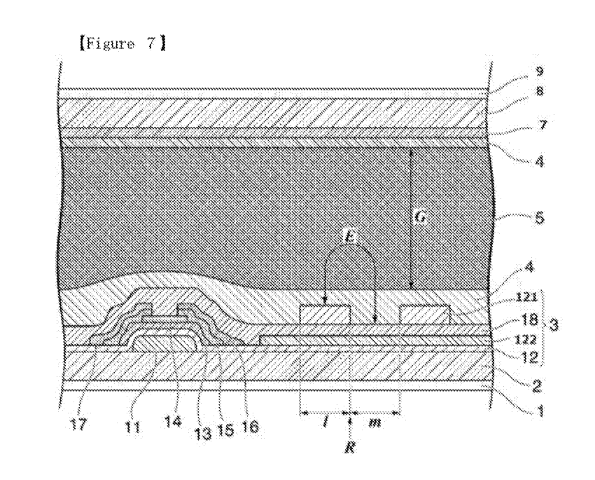

FIG. 7 is a cross-sectional view in which a liquid crystal display element has been cut in a line III-III direction in FIG. 6. The first substrate 2 having formed on the surface thereof the alignment layer 4 and the thin-film transistor-containing electrode layer 3, and the second substrate 8 having formed on the surface thereof the alignment layer 4 are separated with each other so as to mutually face the alignment layers with a predetermined interval G, and the space is filled with the liquid crystal composition-containing liquid crystal layer 5. Further, as shown in FIG. 6, plural tooth parts of the comb-like pixel electrode 121 are provided on the substrate in the separating state. As other embodiment, plural tooth parts of the comb-like pixel electrode and plural tooth parts of the comb-like common electrode may be provided on the substrate in the separated and engaged state, and in this case, the pixel electrode and the common electrode may be mutually separated and arranged on the first substrate, and the upper and lower relationship may be present as in FIG. 7 and as described hereinunder. By this, the shortest separation distance d between the adjacent common electrode and pixel electrode and the shortest separation distance G of the mutual alignment layers can be adjusted by changing the separation distance and the interval of tooth parts of each electrode. Further, when the shortest separation distance d between the adjacent common electrode and pixel electrode is longer than the shortest separation distance G of the mutual alignment layers, the electric field formed between the common electrode and the pixel electrode is that a component in a surface direction increases, and liquid crystal molecules can be aligned in a horizontal direction. On the other hand, when the shortest separation distance d between the adjacent common electrode and pixel electrode is shorter than the shortest separation distance G of the mutual alignment layers, fringe electric field is generated, and alignment in a horizontal direction and a vertical direction of liquid crystal molecules can be efficiently utilized (particularly, n-type liquid crystal composition).

In the present specification, the liquid crystal display element having the condition that the shortest separation distance d between the adjacent common electrode and pixel electrode is longer than the shortest separation distance G of the mutual alignment layers is called an IPS system liquid crystal display element, and the element having the condition that the shortest separation distance d between the adjacent common electrode and pixel electrode is shorter than the shortest separation distance G of the mutual alignment layers is called FFS. Therefore, only that the shortest separation distance d between the adjacent common electrode and pixel electrode is longer than the shortest separation distance G of the mutual alignment layers is the condition of an IPS system. Therefore, there is not limitation in the positional relationship in a thickness direction between the surface of the common electrode and the surface of the pixel electrode. For this reason, in the IPS system liquid crystal display element of the present invention, the pixel electrode may be provided at a liquid crystal layer side than the common electrode as shown in FIG. 7 and FIG. 9 described hereinunder.

The embodiment relating to the position in a thickness direction between the pixel electrode and the common electrode is described below as other embodiment of the IPS system or FFS system liquid crystal display element of the present invention.

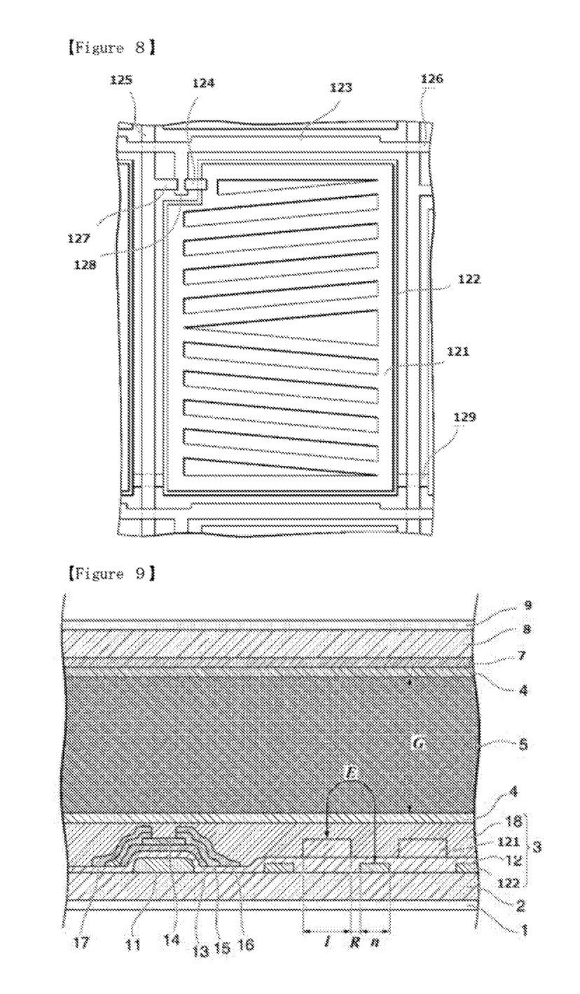

The configuration as more preferred embodiment of the second embodiment (IPS system or FFS system liquid crystal display element) of the present invention is that the pixel electrode and the common electrode are formed on the same substrate, similar to the exploded view of FIG. 5. Therefore, the exploded view of the liquid crystal display element quotes the description of FIG. 5. FIG. 8 is an enlarged plane view of the region of the thin-film transistor-containing electrode layer 3 (or referred to as thin-film transistor layer 3) in the region II formed on the substrate of the embodiment different from FIG. 6.

The structure of the electrode layer 3 shown in FIG. 8 is that the thin-film transistor containing the source electrode 127, the drain electrode 128 and the gate electrode 124 is provided by connecting to the pixel electrode 121 as a switch element supplying display signal to the pixel electrode 121 in the vicinity of an intersection at which the gate wiring 126 and the data wiring 125 intersect with each other, similar to FIG. 5. The pixel electrode 121 shown in FIG. 8 has a shape that a nearly rectangular flat plate electrode has been hollowed at a nearly rectangular frame-like cut-off part. Further, the comb-like common electrode 122 is formed on the entire back face of the pixel electrode 121 via the insulating layer 18 (not shown). In the case where the shortest separation distance d between the adjacent common electrode and pixel electrode is longer than the shortest separation distance G of the mutual alignment layers (or distance between substrates), it is an IPS system liquid crystal display element, and in the case where the distance d is shorter than the distance G, it is an FFS system liquid crystal display element. The surface of the pixel electrode is preferably covered with the protective insulating layer and the alignment film layer. A storage capacitor (not shown) that stores display signal supplied via the data wiring 125 may be provided in the region surrounded by the plural gate wirings 126 and the plural data wirings 125. The shape of the cut-off part is not particularly limited, and the cut-off part having not only a rectangular shape shown in FIG. 8, but the conventional shape such as an ellipse, a circle, a rectangular shape, a diamond shape, a triangle or a parallelogram can be used.

FIG. 9 is the embodiment different from FIG. 6, and in FIG. 8, is a cross-sectional view in which the liquid crystal display element has been cut at the same place as the line III-III direction of FIG. 6. The first substrate 2 having on the surface thereof the alignment layer 4 and the thin-film transistor-containing electrode layer 3 and the second substrate 8 having on the surface thereof the alignment layer 4 are separated such that the alignment layers face with each other with a predetermined interval G, and the space is filled with the liquid crystal composition-containing liquid crystal layer 5. The gate insulating film 12, the common electrode 122, the insulating film 18, the pixel electrode 121 and the alignment layer 4 are laminated in this order on a part of the surface of the first substrate 2. Further, as shown in FIG. 8, the pixel electrode 121 has the shape that the central part and both edges of a flat plate are hollowed at a triangular cut-off part, and the remaining region is hollowed at a rectangular cut-off part, and the common electrode 122 is provided with a cut-off part similar to the pixel electrode 21 or the comb-like common electrode 122 is arranged at a first substrate side than the pixel electrode.

In the case of the IPS system (the condition that the shortest separation distance d between the adjacent common electrode and pixel electrode is longer that the shortest separation distance G of mutual alignment layers (or distance between substrates), if the shortest separation distance d between the adjacent common electrode and pixel electrode is longer than the shortest separation distance G of the mutual alignment layers, the electric field (E) formed between the common electrode and the pixel electrode is that the component in a surface direction (electric field in a horizontal direction) increases, thereby orienting liquid crystal molecules in a horizontal direction. As a result, the IPS or FFS system liquid crystal display element is that as shown in the drawing, when electric field is formed between the pixel electrode 121 and the common electrode 122, liquid crystal oriented in a horizontal direction rotates in a horizontal direction, thereby a transmission amount of incident light from a backlight can be controlled. The IPS and FFS mode liquid crystal display elements have the merits of wide viewing angle and high contrast. However, because the common electrode 122 is formed by the same metal material as the data wiring or the gate wiring, there are problems that aperture ratio and transmittance are low, and color changes by a viewing angle.

In the IPS and FFS system liquid crystal display elements, the first alignment layer and second alignment layer provided adjacent to the liquid crystal layer are preferably an alignment film that induces homogeneous alignment to the liquid crystal composition. For example, when an alignment film that induces homogeneous alignment to the liquid crystal composition is used as the alignment layer, liquid crystal molecules arranged in a surface direction that is an alignment direction of the alignment film before applying voltage between the common electrode and the pixel electrode shield light. On the other hand, when voltage is applied, electric field (E) is applied in a plane direction. As a result, liquid crystal molecules rotate horizontally, and can be arranged along the electric field direction.

The term “on the substrate” in the present specification includes the state of not only direct contact with a substrate, but indirect contact, that is, the state of being supported on a substrate.

Other preferred embodiment (FFS) in the liquid crystal display composition of the present invention is a liquid crystal display element in which a first substrate having on the surface thereof a first alignment layer and a thin-film transistor-containing electrode layer, and a second substrate having on the surface thereof a second alignment layer are arranged by separating such that the alignment layers face with each other, and the space between the first substrate and the second substrate is filled with a liquid crystal composition-containing liquid crystal layer, wherein the thin-film transistor-containing electrode layer includes plural gate wirings and data wirings provided in a network shape, a thin-film transistor provided at each intersection between the gate wirings and the data wirings, a pixel electrode connected to the thin-film transistor, and a common electrode provided on the first substrate separating from the pixel electrode, and the shortest separation distance d between the adjacent common electrode and pixel electrode is preferably shorter than the shortest separation distance G between the mutual alignment layers.

The FFS system liquid crystal display element utilizes fringe electric field, and when the shortest separation distance d between the adjacent common electrode and pixel electrode is shorter than the shortest separation distance D between mutual alignment layers, fringe electric field is formed between the common electrode and the pixel electrode, and alignment in a horizontal direction and a vertical direction of liquid crystal molecules can be efficiently utilized. Specifically, in the case of the FFS system liquid crystal display element, electric field in a horizontal direction formed in a vertical direction to a line forming a comb shape of the pixel electrode 21, and radial electric field can be utilized.

Further, in the case of the FFS system liquid crystal display element, when voltage is applied to liquid crystal molecules arranged such that a long axis direction is parallel to an alignment direction of the alignment layer, equipotential line of radial electric field is formed between the pixel electrode 121 and the common electrode 122 up to the upper part of the pixel electrode 121 and the common electrode 122, and liquid crystal molecules in the liquid crystal layer 5 rotate in the liquid crystal layer 5 along the electric field formed. Particularly, the liquid crystal composition of the present invention uses liquid crystal molecules having negative dielectric anisotropy. Therefore, a long axis direction of the liquid crystal molecules rotates so as to go straight to the electric field direction formed. The liquid crystal molecules located near the pixel electrode 21 are easy to receive the influence of fringe electric field, but liquid crystal molecules having negative dielectric anisotropy are that polarization direction is on a short axis of molecules. Therefore, the long axis direction does not rotate in a direction going straight to the alignment layer 4, and the long axis direction of all liquid crystal molecules in the liquid crystal layer 5 can maintain a parallel direction to the alignment film 4. Therefore, excellent transmittance characteristic can be obtained as compared with the FFS system liquid crystal display element using liquid crystal molecules having positive dielectric anisotropy.

The minimum separation distance d between the pixel electrode and the common electrode can be adjusted as a (average) film thickness of the gate insulating film 12. In other words, in the embodiment of FIG. 7, the distance in a horizontal direction to a substrate between the pixel electrode and the common electrode is 0. Electrode width on a comb-like part of the pixel electrode 121: l, and width of a gap of comb-like parts of the pixel electrode 21: m are preferably formed into a width to an extent such that all liquid crystal molecules in the liquid crystal layer 5 can be driven by electric field generated. On the other hand, in the embodiment of FIG. 9, the distance in a direction horizontal to the substrate between the pixel electrode and the common electrode is R.

As shown in FIG. 2, the liquid crystal display element has a rectangular display region R1 located at a central part and a frame-like non-display part R2 located along a margin of the display region, and red, green or blue color filter is formed in the display region R1. In more detail, the color filter is provided such that the margin thereof overlaps signal line (date wiring, gate wiring and the like). Plural pixel electrodes formed by a transparent conductive film such as ITO (Indium Tin Oxide) may be provided on the color filter. Each pixel electrode is connected to the corresponding thin-film transistor via a through-hole (not shown) formed on an insulting film and each colored layer. In more detail, the pixel electrode is connected to TFT via the contact electrode. Plural columnar spacers or the like may be provided on the pixel electrode 21. An alignment film is formed on the color filter and the pixel electrode.

### EXAMPLES

The present invention is described in detail with reference to Examples given hereinunder, but the scope of the present invention should not be limited to these Examples. “%” in the compositions of the following Examples and Comparative Examples means “% by mass”. In Examples, the properties measured and the evaluations are as follows.

The following abbreviations are used in describing the compounds used in Examples.

(Side Chain)

−n —CₙH₂ₙ₊₁, a linear alkyl group having n's carbon atoms.

n− CₙH₂ₙ₊₁—, a linear alkyl group having n's carbon atoms.

−Oₙ —OCₙH₂ₙ₊₁, a linear alkoxyl group having n's carbon atoms.

ₙO− CₙH₂ₙ₊₁O—, a linear alkoxyl group having n's carbon atoms.

−V —CH═CH₂

V− CH₂═CH—

−V1 —CH═CH—CH₃

1V− CH₃—CH═CH—

−2V —CH₂—CH₂—CH═CH₃

V2− CH₃═CH—CH₂—CH₂—

−2V1 —CH₂—CH₂—CH═CH—CH₃

1V2− CH₃—CH═CH₂—CH₂—CH₂

—COO— —COO—

—OCO— —OCO—

(Ring Structure)

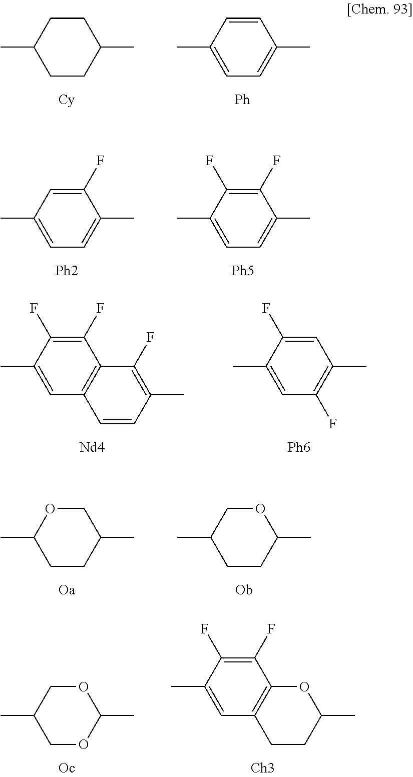

### Examples and Comparative Examples

Liquid crystal compositions having formulations shown in the following Table 1 were prepared, and the physical properties thereof were measured. The results are shown in the following Tables.

The VA liquid crystal display element shown in FIG. 3 was prepared using the liquid crystal compositions of Examples 1 to 16 and Comparative Examples. The liquid crystal display element has an inverted staggered type thin-film transistor as an active element. Injection of the liquid crystal composition was performed by a drip process, and light resistance was evaluated. Compositions of Examples 1 to 16 and Comparative Examples and experimental results of the evaluation are shown in Table 1 below. Symbols at a left side of the content are abbreviations of the above compounds.

### (Properties of Liquid Crystal Composition)

Tni: Nematic phase-isotropic liquid phase transition temperature (° C.)
Δn: Refractive index anisotropy at 25° C.
Δ∈: Dielectric anisotropy at 25° C.
η: Viscosity at 20° C. (mPa·s)
γ₁: Rotational viscosity at 25° C. (mPa·s)
Initial voltage holding ratio (initial VHR): Voltage holding ratio (%) at 343 K under the condition of a frequency of 6 Hz and an applied voltage of 5V.
VHR after heat resistance test: A TEG (test element group) for evaluation of electro-optical properties filled with a liquid crystal composition sample was held in a constant-temperature tank at 130° C. for 1 hours, and then VHR thereof was measured under the same condition as that of the above-mentioned VHR measurement method.

Light resistance test used an ultra-high pressure mercury lamp (manufactured by ATLAS, SUNTEST CPS+, 50 lamp output: 500 W, illumination in 300 to 400 nm: 50 W/m²). A sample of 2 cc was placed in a glass bottle having an inner diameter of 25 mm, light resistance test was performed (20 minutes) and the change with time of resistivity was examined.

### (Burn-in Evaluation)

Burn-in evaluation of a liquid crystal display element was performed as follows. After displaying a predetermined fixed pattern in a display area for an optional test time of 1000 hours, test time until an afterimage of the fixed pattern when uniform display was conducted on the entire surface reaches unacceptable afterimage level was measured.

1) The test time used herein means a display time of a fixed pattern, longer time indicates that the occurrence of afterimage is suppressed and performance is high.

2) Unacceptable afterimage level is a level that afterimage that fails in pass/fail judgment of shipping is observed. The level was visually determined by the following four-grade evaluation. Performance is high as test time is longer.

Sample A: 1,000 hours

Sample B: 500 hours

Sample C: 200 hours

Sample D: 100 hours

The performance is A>B>C>D.

TABLE 1

| | Exam- | Exam- | Exam- | Exam- |
|---|---|---|---|---|
| Sample Name | ple 1 | ple 2 | ple 3 | ple 4 |
| T_{NI}/° C. | 89.8 | 84.2 | 105.3 | 98.4 |
| Δn | 0.119 | 0.117 | 0.112 | 0.110 |
| Δε | −4.97 | −5.07 | −4.38 | −3.82 |
| 3-Cy-Cy-2 | | | | |
| 3-Cy-Cy-4 | | | | |
| 3-Cy-Cy-5 | | | | |
| 3-Cy-Cy-V | | | | |
| 3-Cy-Cy-V1 | 8 | 10 | 12 | |
| 4-Cy-Cy-V | | | | |
| 5-Cy-Cy-V | 11 | 8 | 8 | |
| 3-Cy-Cy-O1 | | | | 5.8 |
| 3-Cy-Cy-O3 | | | | 7 |
| 5-Cy-Cy-O1 | | | | 6.9 |
| V-Cy-Cy-Ph-1 | | | | 8.2 |
| 3-Cy-Ph5—O2 | | | | |
| 3-Cy-Ph5—O4 | 20 | 25 | 15 | 15.6 |
| 5-Cy-Ph5—O2 | | | | |
| 5-Cy-Ph5—O4 | 11.3 | 10 | 13 | |
| 3-Ph—Ph5—O4 | | | | |
| 2-Cy-Cy-Ph5-1 | | | | 4.2 |
| 3-Cy-Cy-Ph5-1 | | | | 5.3 |
| 3-Cy-Cy-Ph5-3 | | | | |
| 4-Cy-Cy-Ph5-3 | | | | |
| 3-Cy-Cy-Ph5—O1 | | | | |
| 3-Cy-Cy-Ph5—O2 | 5.9 | 6 | 8 | 7.8 |
| 3-Cy-Cy-Ph5—O3 | 6 | 6 | 8 | 7.9 |
| 4-Cy-Cy-Ph5—O2 | 5.9 | 6 | 8 | 7.8 |
| 2-Cy-Ph—Ph5—O2 | 10 | 8 | 7 | 6.8 |
| 3-Cy-Ph—Ph5—O2 | 10 | 8 | 7 | 5.9 |
| 3-Ph—Ph5—Ph-2 | 7.7 | 9 | 5 | 7.6 |
| 3-Cy-Cy-COO—Ph-Cy-3 | 2.2 | 2 | 5 | 3.2 |
| 3-Cy-Cy-COO—Ph-Cy-5 | 2 | 2 | 4 | |

TABLE 2

| | Exam- | Exam- | Exam- | Exam- |
|---|---|---|---|---|
| Sample Name | ple 5 | ple 6 | ple 7 | ple 8 |
| T_{NI}/° C. | 92.8 | 102.0 | 101.4 | 100.1 |
| Δn | 0.106 | 0.123 | 0.123 | 0.116 |
| Δε | −3.66 | −3.30 | −3.51 | −2.70 |
| 3-Cy-Cy-2 | | | | |
| 3-Cy-Cy-4 | | | | |
| 3-Cy-Cy-5 | | | | |
| 3-Cy-Cy-V | | | | |
| 3-Cy-Cy-V1 | | | | |
| 4-Cy-Cy-V | | 18.4 | 16 | 27.5 |
| 5-Cy-Cy-V | | | | |
| 3-Cy-Cy-O1 | 7 | | | |
| 3-Cy-Cy-O3 | 10 | | | |
| 5-Cy-Cy-O1 | 7 | | | |
| V-Cy-Cy-Ph-1 | 8 | 17 | 18 | 15 |
| 3-Cy-Ph5—O2 | | | | |
| 3-Cy-Ph5—O4 | 15 | 15 | 17 | 12 |
| 5-Cy-Ph5—O2 | | | | |
| 5-Cy-Ph5—O4 | | | | |
| 3-Ph—Ph5—O4 | | | | |
| 2-Cy-Cy-Ph5-1 | 3 | | | |
| 3-Cy-Cy-Ph5-1 | 4 | | | |
| 3-Cy-Cy-Ph5-3 | | 3.3 | 3 | 2 |
| 4-Cy-Cy-Ph5-3 | | 1.9 | 2 | 1 |
| 3-Cy-Cy-Ph5—O1 | | | | |
| 3-Cy-Cy-Ph5—O2 | 8 | 3.9 | 4 | 3 |
| 3-Cy-Cy-Ph5—O3 | 8 | 4.7 | 5 | 4 |
| 4-Cy-Cy-Ph5—O2 | 8 | 4.7 | 5 | 4 |
| 2-Cy-Ph—Ph5—O2 | 7 | 7.6 | 7 | 6.5 |
| 3-Cy-Ph—Ph5—O2 | 6 | 9.5 | 10 | 11 |
| 3-Ph—Ph5—Ph-2 | 7 | 11.6 | 11 | 10 |
| 3-Cy-Cy-COO—Ph-Cy-3 | 2 | 2.4 | 2 | 4 |
| 3-Cy-Cy-COO—Ph-Cy-5 | | | | |

TABLE 3

| | Exam- | Exam- | Exam- | Exam- |
|---|---|---|---|---|
| Sample Name | ple 9 | ple 10 | ple 11 | ple 12 |
| T_{NI}/° C. | 83.3 | 91.6 | 77.1 | 91.4 |
| Δn | 0.097 | 0.108 | 0.103 | 0.096 |
| Δε | −4.60 | −5.15 | −3.84 | −3.59 |
| 3-Cy-Cy-2 | 10 | 10 | | |
| 3-Cy-Cy-4 | 10 | 5 | | |
| 3-Cy-Cy-5 | 8 | 8 | | |
| 3-Cy-Cy-V | | | 25 | 25 |
| 3-Cy-Cy-V1 | | | 10 | 10 |
| 4-Cy-Cy-V | | | | |
| 5-Cy-Cy-V | | | | |
| 3-Cy-Cy-O1 | | | | |
| 3-Cy-Cy-O3 | | | | |
| 5-Cy-Cy-O1 | | | | |
| V-Cy-Cy-Ph-1 | | | | |
| 3-Cy-Ph5—O2 | 14 | 12 | 15 | |
| 3-Cy-Ph5—O4 | 2 | 2 | 5 | |
| 5-Cy-Ph5—O2 | 10 | 9 | | 11 |
| 5-Cy-Ph5—O4 | | | | 9 |
| 3-Ph—Ph5—O4 | 5 | 5 | 12 | 10 |
| 2-Cy-Cy-Ph5-1 | | | | |
| 3-Cy-Cy-Ph5-1 | | | | |
| 3-Cy-Cy-Ph5-3 | | | | |
| 4-Cy-Cy-Ph5-3 | | | | |
| 3-Cy-Cy-Ph5—O1 | 5 | 5 | | |
| 3-Cy-Cy-Ph5—O2 | 7 | 7 | | |
| 3-Cy-Cy-Ph5—O3 | 6 | 6 | 15 | 10 |
| 4-Cy-Cy-Ph5—O2 | 3 | 3 | | 8 |
| 2-Cy-Ph—Ph5—O2 | 8 | 12 | 5 | |
| 3-Cy-Ph—Ph5—O2 | 8 | 12 | | 7 |
| 3-Ph—Ph5—Ph-2 | | | 5 | |
| 3-Cy-Cy-COO—Ph-Cy-3 | 2 | 2 | 5 | 5 |
| 3-Cy-Cy-COO—Ph-Cy-5 | 2 | 2 | 3 | 5 |

TABLE 4

| | Exam- | Exam- | Exam- | Exam- |
|---|---|---|---|---|
| Sample Name | ple 13 | ple 14 | ple 15 | ple 16 |
| T_{NI}/° C. | 91.8 | 75.7 | 99.9 | 92.1 |
| Δn | 0.105 | 0.106 | 0.098 | 0.101 |
| Δε | −2.88 | −3.58 | −3.33 | −4.25 |
| 3-Cy-Cy-2 | | | | |
| 3-Cy-Cy-4 | | | | |
| 3-Cy-Cy-5 | | | | |
| 3-Cy-Cy-V | 25 | 30 | 30 | |
| 3-Cy-Cy-V1 | 10 | 5 | 5 | 10 |
| 4-Cy-Cy-V | | | | 15 |
| 5-Cy-Cy-V | | | | |
| 3-Cy-Cy-O1 | | | | |
| 3-Cy-Cy-O3 | | | | |
| 5-Cy-Cy-O1 | | | | |
| V-Cy-Cy-Ph-1 | | | | |
| 3-Cy-Ph5—O2 | 10 | 10 | | 10 |
| 3-Cy-Ph5—O4 | | 2 | | |
| 5-Cy-Ph5—O2 | | | 10 | 10 |
| 5-Cy-Ph5—O4 | 10 | 5 | 7 | 6 |
| 3-Ph—Ph5—O4 | | 13 | 5 | 8 |
| 2-Cy-Cy-Ph5-1 | | | | |
| 3-Cy-Cy-Ph5-1 | | | | |
| 3-Cy-Cy-Ph5-3 | | | | 5 |
| 4-Cy-Cy-Ph5-3 | | | | |
| 3-Cy-Cy-Ph5—O1 | | | 8 | |
| 3-Cy-Cy-Ph5—O2 | 14 | 10 | | 8 |
| 3-Cy-Cy-Ph5—O3 | | 8 | | 8 |
| 4-Cy-Cy-Ph5—O2 | 10 | | 10 | |
| 2-Cy-Ph—Ph5—O2 | | | 5 | 8 |
| 3-Cy-Ph—Ph5—O2 | | | 10 | |
| 3-Ph—Ph5—Ph-2 | 15 | 10 | | |
| 3-Cy-Cy-COO—Ph-Cy-3 | 3 | 7 | 5 | 6 |
| 3-Cy-Cy-COO—Ph-Cy-5 | 3 | | 5 | 6 |

TABLE 5

| | Exam- | Exam- | Exam- |
|---|---|---|---|
| Sample Name | ple 17 | ple 18 | ple 19 |
| T_{NI}/° C. | 83.4 | 80.1 | 91.3 |
| Δn | 0.094 | 0.101 | 0.095 |
| Δε | −4.94 | −4.35 | −4.04 |
| 3-Cy-Cy-2 | 16 | | |
| 3-Cy-Cy-4 | 10 | | |
| 3-Cy-Cy-5 | 5 | | |
| 3-Cy-Cy-V | | 25 | 30 |
| 3-Cy-Cy-V1 | | 10 | 7 |
| 3-Cy-1O—Ph5—O1 | 9 | 7 | 7 |
| 3-Cy-1O—Ph5—O2 | 12 | 10 | 10 |
| 3-Ph—Ph5—O4 | 5 | 12 | 5 |
| 2-Cy-Cy-1O—Ph5—O2 | 9 | 7 | 7 |
| 3-Cy-Cy-1O—Ph5—O2 | 12 | 11 | 11 |
| 2-Cy-Ph—Ph5—O2 | 8 | 5 | 6 |
| 3-Cy-Ph—Ph5—O2 | 10 | | 9 |
| 3-Ph—Ph5—Ph-2 | | 5 | |
| 3-Cy-Cy-COO—Ph-Cy-3 | 2 | 4 | 4 |
| 3-Cy-Cy-COO—Ph-Cy-5 | 2 | 4 | 4 |

TABLE 6

| | Comparative | Comparative |
|---|---|---|
| Sample Name | Example 1 | Example 2 |
| T_{NI}/° C. | 82.8 | 82.8 |
| Δn | 0.098 | 0.121 |
| Δε | −4.64 | −4.42 |
| 3-Cy-Cy-2 | 10 | |
| 3-Cy-Cy-4 | 10 | |
| 3-Cy-Cy-5 | 8 | |
| 3-Cy-Cy-V1 | | 10 |
| 4-Cy-Cy-V | | |
| 3-Cy-Cy-V | | 25 |
| 3-Cy-Ph5—O4 | 2 | |
| 5-Cy-Ph5—O4 | | |
| 3-Cy-Ph5—O2 | 14 | |
| 5-Cy-Ph5—O2 | 10 | |
| 3-Cy-Cy-Ph5—O1 | 5 | |
| 3-Cy-Cy-Ph5—O2 | 7 | |
| 3-Cy-Cy-Ph5—O3 | 6 | 15 |
| 4-Cy-Cy-Ph5—O2 | 3 | |
| 2-Cy-Ph—Ph5—O2 | 8 | 10 |
| 3-Cy-Ph—Ph5—O2 | 8 | |
| 3-Cy-Cy-Ph5-3 | | |
| 3-Ph—Ph5—O4 | 5 | 27 |
| 3-Ph—Ph5—Ph-2 | | 5 |
| 3-Cy-Cy-COO—Ph-Cy-3 | | |
| 3-Cy-Cy-Ph-Cy-3 | 4 | 8 |

Test results of light resistance of the liquid crystal compositions prepared in Examples 1 to 19 showed that specific resistance value was decreased at most 1/50 by UV irradiation for 20 minutes. On the other hand, it was confirmed that specific resistance value was decreased 1/100 or less in the liquid crystal compositions of Comparative Examples 1 and 2.

Each constitution in each embodiment described above, the combination thereof and the like are one example, and addition, omission, substitution and other modifications of constitution can be made without departing the spirit and scope of the present invention. Further, the present invention is not limited by each embodiment, and is limited by only the scope of claims.

### INDUSTRIAL APPLICABILITY

The liquid crystal composition of the present invention can be widely applied to fields of a liquid crystal display element and a liquid crystal display.

1. A liquid crystal composition comprising:
as a first component, at least one selected from the group of compounds represented by the following formula (1): 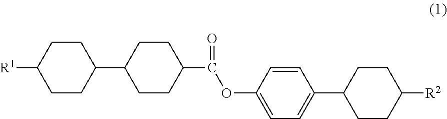
wherein R¹ and R² each independently represent one group selected from the group consisting of an alkyl group having 1 to 15 carbon atoms, an alkenyl group having 2 to 15 carbon atoms and an alkoxy group having 1 to 15 carbon atoms, and
as a second component, at least one selected from the group consisting of compounds represented by the following General Formula (2): 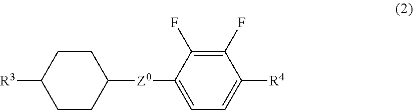
wherein R³ is selected from the group consisting of an alkyl group having 1 to 15 carbon atoms, an alkenyl group having 2 to 15 carbon atoms and an alkoxy group having 1 to 15 carbon atoms,
Z⁰ represents a single bond, —CH₂O— or —OCH₂—, and
R⁴ is at least one group selected from the group consisting of an alkyl group having 1 to 15 carbon atoms and an alkoxy group having 1 to 15 carbon atoms.

2. The liquid crystal composition according to claim 1, further containing, as a third component, at least one selected from the group of compounds represented by the following formula (3): 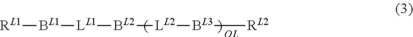
wherein R^{L1} and R^{L2} each independently represent an alkyl group having 1 to 8 carbon atoms, and one or non-adjacent two or more (—CH₂—)'s in the alkyl group may be each independently substituted with —CH═CH—, —C≡C—, —O—, —CO—, —COO— or —OCO—,
OL indicates 0, 1, 2 or 3,
B^{L1}, B^{L2} and B^{L3} each independently represent the group selected from the following (a) and (b):
(a) a 1,4-cyclohexylene group (one —CH₂— or non-adjacent 2 or more (—CH₂—)'s existing in this group may be substituted with —O—),
(b) a 1,4-phenylene group (one —CH═ or non-adjacent two or more (—CH═)'s existing in this group may be substituted with —N═),
the hydrogen atom contained in the group represented by the above (a) and the above (b) may be each independently substituted with a cyano group or a fluorine atom,
L^{L1} and L^{L2} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF— or —C≡C—,
when OL is 2 or 3 and plural L^{L2}'s are present, they may be the same or different, and when OL is 2 or 3 and plural B^{L3}'s are present, they may be the same or different,
with the proviso that compounds represented by General Formula (1) and compounds represented by General Formula (2) are excluded.

3. The liquid crystal composition according to claim 1, further containing, as a fourth component, at least one selected from the group of compounds represented by the following formula (4): 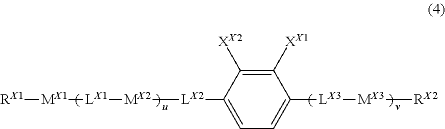
wherein R^{X1} and R^{X2} each independently represent an alkyl group having 1 to 10 carbon atoms, an alkoxy group having 1 to 10 carbon atoms, or an alkenyl group having 2 to 10 carbon atoms, and one methylene group or two or more non-adjacent methylene groups existing in these groups may be substituted with —O— or —S—, and one or more hydrogen atoms exiting in these groups may be substituted with a fluorine atom;
u and v each independently indicate 0, 1 or 2, and u+v is 2 or less;
M^{X1}, M^{X2} and M^{X3} each independently are selected from represent the group consisting of the following (a) and (b):
(a) a trans-1,4-cyclohexylene group (one methylene group or two or more non-adjacent methylene groups existing in this group may be substituted with —O— or —S—), and
(b) a 1,4-phenylene group (one —CH═ or two or more non-adjacent (—CH═)'s existing in this group may be substituted with —N═),
wherein the hydrogen atom contained in the group of the above (a) or the above (b) may be substituted with the group selected from a cyano group, a fluorine atom, a trifluoromethyl group and a trifluoromethoxy group, and
plural M^{X2}'s and/or M^{X3}'s, if any, may be the same or different;
L^{X1}, L^{X2} and L^{X3} each independently represent a single bond, —COO—, —OCO—, —CH₂CH₂—, —(CH₂)₄—, —OCH₂—, —CH₂O—, —OCF₂—, —CF₂O—, —CH═CH— or —C≡C—, and plural L^{X1}'s and/or L^{X3}'s, if any, may be the same or different; and
X^{X1} and X^{X2} each independently represent a trifluoromethyl group, a trifluoromethoxy group or a fluorine atom, provided that any one of X^{X1} and X^{X2} represents a fluorine atom,
with the proviso that the compounds represented by General Formula (1), General Formula (2) and General Formula (3) are excluded.

4. The liquid crystal composition according to claim 1, further comprising a reactive monomer.

5. A liquid crystal display element using the liquid crystal composition according to claim 1.

6. A liquid crystal display using the liquid crystal display element according to claim 5.
